(19) United States
(12) Patent Application Publication
(10) Pub. No.: US 2018/0303129 A1
(43) Pub. Date: Oct. 25, 2018

(54) AQUACULTURE FEED FORMULATION AND AQUACULTURE PRODUCT PRODUCED WITH SAME

(71) Applicant: TRUSTEES OF DARTMOUTH COLLEGE, Hanover, NH (US)

(72) Inventors: Anne R. Kapuscinski, Hanover, NH (US); Pallab K. Sarker, Hanover, NH (US)

(21) Appl. No.: 15/520,503

(22) PCT Filed: Oct. 23, 2015
(86) PCT No.: PCT/US15/57065

§ 371 Date: Apr. 20, 2017

Related U.S. Application Data
(60) Provisional application No. 62/068,254, filed on Oct. 24, 2014.
(60) Provisional application No. 62/106,887, filed on Jan. 23, 2015.
(60) Provisional application No. 62/234,778, filed on Sep. 30, 2015.

(51) Int. Cl. A23K 20/158; A23K 10/16; A23K 20/142; A23K 50/80

(52) U.S. Cl. CPC A23K 20/158; A23K 50/80; A23K 20/142; A23K 10/16

(57) ABSTRACT

A fishmeal-free and fish oil-free aquaculture feed composition containing marine microalgae as the source of fatty acids and the source of essential amino acids is described as is a method for producing an aquaculture product with improved growth rates, feed conversion ratio, protein efficiency ratio, survival rate, and human health-promoting omega-3 long-chain polyunsaturated fatty acid levels in the fillet using the fishmeal-free and fish oil-free aquaculture feed composition.

This patent application claims the benefit of priority from U.S. Application Ser. No. 62/068,254 filed Oct. 24, 2014, U.S. Application Ser. No. 62/106,887 filed Jan. 23, 2015 and U.S. Application Ser. No. 62/234,778 filed Sep. 30, 2015, the contents of each of which are hereby incorporated by reference in their entirety.

### BACKGROUND

Aquaculture is a diverse and rapidly expanding industry. Responsible expansion of aquafeeds, inter alia, requires finding alternatives to fishmeal and fish oil for which aquaculture is the largest user. Fishmeal is used in aquafeeds because it meets the essential amino acid needs of most farmed fish. Fish oil is a prized aquafeed ingredient because it is a rich source of n3 polyunsaturated fatty acids (n3 PUFAs), especially two PUFAs that provide the best health benefit for human consumption: eicosapentaenoic acid (EPA, C20:5n3) and docosahexaenoic acid (DHA, C22:6n3). Aquaculture feeds currently use over 80% of the world's fishmeal and fish oil, which are extracted from small ocean-caught fish. This has four unsustainable consequences. First, analysts project exhaustion of global supplies of fishmeal and oil by 2040 (Duarte, et al. (2009) Bioscience 59(11):967-976), with huge price increases already indicating scarcity. Feed production is also aquaculture's main cause of fossil fuel consumption and greenhouse gas emissions due to harvesting and converting ocean fish into fishmeal and fish oil, and transporting these global commodities (Pelletier & Tyedmers (2010) J. Industr. Ecol. 14:467-481). Further, overfishing of small ocean fish for fishmeal and oil is causing large declines in marine biodiversity because these same small fish are the main prey, i.e., the forage fish for predatory fish (e.g., tuna), marine mammals, and sea birds (Smith, et al. (2011) Science 33:1147-1150; Troell, et al. (2014) Proc. Natl. Acad. Sci. USA 111:13257-63). Moreover, diversion of these forage fish to fishmeal and fish oil production erodes human food security because it takes an average of 5 kg of edible fish to produce the fish meal and fish oil in diets fed to yield 1 kg of farmed fish, causing a global net loss in edible fish (Naylor, et al. (2009) Proc. Natl. Acad. Sci. USA 106:15103-15110). Forage fish provide over 50 percent of the total food fish supply for people in more than 36 countries but their diversion into nonfood commodities has raised their prices to levels unaffordable for many impoverished peoples (Tacon & Metian (2009) Ambio 38:294-302; Troell, et al. (2014) Proc. Natl. Acad. Sci. USA 111:13257-63). It has thus been recommended that government limits be placed on the use of food-grade forage fish for animal feeds and finding alternative feed sources.

Partial substitution of fishmeal and fish oil with terrestrial plant ingredients is useful but insufficient for responsible and nutritionally complete diet formulations. Overreliance on terrestrial crops embroils aquaculture in concerns about massive diversion of crops from human consumption to animal feeds, just when agriculture faces a global challenge to feed nearly a billion chronically hungry people (Foley, et al. (2011) Nature 478:337-342; Troell, et al. (2014) Proc. Natl. Acad. Sci. USA 111:13257-63). Dependence on terrestrial crops also risks turning the rapidly expanding aquaculture sector into a driver of environmentally unsustainable agricultural practices for the world's grains and oils (Foley, et al. (2011) Nature 478:337-342). Moreover, unbalanced levels of essential amino acids, low levels of n3 PUFAs, lack of DHA and EPA, a low ratio of n3:n6 fatty acids, and high levels of anti-nutritional factors (Sarker, et al. (2013) Rev. Aquacult. 5:1-21) have limited inclusion rates of terrestrial plant ingredients, even in diets for omnivorous species like tilapia (Shiau, et al. (1990) Aquaculture 86:401-407; Maina, et al. (2002) Aquacult. Res. 33:853-862; Borgeson, et al. (2006) Aquacult. Nutr. 12:141-149; Ng & Low (2005) J. Applied Aquacult. 17:87-97; Azaza, et al. (2009) Aquacult. Nutr. 17:507-521; Thompson, et al. (2012) N. Am. J. Aquacult. 74:365-375).

It is known that the diet of farmed fish greatly influences their general biochemical composition, particularly their fatty acid composition (Ng, et al. (2001) Fish Physiol. Biochem. 25:301-310). In this respect, replacing fish oil with terrestrial plant oil significantly lowers the levels of EPA and DHA in fish which, in turn, reduces the nutritional and health benefits for humans of eating farmed fish (Bell, et al. (2001) J. Fish Nutr. 131:1535-1543; Francis, et al. (2007) Aquaculture 269:447-455; Berge, et al. (2009) Aquaculture 296:299-308; Østbye, et al. (2011) Aquacult. Nutr. 17:177-190; Teoh, et al. (2011) Aquaculture 316:144-154). Intensively farmed Nile tilapia are typically fed high levels of C18 n6 fatty acids coming from vegetable oils in the commercial feed (Karapanagiotidis, et al. (2006) J. Agric. Food Chem. 54:4304-4310). Also, Nile tilapia have shown a limited capacity for de novo synthesis of EPA (C20:5n3) and DHA (C22:6n3) from dietary C18:3n-3 in the terrestrial plant oil ingredients (Karapanagiotidis, et al. (2007) Lipids 42:547-559).

Nutritional benefits are also reduced when diets fed in intensive farming lead to undesirable n3:n6 ratios in tilapia flesh. Fillets of intensively farmed tilapia can have elevated contents of saturated fatty acids (SFA), mono-unsaturated fatty acids (MUFA) and linolenic acid and very little content of n3. Consequently, intensively farmed tilapia can have a 60-fold higher n6 PUFA content than in coldwater fish, and an n3:n6 ratio of up to 1:6.0 compared to 1:0.10-0.26 in coldwater fish (Weaver, et al. (2008) J. Am. Diet. Assoc. 108:1178-1185; Foran, et al. (2005) J. Nutr. 135:2639-2643). Consuming farmed tilapia with such elevated levels of n6 PUFA can contribute to an imbalanced n3/n6 ratio in humans (Simopoulos (2008) Exp. Biol. Med. 233:674-688; Weaver, et al. (2008) J. Am. Diet. Assoc. 108:1178-1185). In turn, this would increase production of pro-inflammatory eicosanoids, via C20:4n6 arachidonic acid, which play a pivotal role in many inflammatory related conditions and disease (Ferretti et al. (1997) Lipids 32:435-439). However, a feed composition with a ratio of n3:n6 fatty acids of at least 1:1 or higher can rebalance the ratio in the fillet of farmed tilapia. Aquaculture products that have a ratio of n3:n6 fatty acids of at least 1:1 or higher have been increasingly recognized to benefit human health, and improve the overall ratio in a person's total diet, which should be approximately 1:1 for optimum health (Ruxton, et al. (2004) J. Hum. Nutr. Diet. 17:449-459; Burghardt, et al. (2010) Nutr. Metabol. 7:53; Strobel, at al. (2012) Lipids in Health and Disease 11:n/a-144). It is important to maintain high levels of EPA and DHA in fish since health-conscious consumers have a dietary requirement of these PUFAs (Weaver, et al. (2008) J. Am. Diet. Assoc. 108:1178-1185). Therefore, replacing fish oil with terrestrial oils while maintaining the levels of EPA and DHA in fish products remains a significant challenge for the industry.

Commercial-scale production of microalgae for biofuels and human nutritional supplements has stimulated interest in microalgae for animal feeds (Gouveia et al. (2009) In: Algae: Nutrition, Pollution Control and Energy Sources (Hagen, ed.), pp. 265-300. New York: Nova Science Publishers, USA; Hemaiswarya, et al. (2011) World J. Microbiol. Biotechnol. 27:1737-1746; Ryckebosch, et al. (2012) Lipid Technol. 24:128-130). Increasing attention has focused on marine microalgae for aquaculture feeds because of their elevated fatty acid profiles. In contrast to terrestrial plant protein and oil sources, microalgae are relatively high in essential long chain n-3 polyunsaturated fatty acids (n3 LC PUFA) such as DHA (C22:6n3) and EPA (C20:5n3), which are important both for maintaining fish health and imparting neurological, cardiovascular and anticancer benefits to humans (Peet & Stokes (2005) Drugs 65(8):1051-9; Brasky, et al. (2011) Am. J. Epidemiol. 173:1429-39). Thus, microalgae have been suggested as possible replacements for fishmeal, fish oil and other plant protein concentrates in tilapia feeds (Dawah, et al. (2002) J. Egypt. Acad. Soc. Environ. Develop. (B. Aquaculture) 2:113-125; Badawy, et al. (2008) In: Tilapia Aquaculture from the Pharaohs to the Future: Proc. 8th Internatl. Symp. Tilapia Aquacult. (Elghobashy, et al. eds.) pp. 801-810. Egypt Ministry of Agriculture, Cairo, Egypt; (Roy, et al. (2011) J. Algal Bio. Utiliz. 2(1):10-20); Hussein, et al. (2012) Aquacult. Res. 44(6):937-949) and other finfish and crustacean feeds (Day & Tsavalos (1996) J. Appl. Phycol. 25:86; Nandeesha, et al. (1998) Aquacult. Res. 29:305-312; Miller, et al. (2008) Nutr. Res. Rev. 21:85-96; Patnaik, et al. (2006) Aquacult. Nutr. 12:395-401; Walker & Berlinsky (2011) N. Am. J. Aquacult. 73:76-83. In addition, commercial diet pellets coated with Schizochytrium sp. (SCI) dried cells have been tested against Oreochomis honorum (Watters, et al. (2013) Isr. J. Aquacult. 65(869):1-7). However, digestibility data are very limited (Olver-Novoa, et al. (1998) Aquacult. Res. 29:709-715).

Poorly characterized digestibility or bioavailability of nutrients forces nutritionists to use broader safety margins when formulating feeds, reducing their ability to formulate on a truly least-cost basis and confidence in the nutritive value of many ingredients (tall (1991) In: Fish Nutrition Research in Asia. Proceedings of the Fourth Asian Fish Nutrition Workshop (De Silva ed.) pp. 1-12. Asian Fisheries Society, Manila, Philippines; Bureau (2008) Int. Aquafeed 11:18-20; Glencross, et al. (2007) Aquacult. Nutr. 13:17-34; Chowdhury, et al. (2012) Aquaculture 356-357:128-134), as well as hampering efforts to reduce nutrient loading in aquaculture wastes (Sarker, et al. (2009) Aquaculture 289:113-117; Sarker, et al. (2011) Anim. Feed Sci. Technol. 168:241-249).

US 2007/0226814 discloses fish food containing at least one biomass obtained from fermenting microorganisms, wherein the biomass contains at least 20% DHA relative to the total fatty acid content. Preferred microorganisms used as sources for DHA are organisms belonging to the genus Stramenopiles.

WO 2012/021711 discloses, inter alia, aquaculture feed containing at least one source of EPA and optionally at least one source of DHA, wherein the at least one source of EPA is microbial oil and an optionally fish oil or fish meal. Preferred microbial oil is obtained from Yarrowia lipolytica.

### SUMMARY OF THE INVENTION

This invention is a method for preparing a fish oil-free and fishmeal-free aquaculture feed composition by providing a source of fatty acids, wherein the fatty acid source consists of one or a combination of marine microalgae having an omega-3 long-chain polyunsaturated fatty acid content of at least 30% of the total fatty acids; providing at least one source of essential amino acids; and contacting the fatty acid source and at least one source of essential amino acids to prepare an aquaculture feed composition, wherein the ratio of omega-3 polyunsaturated fatty acids:omega-6 polyunsaturated fatty acids of the aquaculture feed composition is in the range of 1:1 to 2:1. In one embodiment, the marine microalgae are Schizochytrium sp., Nannochloropsis sp., Isochrysis sp., Nanofrustulum sp., Tetraselmis sp., Crypthecodinium sp. or Phaeodactylum sp. In another embodiment, the at least one source of essential amino acids is a marine microalgae (e.g., one or a combination of Nannochloropsis sp., Schizochytrium sp., Isochrysis sp., Nanofrustulum sp., Tetraselmis sp. Crypthecodinium sp. or Phaeodactylum sp.) in combination with corn meal, soybean meal, or a combination thereof. In other embodiments, the marine microalgae have an omega-3 long-chain polyunsaturated fatty acid content in the range of 30 to 50% of the total fatty acids and the ratio of omega-3 polyunsaturated fatty acids:omega-6 polyunsaturated fatty acids of the aquaculture feed composition is in the range of 1.8:1 to 1:1. A fish oil-free aquaculture feed composition prepared by the method is also provided.

This invention is also a method for producing an aquaculture product with improved growth rates, feed conversion ratio, protein efficiency ratio, or survival rates by feeding a freshwater tilapia or a salmonid species a fish oil-free aquaculture feed composition containing a source of fatty acids, wherein the fatty acid source consists of one or a combination of marine microalgae having an omega-3 long-chain polyunsaturated fatty acid content of at least 30% of the total fatty acids; and at least one source of essential amino acids thereby producing an aquaculture product with improved growth rates, feed conversion ratio, protein efficiency ratio, or survival rates. In some embodiments, the freshwater tilapia is Oreochromis niloticus, Oreochromis niloticus×Oreochromis aureus, Oreochromis aureus, or Oreochromis mossambicus, and the salmonid species is Salmo salar, Pacific salmon, Oncorhynchus mykiss, Salmo gairdneri, alvelinus alpinus, Salvelinus namaycush or Salvelinus fontinalis. In other embodiments, the marine microalgae are Schizochytrium sp., Nannochloropsis sp., Isochrysis sp., Nanofrustulum sp., Tetraselmis sp., Crypthecodinium sp. and Phaeodactylum sp. In some embodiments, the at least one source of essential amino acids is a marine microalgae (e.g., one or a combination of Nannochloropsis sp., Schizochytrium sp., Isochrysis sp., Nanofrustulum sp., Tetraselmis sp. Crypthecodinium sp. or Phaeodactylum sp.) in combination with corn meal, soybean meal, or a combination thereof. An aquaculture product with a ratio of omega-3 PUFA:omega-6 PUFA in the range of 1.8:1 to 1:1, or aquaculture meat product thereof having a ratio of omega-3 PUFA:omega-6 PUFA in the range of 1.8:1 to 1:1, produced by the method is also provided.

### DETAILED DESCRIPTION OF THE INVENTION

It has now been found that 100% of the fish oil used in conventional aquaculture feed, in particular Nile tilapia aquafeed, can be replaced with marine microalgae. In particular, improved growth rates, feed utilization indices, and beneficial fatty acid profiles in Nile tilapia are observed when 100% of the fish oil typically included in tilapia diets is replaced by dried whole cells of a marine microalga species, Schizochytrium sp. As such, marine microalgae are of use as high-quality substitutes for fish oil and human-health-promoting supplements of long-chain polyunsaturated fatty acids, especially 22:6n3 DHA, for aquaculture feed. Furthermore, content and apparent digestibility coefficients of crude protein and amino acids indicate that marine microalgae such as Nannochloropsis sp. and Isochrysis sp. can be used as substitutes for fishmeal in aquaculture feed.

Accordingly, the present invention is an aquaculture feed composition for fish production, in particular fresh water fish production, which provides a sustainable alternative to fish oil. Specifically, the invention concerns a fish oil-free aquaculture feed composition composed of a source of fatty acids, in particular one or a combination of marine microalgae having an omega-3 long-chain polyunsaturated fatty acid content of at least 30% of the total fatty acids; and at least one source of essential amino acids. In some embodiments, the ratio of omega-3 polyunsaturated fatty acids:omega-6 polyunsaturated fatty acids of the aquaculture feed composition is at least 1:1 and less than 2:1. In certain embodiments, the ratio of omega-3 polyunsaturated fatty acids:omega-6 polyunsaturated fatty acids of the aquaculture feed composition is in the range of 1:1 to 2:1.

As used herein, the terms “aquaculture feed composition,” “aquaculture feed formulation,” “aquaculture feed” and “aquafeed” are used interchangeably and refer to manufactured or artificial diets (i.e., formulated feeds) to supplement or to replace natural feeds in the aquaculture industry. Prepared feed is most commonly produced in flake, pellet or tablet form. Typically, an aquaculture feed composition refers to artificially compounded feeds that are useful for farmed finfish and crustaceans (i.e., both staple food fish species such as carp, tilapia and catfish, as well as higher-value cash crop species such as shrimp, salmon, trout, yellowtail, seabass, seabream and grouper). Aquaculture feed compositions supply essential amino acids and fatty acids reflected in the normal diet of fish. In conventional aquaculture feed, fishmeal provides a source of proteins and amino acids, whereas fish oil is a major source of lipid and fatty acids.

The instant aquaculture feed is “fish oil-free” in that the formulation does not include fish oil as the major source of fatty acids. While fish meal can contain between 5% and 10% oil (Jensen, et al. (April 1990) Internatl. By-Products Conf., Anchorage, Ak.), the fish oil-free formulation contains less than 5%, less than 2%, or less than 1% by weight fish oil. “Fish oil” refers to oil derived from the tissues of an oily fish. Examples of oily fish include, but are not limited to menhaden (e.g., fish of the genera Brevoortia and Ethmidium), anchovy, herring, capelin, cod and the like. In some embodiments, the aquaculture feed composition of the invention also contains less than 5%, less than 2%, less than 1% by weight vegetable oil. “Vegetable oil” refers to any edible oil obtained from a plant. Typically plant oil is extracted from seed or grain of a plant such as corn, soybeans, rapeseeds, sunflower seeds and flax seeds.

The fish oil-free aquaculture feed composition of this invention is produced by combining a source of fatty acids, in particular one or a combination of marine microalgae having an omega-3 long-chain polyunsaturated fatty acid content of at least 30% of the total fatty acids present in the microalgae and at least one source of essential amino acids. As is known in the art, microalgae are unicellular species, which may exist as individual cells, or organized in chains or groups. Depending on the species, sizes of microalgae can range from a few millimeters to a few micrometers. Microalgae perform photosynthesis, grow photoautotrophically and heterotrophically and can be cultivated under difficult agroclimatic conditions, including cultivation in freshwater, saline water, moist earth, dry sand and other open-culture (e.g., open ponds or raceways) conditions known in the art. Microalgae can also be obtained from commercial sources or cultivated and genetically engineered in controlled closed-culture systems, for example, in closed bioreactors. Microalgae are typically harvested by sedimentation and/or flocculation, thus forming a microalgae sludge that can be subjected to additional processing such as drying, pasteurization, sterilization, etc. The microalgae biomass may be in the form of whole cells, whole cell lysates, homogenized cells, partially hydrolyzed cellular material and/or co-products of marine microalgae. As used herein, a marine microalgae co-product is the material that remains after a first product has been extracted from marine microalgae. For example, oil, starch, or other algal products, e.g., chlorophyll or beta carotene, are extracted from marine microalgae as a first product and the remaining cellular material (i.e., co-product) is of use herein as a component of the aquaculture feed composition. In one embodiment, the marine microalgae are provided in the form of whole cells. In another embodiment, the marine microalgae are dried. In particular embodiments, the marine microalgae are provided in the form of dried whole cells. In a further embodiment, the marine microalgae are provided in the form of a co-product.

The microalgae used in the present invention are marine microalgae, i.e., algae that are naturally found in sea water. Marine microalgae can include members from various divisions of algae, including diatoms, pyrrophyta, ochrophyta, chlorophyta, euglenophyta, dinoflagellata, chrysophyta, phaeophyta, rhodophyta and cyanobacteria. Preferably, the marine microalgae are Schizochytrium sp., Nannochloropsis sp., Isochrysis sp., Nanofrustulum sp., Tetraselmis sp., Crypthecodinium sp., Phaeodactylum sp., Chaetoceros sp., Thalassiosira sp., Pavlova sp., Skeletonema sp., Haematococcus sp., Chlamydomonas sp., Thraustochytrium sp., Pinguiococcus sp., or Dunaliella sp. In certain embodiments, the marine microalgae of use as a source of fatty acids are Schizochytrium sp.

As described herein, the aquafeed composition of the invention, which has a higher polyunsaturated fatty acid content than fish oil, exhibited a high level of digestibility of lipid and all unsaturated fatty acid fractions compared to the reference diet containing fish meal and fish oil. Accordingly, marine microalgae of use in the present compositions and methods desirably have a higher polyunsaturated fatty acid content than fish oil. The term “fatty acids” refers to long chain aliphatic acids (alkanoic acids) of varying chain lengths, from about C₁₂ to C₂₂, although both longer and shorter chain-length acids are known. The predominant chain lengths are between C₁₆ and C₂₂. The structure of a fatty acid is represented by a simple notation system of “X:Y,” where X is the total number of carbon atoms in the particular fatty acid and Y is the number of double bonds. Additional details concerning the differentiation between “saturated fatty acids” versus “unsaturated fatty acids,” “monounsaturated fatty acids” versus “polyunsaturated fatty acids” or “PUFAs,” and “omega-6 fatty acids” or “n6” versus “omega-3 fatty acids” or “n3” are provided in, e.g., U.S. Pat. No. 7,238,482, which is hereby incorporated herein by reference.

In some embodiments, the marine microalgae have an omega-3 long-chain polyunsaturated fatty acid (n3 LCPUFA) content of at least 30% of the total fatty acids present in the microalgae. In certain embodiments, the marine microalgae have an n3 LCPUFA content in the range of 30% to 50% of the total fatty acids. In some embodiments, the n3 LCPUFA content of the marine microalgae is about 35%, 36%, 37%, 38%, 39%, 40%, 410, 42%, 43%, 44%, 45%, 46%, 460, 48%, 49% or 50% of the total fatty acids of the marine microalgae. In particular embodiments, the major n3 LCPUFA represented are Eicosapentaenoic acid (020:5n3) or EPA, docosapentaenoic acid (C22:5n3) or DPA; and Docosahexaenoic acid (022:6n3) or DHA.

In other embodiments, the marine microalgae have a high level of omega-3 polyunsaturated fatty acids (n3 PUFA). In accordance with this embodiment, the marine microalgae have an n3 PUFA content of at least 30% of the total fatty acids present in the microalgae. In certain embodiments, the marine microalgae have an n3 PUFA content in the range of 30% to 50% of the total fatty acids. In some embodiments, the n3 PUFA content of the marine microalgae is about 35%, 36%, 37%, 38%, 39%, 40%, 41%, 42%, 43%, 44%, 45%, 46%, 46%, 48%, 49% or 50% of the total fatty acids of the marine microalgae.

In particular embodiments, the total n3 PUFA represented are alpha linolenic acid or ALA (C18:3n3), octadecatetraenoic acid (C18:4n3), eicosatrinoic acid (C20:3n3), arachidonic acid or ARA (C20:4n3), EPA, DPA, and DHA.

The term “total fatty acids” or “TFAs” herein refers to the sum of all cellular fatty acids that can be derivitized to fatty acid methyl esters (FAMEs) by the base transesterification method (as known in the art) in a given sample. Thus, total fatty acids include fatty acids from neutral lipid fractions (including diacylglycerols, monoacylglycerols and TAGs) and from polar lipid fractions (including, e.g., the phosphatidylcholine and phosphatidylethanolamine fractions).

The concentration of a fatty acid is expressed herein as a weight percent of TFAs (% TFAs), e.g., milligrams of the given fatty acid per 100 milligrams of TFAs. Unless otherwise specifically stated in the disclosure herein, reference to the percent of a given fatty acid is equivalent to concentration of the fatty acid as % TFAs.

As indicated, the aquaculture feed composition also includes at least one source of essential amino acids. Ten essential amino acids are typically included in the diet of fish: Arginine, Histidine, Isoleucine, Leucine, Lysine, Methionine, Phenylalanine, Threonine, Tryptophan, and Valine. Essential amino acids can be of plant, animal and/or microalgal origin. For example, amino acids of animal origin can be from marine animals (e.g., fish meal, fish protein, krill meal, mussel meal, shrimp peel, squid meal, etc.) or land animals (e.g., blood meal, egg powder, liver meal, meat meal, meat and bone meal, silkworm, pupae meal, whey powder, etc.). Amino acids of plant origin can include soybean meal, corn meal, wheat gluten, cottonseed meal, canola meal, sunflower meal, rice and the like. In particular embodiments, essential amino acids are solely provided by at least one marine microalgae source alone or in combination with corn meal, soybean meal, or a combination thereof. In this respect, the aquaculture feed product is fishmeal-free. Examples of suitable marine microalgae include, but are not limited to, Nannochloropsis sp., Schizochytrium sp., Isochrysis sp., Nanofrustulum sp., Tetraselmis sp. Crypthecodinium sp., Phaeodactylum sp. or a combination thereof. As indicated herein, marine microalgae can be obtained from commercial sources or grown in closed or open culture systems. The microalgae biomass may be in the form of whole cells, whole cell lysates, homogenized cells, partially hydrolyzed cellular material and/or co-product. In one embodiment, the marine miurodlgae are provided in the form of whole cells. In another embodiment, the marine microalgae are dried. In particular embodiments, the marine microalgae are provided in the form of dried whole cells. In a further embodiment, the marine microalgae are provided in the form of a co-product.

Micro components can also be included in the aquaculture feed composition. Micro components include feed additives such as vitamins, trace minerals, feed antibiotics and other biologicals. Vitamins include, e.g., vitamin A, E, K₃, D₃, Bi, B₃, B₆, Bi₂, C, biotin, folic acid, panthothenic acid, nicotinic acid, choline chloride, inositiol and para-amino-benzoic acid. Minerals such as salts of calcium, cobalt, copper, iron, magnesium, phosophorus, potasium, selenium and zinc can be included at levels of less than 100 mg/kg (100 ppm). Other components may include, but are not limited to, antioxidants, beta-glucans, bile salt, cholesterol, enzymes, monosodium glutamate, carotenoids, etc.

The aquaculture feed composition can be prepared as a feed premix, i.e., a crude mixture of aquaculture feed components, which is subsequently processed into an aquaculture feed composition that is in the form of flakes, pellets or tablets. For example, the aquaculture feed may be dried using any conventional drying apparatus, such as a drum dryer or a vacuum dryer, to reduce the moisture content of the composition to about five weight percent, or less, based on the total weight of the aquaculture feed. As other suitable examples, drying may be through air-drying, using a fan or blower, or a vacuum. After being dried, the aquaculture feed may optionally then be ground to a desired particle size range, such as to the consistency of a meal or flour. Exemplary aquaculture feed compositions and processing methods are provided herein in the Examples.

In certain embodiments, the aquaculture feed composition has a balanced ratio of n3:n6 PUFA or a ratio in which n3 PUFA is up to 1.9 times more abundant than n6 PUFA. In accordance with this embodiment, the ratio of n3:n6 PUFA is at least 1:1 and less than 2:1, less than 1.9:1, less than 1.8:1, less than 1.7:1 or less than 1.6:1. In particular embodiments, the ratio of n3:n6 PUFA is in the range of 1.8:1 to 1:1; 1.7:1 to 1:1; 1.6 to 1:1; 1.5:1 to 1:1; 1.4:1 to 1:1; 1.3:1 to 1:1; 1.2:1 to 1:1; or 1.1:1 to 1:1.

The aquaculture feed composition of this invention finds application in aquaculture. Aquaculture is the practice of farming aquatic animals and plants. It involves cultivating an aquatic product (e.g., freshwater and saltwater organisms) under controlled conditions. It involves growing and harvesting fish, shellfish, and aquatic plants in fresh, brackish or salt water.

Organisms grown in aquaculture may include fish and crustaceans. However, the farming of finfish is the most common form of aquaculture. It involves raising fish commercially in tanks, ponds, or ocean enclosures, usually for food. Particularly of interest are freshwater tilapia such as Nile tilapia (Oreochromis niloticus), hybrid tilapia (Oreochromis niloticus×Oreochromis aureus), other Oreochromis tilapia species or fish of the salmonid group, for example, Atlantic salmon (Salmo salar), Pacific salmon, rainbow trout (Oncorhynchus mykiss), rainbow trout (Salmo gairdneri), Arctic charr (Alvelinus alpines), lake trout (Salvelinus namaycush), brook trout (Salvelinus fontinalis), cherry salmon (Oncorhynchus masou), Chinook salmon (Oncorhynchus tshawytscha), chum salmon (Oncorhynchus keta), coho salmon (Oncorhynchus kisutch), pink salmon (Oncorhynchus gorbuscha), and sockeye salmon (Oncorhynchus nerka). Other finfish of interest for aquaculture include, but are not limited to, sea bass, catfish (order Siluriformes), carp (family Cyprinidae) and cod (genus Gadus).

Given that the present aquaculture feed composition improves growth rates, feed conversion rate, protein efficiency ratio, and survival rates of fish, the present invention also provides a method for producing an aquaculture product, or aquaculture meat product thereof. An “aquaculture product” is a harvestable aquacultured species including a freshwater tilapia such as Nile tilapia (Oreochromis niloticus), hybrid tilapia (Oreochromis niloticus×Oreochromis aureus), other Oreochromis tilapia species; or a salmonid species including Atlantic salmon (Salmo salar), Pacific salmon, rainbow trout (Oncorhynchus mykiss), rainbow trout (Salmo gairdneri), Arctic charr (Alvelinus alpines), lake trout (Salvelinus namaycush) and brook trout (Salvelinus fontinalis), which is often sold for human consumption. For example, salmon and tilapia are intensively produced in aquaculture and thus are aquaculture products.

The term “aquaculture meat product” refers to food products intended for human consumption containing at least a portion of meat from an aquaculture product as defined above. An aquaculture meat product may be, for example, a whole fish or a filet cut from a fish, each of which may be consumed as food.

The method of producing an aquaculture product involves feeding a freshwater tilapia or a salmonid species a fish oil-free aquaculture feed composition of this invention, i.e., a composition containing a marine microalgae having an omega-3 long-chain polyunsaturated fatty acid content of at least 30% of the total fatty acids and at least one source of essential amino acids, wherein said composition improves growth rates, feed conversion ratio, protein efficiency ratio, and/or survival rates; and with a ratio of n3:n6 PUFA in the range of 1.8:1 to 1:1. The present composition can be used as the sole food source throughout the lifecycle of the fish or be combined with one or more different aquaculture feed compositions over time, which are formulated to meet the changing nutrient requirements needed during different stages of growth (Handbook of Salmon Farming; Stead and Laird (eds) (2002) Praxis Publishing Ltd., Chichester, UK). The present aquaculture feed compositions may be fed to animals to support their growth by any method of aquaculture known by one skilled in the art (Food for Thought: the Use of Marine Resources in Fish Feed, Editor: Tveferaas, head of conservation, WWF-Norway, Report #02/03 (2/2003)). Once the aquaculture animals reach an appropriate size, the crop is harvested, processed to meet consumer requirements, and can be shipped to market, generally arriving within hours of leaving the water.

Based on the disclosure herein, it will be clear that renewable alternatives to fish oil and fishmeal can be utilized as a means to produce aquaculture feed compositions. These modified formulations do not reduce fish health and may yield economic benefits to those performing aquaculture. Additionally, the modified formulations of the present invention will have societal benefits, as they will support sustainable aquaculture. Implementing sustainable alternatives to fish oil and fishmeal that can keep pace with the growing global demand for aquaculture products will also be advantageous.

The following non-limiting examples are provided to further illustrate the present invention.

### Example 1: Digestibility of Lipid and Fatty Acids from Marine Schizochytrium sp., and Protein and Essential Amino Acids from Spirulina sp.

Dietary Design.

A high-quality reference diet was prepared (Table 1)(Borgeson, et al. (2006) Aquacult. Nutr. 12:141-149; Hernández, et al. (2010) Aquacult. Nutr. 16:44-53) and combined with each test microalga species (pure Spirulina sp., Schizochytrium sp., and Chlorella sp. algae) at a 7:3 ratio (as is basis) to produce three test diets (one for each microalga species) following a conventional apparent digestibility protocol (Cho, et al. (1982) Comp. Biochem. Physiol. B 73:25-41; Bureau & Hua (2006) Aquaculture 252:103-105). Dried Schizochytrium sp. (SCI) was obtained from Aquafauna Bio-marine, Inc. (Hawthorne, Calif.) under the product name ALGAMAC, and dried Spirulina sp. (SPI) and Chlorella sp. (CHL) from Nuts.com (Cranford, N.J.). As a digestion indicator, SIPERNAT 50 (acid-insoluble ash) from Evonik Degussa Corporation (Parsippany, N.J.) was included in the basal diet at 1% (Goddard & McLean (2001) Aquaculture 194:93-98).

TABLE 1

| Ingredient | Amount (g/kg) |
|---|---|
| Fish meal | 300 |
| Soybean meal | 170 |
| Corn gluten meal | 130 |
| Fish oil | 100 |
| Wheat flour | 280 |
| Vitamin/mineral¹ | 10 |
| SIPERNAT 50 (silicon dioxide marker)² | 10 |
| Total | 1000 |

¹Vitamin/mineral premix (mg/kg dry diet unless otherwise stated): vitamin A (as acetate), 7500 IU/kg dry diet; vitamin D3 (as cholecalcipherol), 6000 IU/kg dry diet; vitamin E (as DL-α-tocopherylacetate), 150 IU/kg dry diet; vitamin K (as menadione Na-bisulphate), 3; vitamin B12 (as cyanocobalamin), 0.06; ascorbic acid (as ascorbyl polyphosphate), 150; D-biotin, 42; choline (as chloride), 3000; folic acid, 3; niacin (as nicotinic acid), 30; pantothenic acid, 60; pyridoxine, 15; riboflavin, 18; thiamin, 3; NaCl, 6.15; ferrous sulphate, 0.13; copper sulphate, 0.06; manganese sulphate, 0.18; potassium iodide, 0.02; zinc sulphate, 0.3; carrier (wheat middling or starch).
²SIPERNAT 50: Source of acid-insoluble ash composed of 98.50% SiO₂ with an average particle size of 50 μm.

The diets were produced by weighing and mixing oil and dry ingredients in a food mixer (Hobart Corporation, Tory, Ohio) for 15 minutes and then blending water (330 ml/kg diet) into the mixture to attain a consistency appropriate for pelleting. Each diet was subsequently passed through a meat grinder (PANASONIC, MK-G20NR) to create 4 mm-diameter pellets. After pelleting, the diets were dried to a moisture content of 80-100 g/kg under a hood at room temperature for 12 hours and stored at −20° C. Tables 2 and report the proximate composition, gross energy, amino acid and fatty acid profiles of the three test ingredients (microalgae) and of the four diets, respectively.

TABLE 2

| Ingredient | | |
|---|---|---|
| Spirulina | Chlorella | Schizochytrium |
| sp. | sp. | sp. |

Proximate composition (g/kg as is)

| | | | |
|---|---|---|---|
| Dry matter | 822 | 950 | 965 |
| Crude protein | 613 | 545 | 119 |
| Lipid | 55 | 94.2 | 541 |
| Ash | 69 | 53 | 87 |
| Crude fiber | 30 | 79 | 24 |
| Energy, kJ/g | 14.9 | 15.0 | 17.7 |

Essential amino acids (g/kg in weight of ingredient as is)

| | | | |
|---|---|---|---|
| Arginine | 41.0 | 29.0 | 8.0 |
| Lysine | 31.0 | 46.0 | 5.3 |
| Isoleucine | 26.0 | 15.0 | 3.7 |
| Leucine | 47.0 | 42.0 | 7.0 |
| Histidine | 10.0 | 10.0 | 3.0 |
| Methionine | 13.7 | 10.0 | 12.0 |
| Phenylalanine | 25.0 | 23.0 | 4.0 |
| Threonine | 27.0 | 20.0 | 4.0 |
| Tryptophan | 12.0 | 15.0 | 2.0 |
| Valine | 3.0 | 24.0 | 6.0 |

Fatty acids fractions (g/kg of total fatty acids)

| | | | |
|---|---|---|---|
| Total SFA | 477 | 233 | 358 |
| Total MUFA | 120 | 53 | 2.0 |
| Total PUFA | 402 | 713 | 639 |
| 20:5n-3 EPA | ND | ND | 8.0 |
| 22:6n-3 DHA | ND | ND | 438 |
| Total n-3 PUFA | ND | 43 | 461 |
| Total n-6 PUFA | 396 | 662 | 178 |

SFA, saturated fatty acids (sum of all fatty acids without double bonds); MUFA, monounsaturated fatty acids (sum of all fatty acids with a single bond); PUFA, polyunsaturated fatty acids (sum of all fatty acids with ≥2 double bonds); EPA, eicosapentaenoic acid; DHA, docosahexaenoic acid.
ND, not detectable (<10 g/kg of total fatty acids).

TABLE 3

| Diet | | | |
|---|---|---|---|
| | 70%-Ref + | 70%-Ref30%- | 70%-Ref + |
| Ref | 30%-SPI | CHL | 30%-SCI |

Proximate composition (g/kg as is as is)

| | | | | |
|---|---|---|---|---|
| Dry matter | 941 | 914 | 929 | 933 |
| Crude protein | 396 | 467 | 437 | 306 |
| Lipid | 134 | 100 | 104 | 230 |
| Ash | 87 | 79 | 72 | 85 |
| Crude fiber | 13 | 11 | 14 | 8 |
| Energy kj g⁻¹ | 16.7 | 16.0 | 16.4 | 18.8 |

Essential amino acid (g/kg in the weight of diet as is)

| | | | | |
|---|---|---|---|---|
| Arginine | 18.0 | 21.0 | 20.0 | 14.0 |
| Lysine | 18.0 | 23.0 | 26.0 | 14.0 |
| Isoleucine | 10.0 | 14.0 | 12.0 | 7.0 |
| Leucine | 29.0 | 35.0 | 34.0 | 23.0 |
| Histidine | 7.0 | 8.0 | 9.0 | 6.0 |
| Methionine | 8.7 | 9.0 | 9.0 | 9.0 |
| Phenylalanine | 15.0 | 17.0 | 17.0 | 12.0 |
| Threonine | 12.0 | 14.0 | 13.0 | 8.0 |
| Tryptophan | 4.0 | 4.0 | 4.0 | 3.0 |
| Valine | 13.0 | 17.0 | 17.0 | 10.0 |

Fatty acid fractions (g/kg of total fatty acids)

| | | | | |
|---|---|---|---|---|
| Total SFA | 322 | 348 | 313 | 341 |
| Total MUFA | 235 | 218 | 215 | 95 |
| Total PUFA | 443 | 433 | 470 | 563 |
| 20:5n-3 EPA | 124 | 107 | 112 | 56 |
| 22:6n-3 DHA | 103 | 89 | 93 | 302 |
| Total n-3 PUFA | 305 | 263 | 278 | 399 |
| Total n-6 PUFA | 103 | 141 | 160 | 149 |

Ref, reference diet; SPI, Spirulina sp; CHL, Chlorella sp; SCI, Schizochytrium sp.; SFA, saturated fatty acids (sum of all fatty acids without double bonds); MUFA, monounsaturated fatty acids (sum of all fatty acids with a single bond); PUFA, polyunsaturated fatty acids (sum of all fatty acids with ≥2 double bonds); EPA, eicosapentaenoic acid; DHA, docosahexaenoic acid.

Experimental Design, Fish Rearing and Feeding.

Experiments were conducted in a wet lab using twelve indoor, static-water 114-L cylindro-conical tanks fitted with feces settling columns. Each tank contained bio-ball and sponge biological filters. Each tank was filled with charcoal filtered de-chlorinated tap water and provided with aeration through an air stone diffuser via a low-pressure electrical blower.

Nile tilapia (O. niloticus) juveniles were obtained from a population derived from a 2004 import of fish collected from the Bueng Boraphet reservoir in central Thailand (Sukmanomon, et al. (2012) Kasetsart J. (Natural Science) 46:1-18) and propagated at the Dartmouth Organic Farm. Prior to the start of the experiment, fish were randomly assigned to a tank at 4 g/L stocking density (17 tilapia/tank, mean weight of 20.0 g/fish), wherein the photoperiod was maintained at 10 hours light and 14 hour dark cycle. Fish were acclimated to the experimental conditions for seven days before starting the experiment, during which they were fed the reference diet. The four experimental diets were randomly allocated to 12 tanks and each diet was fed to three replicate tanks. The fish were acclimated to the experimental diets for seven days before initiation of feces collection. Fish were hand-fed two times daily between 0930 and 1700 h and uneaten feed collected after each feeding so as not to mix with fecal samples. Appropriate restricted pair feeding was employed to supply the same quantity of dietary nutrients (feed) to the groups (Glencross, et al. (2007) Aquacult. Nutr. 13:17-34). This included feeding fish in each tank to apparent satiation every Monday morning, and then fixing the smallest amount of feed fed to any tank on Monday morning as the weight of feed to be given to each tank at every feeding for the rest of the week. Morning and afternoon feed amounts were equal. The Tuesday morning feeds were adjusted so that the total weekly feed was the same for every tank.

Water quality monitoring three times per week confirmed that excellent conditions were maintained for tilapia. Ten to fifteen percent of the tank water was exchanged each week. Water temperature throughout the experiment was kept within the range 27.0-28.0° C. The range of values for other variables were pH 6.5 to 7.9, dissolved oxygen 6.8 to 9.8 mg/L, nitrite 0.01 to 0.19 mg/L, and total ammonia nitrogen 0.03 to 0.31 mg/L.

Fecal Collection.

Fish fecal samples were collected twice a day, once before the morning feeding and once before the afternoon feeding, for 60 days from an unstirred fecal collection column affixed to the bottom of each tank. Usually for the number of fish and the fish size used in this study, a 40-day fecal collection would have sufficed. However, this experiment was part of a larger study that included analysis for phosphorus (P) digestibility to determine the P budget, and the need to allocate some fecal material to that analysis required a longer fecal collection period.

Uneaten feed residues and feces were flushed out of the fecal collection column after each feeding. To collect feces, the bottom of the tank was sealed from the collector column by closing a valve, gently removing the column and then gently withdrawing settled feces and surrounding water from the fecal collector using electronic pipetting (EPPENDORF EASYPET Serological Pipette Dispenser). Samples were placed in 50 ml FALCON tubes (BD FALCON). Samples were allowed to settle in the tube before removing supernatant water with the pipette. Supernatant was subsequently frozen at −20° C. Fecal samples were pooled by tank for the duration of the experiment. At the end of the experiment, the samples were lyophilized, finely ground, and stored at −20° C. for proximate, amino acid and fatty acid analyses.

Chemical Analysis and Calculations.

Three types of samples (pure microalgae, diets and feces) were sent to New Jersey Feed Laboratory, Inc. (Ewing, N.J.) for the following types of analysis: moisture (Association of Official Analytical Chemists, AOAC, 1995, no 930.15), crude protein (AOAC 990.03), lipid (AOAC 920.39), ash (AOAC 942.05), crude fiber (AOAC 1978.10), energy (automated oxygen bomb calorimeter), amino acids (high-performance liquid chromatography, HPLC analysis, via AOAC methods 994.12, 985.28, 988.15, and 994.12) and fatty acids (fatty acids methyl esters, FAME analysis, via AOAC method 963.22). It should be noted that the New Jersey Feed Laboratory prepared the samples differently for the analysis of methionine and tryptophan.

In addition, acid-insoluble ash (AIA) was analyzed in feed and feces according to known methods (Naumann & Bassler (1976) VDLUFA-Methodenbuch, Diechemische Untersuchung von Futtermitteln, vol. 3. Neumann Neudamm, Melsungen; Keulen & Young (1977) J. Anim. Sci. 44:282-287).

Apparent digestibility coefficients (ADC) were calculated for macro nutrients, amino acids, fatty acids and energy of the test and the reference diets using the following method:

ADC=1−(F/D×Dᵢ/Fᵢ)

wherein, D=% nutrient (or kJ/g gross energy) of diet; F=% nutrient (or kJ/g gross energy) of feces; Dᵢ=% digestion indicator (acid-insoluble ashes; AIA) of diet; Fᵢ=% digestion indicator (AIA) of feces. See Cho, et al. (1982) Comp. Biochem. Physiol. B 73:25-41.

The apparent digestibility of the microalgae as test ingredients was calculated using the following equation:

ADCₜₑₛₜ ingredient=ADC_{test diet}+((ADC_{test diet}−ADC_{ref. diet})×(0.7×D_{ref}/0.3×D_{ingredient}))

wherein, D_{ref} is the percentage of nutrient or kcal/g gross energy in the reference diet, and D_{ingredient} is the percentage of nutrient or kcal/g gross energy in the ingredient. See Forster (1999) Aquacult. Nutr. 5:143-145; Bureau & Hua (2006) Aquaculture 252:103-105; National Research Council (NRC) (2011) Nutrient Requirements of Fish and Shrimp. National Academies Press, Washington, D.C.

Statistical Analysis.

One-way analysis of variance (ANOVA) of apparent digestibility coefficients was conducted for macronutrients, fatty acids and amino acids in the reference and test diets, as well as for test ingredients. When significant differences were found, the treatment means were compared using Tukey's test of multiple comparisons with 95% level of significance. Data were expressed as the mean with pooled SEM of three replicates. Statistical analyses were carried out using the IBM Statistical Package for the Social Sciences (SPSS) program for Windows (v. 20.0, USA).

Digestibility of Energy and Macronutrients in Diets and Test Ingredients.

Significant differences among diets (Table 4) were not detected for the ADC of dry matter (ranged from 79.7 to 81.8%), lipid (ranged from 95.2 to 96.6%), ash (ranged from 47.9 to 53.3%) and gross energy (ranged from 84.1 to 86.4%). Although the ADCs of crude protein in all microalgae diets were similar to that of the reference diet (ranged from 82.2 to 86.2%), SPI had a significantly higher value than SCI (Table 4). Also, the ADC of crude fiber (ranged from 66.5 to 89.8%) was significantly higher in the reference and SPI diets than the CHL and SCI diets.

TABLE 4

| Diet | | | | | |
|---|---|---|---|---|---|
| | 70%-Ref + | 70%-Ref + | 70%-Ref + | Pooled | P- |
| Ref | 30%-SPI | 30%-CHL | 30%-SCI | SEM | value |

ADC (%)

| | | | | | | |
|---|---|---|---|---|---|---|
| Dry matter | 81.1 | 81.8 | 79.7 | 80.5 | 0.7 | 0.2 |
| Crude protein | 84.7^{ab} | 86.2^{a} | 83.9^{ab} | 82.2^{b} | 0.7 | 0.02 |
| Lipid | 95.2 | 96 | 96.4 | 96.6 | 0.6 | 0.09 |
| Ash | 47.9 | 53.1 | 49.7 | 53.3 | 1.7 | 0.1 |
| Crude fiber | 89.8^{a} | 84.8^{a} | 66.5^{b} | 72.3^{b} | 0.9 | <0.01 |
| Energy | 86.1 | 86.3 | 84.1 | 86.4 | 0.6 | 0.07 |

Essential amino acids

| | | | | | | |
|---|---|---|---|---|---|---|
| Arginine | 85.2^{b} | 89.6^{a} | 90^{a} | 89^{a} | 0.8 | 0.01 |
| Lysine | 87.2^{b} | 92.8^{a} | 78.1^{c} | 88.6^{b} | 0.7 | <0.01 |
| Isoleucine | 77.2^{b} | 86.3^{a} | 80.7^{ab} | 80.7^{ab} | 1.4 | 0.01 |
| Leucine | 86.3^{b} | 91.7^{a} | 88.9^{ab} | 89.8^{a} | 0.5 | <0.01 |
| Histidine | 87.4^{b} | 93.9^{a} | 89.9^{ab} | 91.1^{a} | 0.8 | <0.01 |
| Methionine | 85.3^{b} | 94.1^{a} | 88.8^{b} | 89.6^{b} | 0.5 | <0.01 |
| Phenyl-alanine | 82.1^{c} | 91^{a} | 86.1^{b} | 85.8^{b} | 0.8 | <0.01 |
| Threonine | 78.6^{b} | 86.9^{a} | 83.6^{b} | 80.6^{b} | 1 | <0.01 |
| Tryptophan | 81.8^{b} | 89.2^{a} | 81.9^{a} | 88.4^{a} | 1.4 | 0.01 |
| Valine | 81.9^{b} | 87.7^{a} | 86^{a} | 85.5^{ab} | 0.8 | <0.01 |

Fatty acid fractions

| | | | | | | |
|---|---|---|---|---|---|---|
| Total SFA | 64.3^{b} | 68.7^{a} | 72.8^{a} | 57^{c} | 1 | <0.01 |
| Total MUFA | 81.6^{ab} | 80.6^{b} | 80.5^{b} | 84.5^{a} | 1 | 0.02 |
| Total PUFA | 89.6^{b} | 86.7^{b} | 90.1^{b} | 94.0^{a} | 1 | <0.01 |
| 20:5n3 EPA | 91.3^{ab} | 89.0^{b} | 87.8^{b} | 94.5^{a} | 1.2 | 0.05 |
| 22:6n3 DHA | 91.4^{ab} | 87.7^{b} | 85.9^{bc} | 95.0^{a} | 1 | <0.01 |
| Total n3 PUFA | 91.1^{ab} | 88.2^{b} | 86.6^{bc} | 94.4^{a} | 0.8 | <0.01 |
| Total n6 PUFA | 85.2^{b} | 84.2^{b} | 78.8^{c} | 92.9^{a} | 1 | 0.03 |

Reference (ref), Spirulina (SPI), Chlorella (CHL) and Schizochytrium (SCI).
SFA, saturated fatty acids (sum of all fatty acids without double bonds); MUFA, monounsaturated fatty acids (sum of all fatty acids with a single bond); PUFA, polyunsaturated fatty acids (sum of all fatty acids with ≥2 double bonds); EPA, eicosapentaenoic acid; DHA, docosahexaenoic acid.
*Means of ADC of nutrients in reference and test diets for tilapia. Mean values across the row not sharing a common superscript were significantly different as determined by Tukey's HSD test, P < 0.05.

The ADC of most nutrients and gross energy were significantly different among three microalgae ingredients (Table 5). The ADC of crude protein in SPI (86.1%) was significantly higher than in CHL (80.0%). The ADC of crude fiber in CHL (57.5%) was lower than in SPI (83.3%) and SCI (70.6%). The ADC of lipid was highest in SCI (97.9%) followed by SPI (94.5%) and CHL (94.4%). The highest ADC of gross energy was found for SCI (86.5%), which was not different from SPI (86.3%), while the lowest value was obtained for CHL (83.9%). The highest ADC of dry matter and ash was obtained for SCI and SPI, respectively, but there was no significant difference among test microalgae.

TABLE 5

| Ingredient | | | | |
|---|---|---|---|---|
| SPI | CHL | SCI | SEM | P-value |

ADC (%)

| | | | | | |
|---|---|---|---|---|---|
| Dry matter | 79.7 | 73.4 | 81.8 | 1.8 | 0.1 |
| Crude protein | 86.1^{a} | 80.0^{b} | 81.7^{ab} | 0.6 | 0.02 |
| Lipid | 94.5^{b} | 94.4^{b} | 97.9^{a} | 0.4 | 0.03 |
| Ash | 68.5 | 56.6 | 65.9 | 6.1 | 0.8 |
| Crude fiber | 83.3^{a} | 57.5^{c} | 70.6^{b} | 1.5 | <0.01 |
| Energy | 86.3^{a} | 83.9^{b} | 86.5^{a} | 0.5 | 0.03 |

Essential amino acids

| | | | | | |
|---|---|---|---|---|---|
| Arginine | 94^{b} | 96.7^{a} | 100^{a} | 1.5 | 0.05 |
| Lysine | 100^{a} | 68.9^{b} | 90.9^{a} | 1.6 | <0.01 |
| Isoleucine | 94.9 | 86.5 | 91.9 | 2.9 | 0.08 |
| Leucine | 99.7^{a} | 93.4^{b} | 100^{a} | 1.5 | <0.01 |
| Histidine | 100^{a} | 94.1^{b} | 93.1^{b} | 1.2 | <0.01 |
| Methionine | 100^{a} | 93.9^{b} | 100^{a} | 1.8 | 0.01 |
| Phenylalanine | 100^{a} | 92.3^{b} | 100^{a} | 1.3 | <0.01 |
| Threonine | 95.3^{a} | 90.5^{b} | 93.3^{a} | 1.5 | 0.03 |
| Tryptophan | 96.2 | 95.5 | 89.6 | 2.2 | 0.4 |
| Valine | 93.2^{ab} | 91.5^{b} | 99^{a} | 1.8 | 0.03 |

Fatty acid fractions

| | | | | | |
|---|---|---|---|---|---|
| Total SFA | 75.5^{a} | 74.7^{a} | 52^{b} | 3.2 | <0.01 |
| Total MUFA | 76.1 | 69.6 | 84.8 | 5.6 | 0.08 |
| Total PUFA | 79.1^{b} | 90.9^{a} | 97.5^{a} | 2.7 | 0.05 |
| 20:5n3 EPA | ND | ND | 100 | | |
| 22:6n3 DHA | ND | ND | 93.8 | | |
| Total n3 PUFA | ND | 39.1^{b} | 97.2^{a} | 2.1 | <0.01 |
| Total n6 PUFA | 83.5^{b} | 76.7^{b} | 92.4^{a} | 1 | 0.01 |

Spirulina (SPI), Chlorella (CHL) and Schizochytrium (SCI). SFA, saturated fatty acids (sum of all fatty acids without double bonds); MUFA, monounsaturated fatty acids (sum of all fatty acids with a single bond); PUFA, polyunsaturated fatty acids (sum of all fatty acids with ≥2 double bonds); EPA, eicosapentaenoic acid; DHA, docosahexaenoic acid.
*Means of ADC of nutrients in reference and test diets for tilapia. Mean values across the row not sharing a common superscript were significantly different as determined by Tukey's HSD test, P < 0.05.
ND, not detectable (<1% of total fatty acids).

Digestibility of Amino Acids in Diets and Test Ingredients.

The ADCs of all essential amino acids (EAAs) showed significant differences between the reference and one or more test diets (Table 4). The ADC of all individual EEAs was generally higher in the diet with SPI compared to the reference and other test diets. In contrast, the ADC of most individual EAAs was lowest in the CHL diet followed by the reference and SCI diets.

The ADCs of all EAAs among the microalgae ingredients were significantly different except for those of isoleucine and tryptophan (Table 5). The ADCs of most individual EEAs were significantly higher in SPI than CHL. However, no difference was observed between SPI and SCI for most EAAs, except for arginine and histidine that were highest and lowest, respectively, in SCI. The lowest ADC value of lysine, methionine, leucine, phenylalanine, threonine and valine was found in CHL compared with SPI and SCI.

Digestibility of Fatty Acids in Diets and Feed Ingredients.

The ADCs of fatty acids in reference and test diets were higher than 80%, except for saturated fatty acids, SFA (Table 4). With the exception of SFA, ADCs of all fatty acid fractions were significantly higher in the diet with SCI than in the SPI and CHL test diets. The ADCs of total monounsaturated fatty acid (MUFA), total polyunsaturated fatty acids (PUFA), EPA, DHA, n-3 PUFA and total n-6 PUFA were higher in the SCI diet than in the reference diet and other two test diets.

ADCs of all fatty acid fractions among the microalgae ingredients were significantly different except for that of total MUFA (Table 5). The lowest ADC value of total SFA was found in SCI when compared with SPI and CHL. The ADCs of total n3-PUFA and n6-PUFA were significantly higher in SCI (97.2 and 92.4%) than in both the CHL (39.1 and 76.7%) and SPI (n3-PUFA was not detectable and 83.5%). The ADC of total PUFA was significantly higher in SCI (97.5%) than in SPI (79.1%); however, no difference was observed between SCI and CHL. EPA and DHA were not detectable in SPI and CHL, but had high ADCs in SCI (100 and 93.8%). The highest ADC of total MUFA was obtained for SCI, followed by SPI and CHL, but there was no significant difference among test microalgae.

### Example 2: Marine Microalgae for Replacing Fish Oil in Freshwater Fish Aquafeeds

Experimental Design, Fish Rearing and Feeding.

Nile tilapia (O. niloticus) juveniles were obtained from Americulture Inc. (Animas, N. Mex.). Experiments were conducted in a wet lab using fifteen indoor, static-water 114-L cylindro-conical tanks. Each tank was filled with charcoal filtered de-chlorinated tap water and provided aeration through an air stone diffuser via a low-pressure electrical blower. Each tank contained bio-ball and sponge biological filters. Prior to the start of the experiment, 40 tilapia were randomly assigned to each tank with an initial mean weight of 1.52±0.2 g/fish, and accustomed to a photoperiod cycle of 10 hours light and 14 hours dark. Fish were acclimated to the experimental conditions for two weeks before starting the experiment, during which they were fed the control diet. The five experimental diets were randomly allocated to 15 tanks and each diet was fed to three replicate tanks (n=3) in a completely randomized design. Fish were hand-fed three times daily at 0930, 1300 and 1700 h. At the start of the trial, feed was administered at a rate of 10% of body weight. The daily satiation ration was recorded and used as guidance for gradually reducing the feeding rate to 4% of body weight at the end of the trial, as has been described for tilapia (Hussein, et al. (2012) Aquaculture Res. 44:937-949; Karapanagiotidis, et al. (2007) Lipids 42:547-559), and NRC 2011 (NRC (National Research Council) (2011) Nutrient Requirements of Fish and Shrimp. National Academies Press, Washington, D.C., USA)].

All water quality parameters, monitored during the course of the study, confirmed that the tilapia were maintained under excellent conditions. Ten to fifteen percent of the tank water was exchanged each week. Water temperature throughout the experiment was kept within the range of 26.4 to 28.2° C. with a thermostat-regulated, immersion heater in each tank (Hagen Marina Submersible Pre-Set Aquarium Heater, 150 W). The range of values for other variables were pH 7.17 to 7.60, dissolved oxygen 6.18 to 7.13 mg/L, nitrite 0.10 to 0.20 mg/L, and total ammonia nitrogen 0.23 to 0.53 m/L.

Feed Formulation and Pellet Preparation.

Five iso-nitrogenous (38% crude protein), iso-energetic (14 kJ/g) and iso-lipidic (10% lipid) experimental diets were formulated following the requirements for optimum growth of juvenile Nile tilapia (National Research Council (2011) Nutrient Requirements of Fish and Shrimp. National Academies Press, Washington, D.C.). A control diet was prepared for juvenile tilapia, adapted from a proven high quality formulation (Trushenski, et al. (2009) N. Am. J. Aquaculture 71:242-251). The diets differed from each other in their relative amounts of fish oil (menhaden-derived) and dried whole-cells of Schizochytrium sp. (Sc). They also differed in relative amounts of wheat flour, which was used as a filler in the diet. Feed containing fish oil (Sc0) was designated as the control, whereas in experimental feeds, 25% fish oil (Sc25), 50% fish oil (Sc50), 75% fish oil (Sc75), and 100% fish oil (Sc100) was substituted with dried whole cells of Schizochytrium sp. (Table 6).

TABLE 6

| | Diet (g/100 g diet) | | | | |
|---|---|---|---|---|---|
| | Control | | | | |
| Ingredient | (Sc0) | Sc25 | Sc50 | Sc75 | Sc100 |
| Fish meal* | 20 | 20 | 20 | 20 | 20 |
| Corn gluten meal | 20 | 20 | 20 | 20 | 20 |
| Soybean meal | 20 | 20 | 20 | 20 | 20 |
| Wheat flour | 26.25 | 24.5 | 22.75 | 20.5 | 19.15 |
| CaH₂PO₄ | 0.75 | 0.75 | 0.75 | 0.75 | 0.75 |
| Vitamin mix¹ | 1 | 1 | 1 | 1 | 1 |
| Mineral mix² | 1 | 1 | 1 | 1 | 1 |
| Fish oil | 9 | 6.75 | 4.5 | 2.25 | 0 |
| Schizochytrium sp. | 0 | 4 | 8 | 12.5 | 16.1 |
| Choline chloride | 2 | 2 | 2 | 2 | 2 |

Proximate composition (%)

| | | | | | |
|---|---|---|---|---|---|
| Dry matter | 88.2 | 89 | 90.2 | 89.4 | 91.2 |
| Crude protein | 38.2 | 38.6 | 39.3 | 39.1 | 39.3 |
| Lipid | 11.1 | 11.1 | 10.6 | 10.7 | 10.2 |
| Ash | 7 | 7.4 | 7.2 | 8 | 8.6 |
| Carbohydrate | 31 | 31.8 | 32.2 | 31.4 | 32 |
| Gross energy (kJ/g) | 14 | 14.1 | 14.2 | 14 | 14.1 |

Amino acids (% in the weight of diet as is)

| | | | | | |
|---|---|---|---|---|---|
| Arginine | 2 | 2 | 2.1 | 2 | 2.2 |
| Lysine | 2 | 2 | 2.1 | 1.8 | 2.1 |
| Isoleucine | 1.4 | 1.4 | 1.6 | 1.4 | 1.5 |
| Leucine | 3.7 | 3.9 | 4.1 | 3.7 | 4.2 |
| Histidine | 0.8 | 0.8 | 0.8 | 0.8 | 0.8 |
| Methionine | 0.8 | 0.8 | 0.9 | 0.9 | 0.8 |
| Cystine | 0.5 | 0.5 | 0.5 | 0.5 | 0.5 |
| Phenylalanine | 1.8 | 1.9 | 2 | 1.8 | 2.1 |
| Threonine | 1.3 | 1.3 | 1.5 | 1.2 | 1.5 |
| Tryptophan | 0.2 | 0.2 | 0.2 | 0.1 | 0.1 |
| Valine | 1.6 | 1.6 | 1.8 | 1.6 | 1.8 |

¹Vitamin premix (mg/kg dry diet unless otherwise stated): vitamin A (as acetate), 7500 IU/kg dry diet; vitamin D3 (as cholecalcipherol), 6000 IU/kg dry diet; vitamin E (as DL-a-tocopherylacetate), 150 IU/kg dry diet; vitamin K (as menadione Na-bisulphate), 3; vitamin B12 (as cyanocobalamin), 0.06; ascorbic acid (as ascorbyl polyphosphate), 150; D-biotin, 42; choline (as chloride), 3000; folic acid, 3; niacin (as nicotinic acid), 30; pantothenic acid, 60; pyridoxine, 15; riboflavin, 18; thiamin, 3.
²Minera1 premix (mg/kg dry diet unless otherwise stated): ferrous sulphate, 0.13; NaCl, 6.15; copper sulphate, 0.06; manganese sulphate, 0.18; potassium iodide, 0.02; zinc sulphate, 0.3; carrier (wheat middling or starch).
*Omega Protein, Inc. (Houston, TX), as manufacturer specification, the guaranteed gross composition analysis: crude protein, 60%; crude fat, 6%; fiber, 2%.

Dried Schizochytrium sp. was obtained from ALGAMAC (Aquafauna Bio-Marine, Inc., CA). Menhaden fish oil was obtained from Double Liquid Feed Service, Inc. (Danville, Ill.). The diets were produced by weighing and mixing oil and dry ingredients in a stand mixer (Hobart Corporation, Tory, Ohio) for 15 minutes; blending water (330 ml/kg diet) into the mixture to attain a texture appropriate for pelleting; and running each diet through a meat grinder (Panasonic) to create 2 mm-diameter pellets. After pelleting, the diets were dried to a moisture content of 80-100 g/kg under a chemical fume hood at room temperature for 12 hours and the finished diets were stored at −20° C. Table 7 reports the proximate composition, gross energy, and amino acid profiles of dried Sc and Table 8 reports the fatty acid profile of dried Sc and menhaden fish oil. Table 9 reports the fatty acid profiles of the five experimental diets.

TABLE 7

| | Ingredient |
|---|---|
| Composition | Schizochytrium sp. |
| Dry matter | 96.5 |
| Crude protein | 11.9 |
| Lipid | 54.1 |
| Ash | 8.7 |
| Crude fiber | 2.4 |
| Energy | 17.7 |

Essential amino acids
(% in the weight of ingredient as is)

| | |
|---|---|
| Arginine | 0.8 |
| Lysine | 0.5 |
| Isoleucine | 0.4 |
| Leucine | 0.7 |
| Histidine | 0.3 |
| Methionine | 1.2 |
| Phenylalanine | 0.4 |
| Threonine | 0.4 |
| Tryptophan | 0.2 |
| Valine | 0.6 |

Non-essential amino acids
(% in the weight of ingredient as is)

| | |
|---|---|
| Aspartic acid | 1.2 |
| Serine | 0.4 |
| Glutamic acid | 1.9 |
| Glycine | 0.5 |
| Tyrosine | 0.3 |
| Alanine | 0.8 |
| Hydroxyproline | 0.0 |
| Proline | 0.5 |

TABLE 8

Lipid source (% of TFA)

| Fatty acid | Fish oil | Schizochytrium sp. |
|---|---|---|
| 14:00 | 8.1 | 9.3 |
| 15:00 | 0.6 | 0.5 |
| 16:00 | 17.9 | 24.4 |
| 17:00 | 0.6 | ND |
| 18:00 | 3.1 | 0.5 |
| 20:00 | 0.2 | 0.1 |
| 22:00 | 0.1 | 0.1 |
| 24:00 | ND | ND |
| Total SFA | 6.6 | 9.2 |
| 16:1n9 | 0.2 | ND |
| 16:1n7 | 13.9 | 0.2 |
| 18:1n9 | 5.2 | 0.1 |
| 18:1n7 | 3.3 | ND |
| 20:1n9 | 0.6 | ND |
| 20:1n7 | 0.2 | ND |
| 22:1n11 | ND | ND |
| 22:1n9 | 0.1 | ND |
| 24:1n9 | 0.4 | 1.4 |
| Total MUFA | 23.9 | 1.7 |
| 18:2n6 | 1.5 | ND |
| 18:3n6 | 0.3 | 0.2 |
| 20:2n6 | 0.2 | ND |
| 20:3n6 | 0.2 | 0.3 |
| 20:4n6 ARA | 1.3 | 1.4 |
| 22:4n6 | 0.3 | 0.1 |
| 22:5n6 | 0.5 | 15.8 |
| Total n6 PUFA | 4.3 | 17.8 |
| 18:3n3 ALA | 1.5 | ND |
| 18:4n3 | 2.7 | 0.6 |
| 20:3n3 | 0.2 | 0.1 |
| 20:4n3 | 1.4 | 0.8 |
| 20:5n3 EPA | 14.9 | 0.8 |
| 22:5n3 | 2.6 | 0.4 |
| 22:6n3 DHA | 13 | 43.2 |
| Total n3 PUFA | 36.3 | 45.9 |
| Total PUFA | 40.6 | 63.7 |
| Total n6 LCPUFA | 2.5 | 17.6 |
| Total n3 LCPUFA | 32.1 | 45.3 |
| n3:n6 PUFA ratio | 8.4 | 2.6 |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
n6 PUFA, omega-6 polyunsaturated fatty acids (18:2, 18:3, 20:2, 20:3, 20:4, 22:4, 22:5);
n6 LCPUFA, omega-6 long chain polyunsaturated fatty acids (20:2, 20:3, 20:4, 22:4, 22:5);
n3 PUFA, omega-3 polyunsaturated fatty acids (18:3, 18:4, 20:3, 20:4, 20:5, 22:5, 22:6); n3 LCPUFA, omega-3 long chain polyunsaturated fatty acids (20:3, 20:4, 20:5, 22:5, 22:6); EPA, eicosapentaenoic acid;
DHA, docosahexaenoic acid;
ND, not detectable (<0.1% of total fatty acids).

TABLE 9

| | Diet (% of TFA) | | | | |
|---|---|---|---|---|---|
| | Control | | | | |
| Fatty acid | (Sc0) | Sc25 | Sc50 | Sc75 | Sc100 |
| 14:00 | 7.6 | 8 | 8.2 | 8 | 8 |
| 15:00 | 0.5 | 0.6 | 0.5 | 0.5 | 0.5 |
| 16:00 | 18.4 | 19.6 | 20.7 | 21.7 | 22.8 |
| 17:00 | 0.6 | 0.5 | 0.4 | 0.3 | 0.1 |
| 18:00 | 3.2 | 3.0 | 2.4 | 1.8 | 1.3 |
| 20:00 | 0.2 | 0.2 | 0.2 | 0.1 | 0.2 |
| 22:00 | 0.2 | 0.1 | 0.1 | 0.1 | 0.2 |
| 24:00 | 0.1 | 0.1 | 0.1 | 0.1 | 0.2 |
| Total SFA | 30.8 | 32.1 | 32.6 | 32.6 | 33.3 |
| 16:1n9 | 0.2 | 0.2 | 0.2 | ND | ND |
| 16:1n7 | 11 | 9.1 | 6.8 | 4.1 | 2.0 |
| 18:1n9 | 7.8 | 6.7 | 5.6 | 5.0 | 4.2 |
| 18:1n7 | 7.9 | 2.4 | 1.8 | 1.7 | 0.7 |
| 20:1n9 | 0.5 | 0.4 | 0.3 | 0.2 | 0.1 |
| 20:1n7 | 0.2 | 0.1 | 0.1 | 0.3 | ND |
| 22:1n11 | ND | ND | ND | ND | ND |
| 22:1n9 | ND | ND | ND | ND | ND |
| 24:1n9 | 0.3 | 0.5 | 0.6 | 0.9 | 1.0 |
| Total MUFA | 23 | 19.4 | 15.4 | 11.7 | 8.0 |
| 18:2n6 | 10.1 | 9.4 | 9.1 | 9.2 | 9.6 |
| 18:3n6 | 0.3 | 0.2 | 0.2 | 0.2 | 0.1 |
| 20:2n6 | 0.2 | 0.1 | 0.1 | ND | ND |
| 20:3n6 | 0.2 | 0.2 | 0.2 | ND | 0.3 |
| 20:4n6 ARA | 1.2 | 1.3 | 1.2 | 1.2 | 1.3 |
| 22:4n6 | 0.2 | 0.2 | 0.1 | 0.1 | 0.1 |
| 22:5n6 | 0.8 | 3 | 5.7 | 8.5 | 10.8 |
| Total n6 PUFA | 13 | 14.4 | 16.6 | 19.2 | 22.2 |
| 18:3n3 ALA | 1.6 | 1.4 | 1.1 | 0.9 | 0.7 |
| 18:4n3 | 1.9 | 1.6 | 1.2 | 0.8 | 0.4 |
| 20:3n3 | 0.2 | 0.1 | 0.1 | 0.1 | ND |
| 20:4n3 | 1.0 | 1.0 | 0.8 | 0.8 | 0.6 |
| 20:5n3 EPA | 11.1 | 9.22 | 7.0 | 4.6 | 2.5 |
| 22:5n3 DPA | 2.1 | 1.8 | 1.3 | 1.0 | 0.6 |
| 22:6n3 DHA | 10.4 | 15 | 20.7 | 26.2 | 30.8 |
| Total n3 PUFA | 28.3 | 30.12 | 32.2 | 34.4 | 35.6 |
| Total PUFA | 41.3 | 44.52 | 48.8 | 53.6 | 57.8 |
| Total n6 LCPUFA | 2.6 | 4.8 | 7.3 | 9.8 | 12.5 |
| Total n3 LCPUFA | 24.8 | 27.12 | 29.9 | 32.7 | 34.5 |
| n3:n6 PUFA ratio | 2.2 | 2.1 | 1.9 | 1.8 | 1.6 |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
n6 PUFA, omega-6 polyunsaturated fatty acids (18:2, 18:3, 20:2, 20:3, 20:4, 22:4, 22:5);
n6 LCPUFA, omega-6 long chain polyunsaturated fatty acids (20:2, 20:3, 20:4, 22:4, 22:5);
n3 PUFA, omega-3 polyunsaturated fatty acids (18:3, 18:4, 20:3, 20:4, 20:5, 22:5, 22:6); n3 LCPUFA, omega-3 long chain polyunsaturated fatty acids (20:3, 20:4, 20:5, 22:5, 22:6);
EPA, eicosapentaenoic acid;
DHA, docosahexaenoic acid;
ND, not detectable (<1% of total fatty acids).

Biological Sampling Procedures, Fillet Preparations and Growth Measurements.

Fish were bulk weighed at the beginning of the experiment, and then every 3 weeks until the end of the experiment (84 days). Feeding was stopped for 24 hours prior to each bulk weight-sampling event. Five fish per tank were sampled at day 42 (middle) and day 84 (final) for the fillet fatty acid compositions. Fish were immediately euthanized by single cranial pithing, filleted from a standardized dorso-anterior landmark, packaged in sterile polythene bags (WHIRL-PAK, Naso, Fort Atkinson, Wis.) and stored frozen (−20° C.) until fatty acid analysis. At the end of the feeding experiment, 10 fish per tank were sampled, pooled, ground into a homogeneous slurry, freeze-dried, reground and stored at −20° C. until analyzed for the whole-body proximate analysis.

The dietary effects on growth was determined by evaluating final weight, weight gain, feed conversion ratio (FCR), specific growth rate (SGR), protein efficiency ratio (PER) and survival rate (%). The indices were calculated as follows: Weight gain (g)=final weight−initial weight; FCR, feed conversion ratio=feed intake (as fed basis)/weight gain; SGR, specific growth rate (%/day) 100×(ln final wet weight (g)−ln initial wet weight (g))/time (days); PER, protein efficiency ratio=weight gain (g)/protein fed (g); and survival rate (%)=(final number of fish/initial number of fish)×100.

Biochemical Analysis.

Five types of samples (pure microalgae, fish oil, diets, whole body and fillet) were sent to the New Jersey Feed Laboratory, Inc. (Ewing, N.J.) and subjected to the following types of analyses: moisture (AOAC, 930.15), crude protein (AOAC 990.03), lipid (AOAC 920.39), ash (AOAC 942.05), crude fiber (AOAC 1978.10), energy (automated oxygen bomb calorimeter), amino acids (high-performance liquid chromatography, HPLC analysis, via AOAC methods 994.12, 985.28, 988.15, and 994.12) and fatty acids (fatty acids methyl esters, FAME analysis, via AOAC method 963.22). Table 8 reports the fatty acid content of the two lipid sources used, menhaden fish oil and Sc whole dried cells; and Table 9 reports the fatty acid content of the five experimental diets.

Statistical Analysis.

One-way analysis of variance (ANOVA) of growth performance and feed utilization parameters, whole body proximate composition and fillet fatty acids deposition was conducted and, when significant differences were found, the treatment means were compared using Tukey's test of multiple comparisons with 95% level of significance. Data were expressed as the mean±SE of three replicates. A repeated measure analysis was conducted within the general linear model (GLM) framework for 42 and days of fillet fatty acids (% TFA) data to determine whether there were differences among dietary treatments, sampling time, or main effect interactions (diet×time). All statistical analyses were carried out using the IBM Statistical Package for the Social Sciences (SPSS) program for WINDOWS (v. 21.0, Armonk, N.Y., USA). The Pearson correlation coefficient between n3:n6 ratio of each diet and fish weight gain; and between Sc inclusion level in a diet and tissue deposition of DHA, weight gain and FCR data were computed.

Substitution of Fish Oil with Marine Microalgae Improves Growth and Feed Efficiency.

An 84-day growth experiment was conducted with dried whole-cells of Sc. The dietary effects on growth are presented in Table 10.

TABLE 10

| | Diet¹ | | | | | F value |
|---|---|---|---|---|---|---|
| | Sc0 | Sc25 | Sc50 | Sc75 | Sc100 | (P value) |
| Initial weight (g) | 1.4 ± 0.1 | 1.4 + 0.1 | 1.7 ± 0.2 | 1.5 ± 0.1 | 1.6 ± 0.1 | 1.5 (0.27) |
| Final weight (g) | 25.3 ± 0.3^{bc} | 26.4 ± 0.4^{bc} | 27.2 ± 0.7^{ab} | 27.4 ± 0.3^{ab} | 28.8 ± 0.2^{a} | 9.9 (<0.01) |
| Weight gain (g)² | 23.8 ± 0.4^{bc} | 24.9 ± 0.3^{bc} | 25.5 ± 0.7^{ab} | 25.8 ± 0.2^{ab} | 27.3 ± 0.2^{a} | 9.3 (<0.01) |
| FCR³ | 1.1 ± 0.0^{bc} | 1.0 ± 0.0^{bc} | 1.0 ± 0.1^{ab} | 0.9 ± 0.0^{ab} | 0.9 ± 0.0^{a} | 10.2 (<0.01) |
| SGR⁴ | 3.4 ± 0.1 | 3.5 ± 0.1 | 3.3 ± 0.0 | 3.4 ± 0.1 | 3.5 ± 0.1 | 0.8 (0.52) |
| PER⁵ | 2.4 ± 0.1^{bc} | 2.6 ± 0.1^{bc} | 2.7 ± 0.2^{ab} | 2.8 ± 0.1^{ab} | 3.1 ± 0.1^{a} | 9.6 (<0.01) |
| Survival rate (%)⁶ | 92.7 ± 0.4 | 95.2 ± 1.5 | 95.8 ± 0.8 | 92.3 ± 0.2 | 96.3 ± 2.6 | 0.9 (0.57) |

Values are means of ±SE of three replicate groups (n = 3).
¹Mean values not sharing a superscript letter in the same row differ significantly (P < 0.05).
² Weight gain (g) = final wet weight − initial wet weight.
³FCR, feed conversion ratio = feed intake/weight gain.
⁴Specific growth rate SGR (%/day) = 100 × (ln final wet weight (g) − ln initial wet weight (g))/Time (days).
⁵PER, protein efficiency ratio = weight gain (g)/protein fed (g).
⁶Survival rate (%) = (Final number of fish/Initial number of fish) × 100.

The results indicate significantly higher weight gain (g), feed conversion ratio (FCR) and protein efficiency ratio (PER) when fish oil was fully replaced by Sc (Sc100 diet) compared to control diet containing fish oil (Sc0 diet). Tilapia appeared healthy at the end of the experiment, and showed no difference in SGR and survival rate among all diets. Weight gain was in the range of 23.8 to 27.3 g. FCRs were within the range 0.9 to 1.1 and PERs were within the range 2.4 to 3.1 among all dietary treatments. A strong proportional linear relationship was observed between the Sc content of the diet and weight gain (y=0.0193x+23.895; r=0.970; P<0.01). The FCR decreased (improved) as the dietary Sc content increased, showing an inverse relationship (y=−0.054x+1.105; r=0.960; P<0.05).

The whole body proximate composition of Nile tilapia fillets did not differ among dietary treatments (Table 11). This included moisture, crude protein, ash and total lipid. The total lipid content ranged from 6.2 to 6.7% among the five dietary treatments.

TABLE 11

| | Diet | | | | | |
|---|---|---|---|---|---|---|
| Composition | Control | | | | | F value |
| (%)* | (ScO) | Sc25 | Sc50 | Sc75 | Sc100 | (P value) |
| Moisture | 70.5 ± 0.37 | 71.0 ± 0.2 | 70.8 ± 0.2 | 70.6 ± 0.7 | 70.7 ± 0.3 | 0.29 (0.87) |
| Crude protein | 16.4 ± 0.3 | 16.6 ± 0.2 | 16.5 ± 0.1 | 16.5 ± 0.6 | 16.1 ± 0.3 | 0.28 (0.88) |
| Lipid | 6.7 ± 0.3 | 6.4 ± 0.1 | 6.3 ± 0.2 | 6.2 ± 0.5 | 6.2 ± 0.4 | 1.8 (0.2) |
| Ash | 4.5 ± 0.1 | 4.6 ± 0.1 | 4.8 ± 0.1 | 4.6 ± 0.3 | 4.8 ± 0.1 | 0.46 (0.76) |

Values are the mean of three replicate groups of five fish (±SE). No significant diet differences were detected (P > 0.05) for whole body proximate compositions.
*Table reports the major components of proximate analysis (not including minor components, carbohydrate and fiber content)

The fillet fatty acids composition (% of total fatty acids) was significantly influenced either by the dietary treatment or the length of the experiment or both factors. With the exception of 18:0, all SFA fractions showed significant time effects and were higher at the middle (42 days; Table 12) than at the end of the experiment (84 days; Table 13). The composition of four SFA fractions (15:0, 18:0, 20:0, and 22:0) did not differ across dietary treatments. One SFA, palmitic acid (16:0), had the highest final concentration in the fillet irrespective of dietary treatment, as well as significantly higher amounts deposited in the flesh of tilapia fed the Sc100 diet compared to fish fed the Sc0 diet (P<0.01). It also showed a significant diet and time interaction (P=0.03; Table 14). Concentrations of 14:0 and total saturated fatty acid (SFA) were significantly higher in the Sc100-fed fish than in Sc0-fed fish at 42 days, as well as at 84 days (P<0.01). These results were likely due to the higher supply of these two components in the Sc100 diet compared to the Sc0 diet (Table 9).

TABLE 12

| | Fillet (% TFA ± SE)* | | | | |
|---|---|---|---|---|---|
| Fatty Acid | Control | | | | |
| (% TFA) | (ScO) | Sc25 | Sc50 | Sc75 | Sc100 |
| 14:00 | 7.6 ± 0.7^{b} | 8.8 ± 0.2^{ab} | 9.6 ± 0.4^{a} | 10.5 ± 0.2^{a} | 9.6 ± 0.1^{a} |
| 15:00 | 0.7 ± 0.0 | 0.8 ± 0.0 | 0.8 ± 0.0 | 0.6 ± 0.0 | 0.6 ± 0.0 |
| 16:00 | 28.6 ± 1.1^{b} | 32.2 ± 0.9^{b} | 38.8 ± 0.4^{a} | 41.2 ± 0.5^{a} | 42.3 ± 0.6^{a} |
| 17:00 | 0.8 ± 0.0^{a} | 0.8 ± 0.0^{a} | 0.7 ± 0.0^{a} | 0.5 ± 0.0^{bc} | 0.4 ± 0.0^{c} |
| 18:00 | 7.9 ± 0.2 | 8.0 ± 0.5 | 8.3 ± 0.3 | 8.2 ± 0.2 | 7.9 ± 0.3 |
| 20:00 | 0.3 ± 0.0 | 0.4 ± 0.0 | 0.3 ± 0.0 | 0.3 ± 0.0 | 0.4 ± 0.0 |
| 22:00 | 0.1 ± 0.0 | 0.1 ± 0.0 | 0.1 ± 0.0 | 0.1 ± 0.0 | ND |
| 24:00:00 | ND | 0.1 ± 0.0 | ND | 0.1 ± 0.0 | 0.1 ± 0.0 |
| Total SFA | 46.0 ± 2.3^{b} | 51.2 ± 1.8^{b} | 58.6 ± 0.6^{a} | 61.5 ± 0.5^{a} | 61.3 ± 0.9^{a} |
| 16:1n9 | 0.4 ± 0.0 | 0.4 ± 0.0 | 0.3 ± 0.0 | 0.3 ± 0.0 | 0.2 ± 0.1 |
| 16:1n7 | 11.1 ± 0.3^{a} | 9.5 ± 0.1^{a} | 7.6 ± 0.3^{b} | 5.8 ± 0.3^{c} | 2.9 ± 0.2^{d} |
| 18:1n9 | 14.4 ± 0.0^{a} | 12.8 ± 0.4^{a} | 12.1 ± 0.6^{a} | 12.2 ± 0.6^{a} | 9.1 ± 0.6^{b} |
| 18:1n7 | 5.1 ± 0.0^{a} | 4.5 ± 0.1^{a} | 4.0 ± 0.1^{b} | 3.3 ± 0.1^{bc} | 2.5 ± 0.0^{c} |
| 20:1n9 | 0.8 ± 0.0^{a} | 0.8 ± 0.0^{a} | 0.6 ± 0.0^{b} | 0.7 ± 0.0^{a} | 0.4 ± 0.0^{b} |
| 20:1n7 | 0.1 ± 0.0^{b} | 0.1 ± 0.0^{b} | ND | 0.1 ± 0.0^{b} | ND |
| 24:1n9 | 0.1 ± 0.0^{b} | 0.1 ± 0.0^{b} | ND | 0.1 ± 0.0^{b} | ND |
| Total MUFA | 32.0 ± 0.7^{a} | 28.2 ± 0.4^{a} | 24.6 ± 0.9^{b} | 22.5 ± 1.1^{b} | 15.1 ± 0.9^{c} |
| 18:2n6 | 5.0 ± 0.8^{b} | 4.2 ± 0.41^{bc} | 2.8 ± 0.2^{c} | 2.3 ± 0.1^{c} | 4.0 ± 0.6^{c} |
| 18:3n6 | ND | 0.1 ± 0.0^{b} | ND | ND | ND |
| 20:2n6 | 0.2 ± 0.0^{ab} | 0.2 ± 0.0^{ab} | ND | 0.1 ± 0.0^{b} | 0.1 ± 0.0^{b} |
| 20:3n6 | 0.2 ± 0.0^{b} | 0.2 ± 0.0^{b} | ND | 0.1 ± 0.0^{b} | ND |
| 20:4n6 ARA | 0.9 ± 0.0 | 0.9 ± 0.0 | 0.8 ± 0.1 | 0.8 ± 0.0 | 1.1 ± 0.0 |
| 22:4n6 | 0.2 ± 0.0^{b} | ND | ND | ND | ND |
| 22:5n6 | 0.4 ± 0.0^{d} | 1.5 ± 0.1^{c} | 2.0 ± 0.2^{c} | 2.3 ± 0.2^{c} | 3.9 ± 0.1^{ab} |
| Total n6 | 6.9 ± 1.0 | 7.1 ± 0.5 | 5.6 ± 0.4 | 5.6 ± 0.5 | 9.1 ± 0.6 |
| PUFA | | | | | |
| 18:3n3 ALA | 0.4 ± 0.0^{b} | 0.3 ± 0.0^{b} | 0.1 ± 0.0^{c} | 0.1 ± 0.0^{c} | 0.2 ± 0.1^{c} |
| 18:4n3 | 0.4 ± 0.0^{b} | 0.2 ± 0.0^{bc} | 0.1 ± 0.0^{c} | 0.1 ± 0.0^{c} | ND |
| 20:3n3 | ND | ND | ND | ND | ND |
| 20:4n3 | 0.3 ± 0.0^{c} | 0.2 ± 0.0^{c} | ND | 0.1 ± 0.0^{c} | ND |
| 20:5n3 EPA | 1.8 ± 0.3^{b} | 1.3 ± 0.1^{c} | 0.7 ± 0.1^{d} | 0.5 ± 0.0^{d} | 0.4 ± 0.1^{d} |
| 22:5n3 DPA | 2.7 ± 0.5^{c} | 1.9 ± 0.2^{c} | 1.0 ± 0.1^{cd} | 0.7 ± 0.0^{d} | 0.6 ± 0.0^{d} |
| 22:6n3 DHA | 7.7 ± 1.0^{c} | 8.4 ± 0.6^{c} | 8.1 ± 0.8^{b} | 8.0 ± 0.7^{c} | 12.4 ± 0.7^{b} |
| Total n3 | 13.3 ± 0.0 | 12.3 ± 0.0 | 10.0 ± 0.0 | 10.4 ± 0.0 | 13.6 ± 0.0 |
| PUFA | | | | | |
| Total PUFA | 20.2 ± 3.0 | 19.5 ± 1.7 | 15.6 ± 1.4 | 16.0 ± 1.1 | 22.7 ± 0.8 |
| Total n6 | 1.9 ± 0.1^{c} | 2.9 ± 0.1^{c} | 2.8 ± 0.3^{c} | 3.3 ± 0.2^{c} | 5.1 ± 0.1^{b} |
| LCPUFA | | | | | |
| Total n3 | 12.5 ± 1.8 | 11.8 ± 1.0 | 9.8 ± 0.9 | 9.3 ± 0.8 | 13.4 ± 0.8 |
| LCPUFA | | | | | |
| n3:n6 PUFA | 1.9 ± 0.0^{a} | 1.7 ± 0.0^{b} | 1.7 ± 0.0^{b} | 1.8 ± 0.0^{b} | 1.4 ± 0.1^{c} |
| ratio¶ | | | | | |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
n6 PUFA, omega 6 polyunsaturated fatty acids (18:2, 18:3, 20:2, 20:3, 20:4, 22:4, 22:5);
n6 LCPUFA, omega 6 long chain polyunsaturated fatty acids (20:2, 20:3, 20:4, 22:4, 22:5),
n3 PUFA, omega 3 polyunsaturated fatty acids (18:3, 18:4, 20:3, 20:4, 20:5, 22:5, 22:6);
n3 LCPUFA, omega 3 long chain polyunsaturated fatty acids (20:3, 20:4, 20:5, 22:5, 22:6);
EPA, eicosapentaenoic acid; DHA, docosahexaenoic acid, and n3:n6 ratio calculated for total n3 PUFA: total n6 PUFA.
Mean values across the row not sharing a common superscript were significantly different as determined by Tukey's HSD test, P < 0.05.
ND, not detectable (<0.1% of total fatty acids). §, In many cases ±0.0 (S.E) values are rounding error.
¶The ratio for each replicate was first computed and then an average and SEM were computed for the diet treatment.
‡Significance probability associated with F-statistics.

TABLE 13

| | Fillet (% TFA ± SE)* | | | | |
|---|---|---|---|---|---|
| Fatty Acid | Control | | | | |
| (% TFA) | (ScO) | Sc25 | Sc50 | Sc75 | Sc100 |
| 14:00 | 5.6 ± 0.1^{b} | 6.1 ± 0.9^{b} | 6.1 ± 0.3^{ab} | 6.9 ± 0.6^{b} | 7.5 ± 0.3^{b} |
| 15:00 | 0.6 ± 0.0 | 0.5 ± 0.0 | 0.5 ± 0.0 | 0.5 ± 0.0 | 0.4 ± 0.0 |
| 16:00 | 19.9 ± 0.1^{c} | 24 ± 2.0^{bc} | 24.0 ± 0.6^{bc} | 25.6 ± 2.4^{bc} | 30.0 ± 1.6^{b} |
| 17:00 | 0.7 ± 0.0^{a} | 0.6 ± 0.0^{b} | 0.5 ± 0.0^{ab} | 0.4 ± 0.0^{c} | 0.3 ± 0.0^{c} |
| 18:00 | 6.9 ± 0.2 | 6.1 ± 0.5 | 5.7 ± 0.2 | 5.5 ± 0.4 | 6.1 ± 0.3 |
| 20:00 | 0.3 ± 0.0 | 0.3 ± 0.0 | 0.3 ± 0.0 | 0.2 ± 0.0 | 0.3 ± 0.0 |
| 22:00 | 0.1 ± 0.0 | 0.1 ± 0.0 | 0.1 ± 0.0 | ND | 0.1 ± 0.0 |
| 24:00:00 | 0.1 ± 0.0 | 0.1 ± 0.0 | 0.1 ± 0.0 | 0.1 ± 0.0 | 0.1 ± 0.0 |
| Total SFA | 34.2 ± 0.2^{c} | 37.8 ± 3.6^{c} | 37.3 ± 0.6^{c} | 39.2 ± 3.5^{c} | 44.8 ± 2.3^{b} |
| 16:1n9 | 0.4 ± 0.2^{a} | 0.3 ± 0.0^{ab} | 0.3 ± 0.0^{ab} | 0.3 ± 0.0^{ab} | 0.2 ± 0.0^{b} |
| 16:1n7 | 8.7 ± 0.1^{b} | 6.7 ± 1.1^{c} | 5.8 ± 0.2^{c} | 5.3 ± 0.6^{c} | 2.9 ± 0.0^{d} |
| 18:1n9 | 9.8 ± 0.2^{b} | 9.9 ± 0.6^{b} | 8.3 ± 0.5^{b} | 9.8 ± 1.0^{b} | 8.3 ± 0.4^{b} |
| 18:1n7 | 4.1 ± 0.1^{b} | 3.5 ± 0.3^{bc} | 3.1 ± 0.1^{bc} | 2.8 ± 0.2^{c} | 2.1 ± 0.0^{c} |
| 20:1n9 | 0.6 ± 0.0^{b} | ND | 0.5 ± 0.0^{b} | 0.5 ± 0.0^{b} | 0.4 ± 0.0^{b} |
| 20:1n7 | 0.2 ± 0.0^{a} | 0.2 ± 0.0^{a} | 0.1 ± 0.0^{b} | 0.1 ± 0.0^{b} | ND |
| 24:1n9 | 0.3 ± 0.0^{a} | 0.2 ± 0.0^{ab} | 0.1 ± 0.0^{b} | 0.1 ± 0.0^{b} | ND |
| Total MUFA | 24.1 ± 0.3^{b} | 21.2 ± 2.2^{b} | 18.2 ± 0.7^{bc} | 18.9 ± 1.9^{bc} | 14.0 ± 0.6^{c} |
| 18:2n6 | 8.6 ± 0.0^{a} | 6.9 ± 0.7^{b} | 7.2 ± 0.2^{a} | 6.6 ± 0.2^{b} | 5.8 ± 0.3^{b} |
| 18:3n6 | 0.3 ± 0.0^{a} | 0.2 ± 0.0^{ab} | 0.2 ± 0.0^{ab} | 0.2 ± 0.0^{ab} | 0.1 ± 0.0^{b} |
| 20:2n6 | 0.4 ± 0.0^{a} | 0.3 ± 0.0^{a} | 0.3 ± 0.0^{a} | 0.3 ± 0.0^{a} | 0.2 ± 0.0^{ab} |
| 20:3n6 | 0.4 ± 0.0^{a} | 0.4 ± 0.0^{a} | 0.3 ± 0.0^{ab} | 0.4 ± 0.0^{a} | 0.3 ± 0.0^{ab} |
| 20:4n6 ARA | 1.7 ± 0.0 | 1.6 ± 0.1 | 1.7 ± 0.1 | 1.5 ± 0.1 | 1.6 ± 0.0 |
| 22:4n6 | 0.5 ± 0.0^{a} | 0.4 ± 0.0^{a} | 0.4 ± 0.0^{a} | 0.4 ± 0.0^{a} | 0.3 ± 0.0^{ab} |
| 22:5n6 | 0.8 ± 0.0^{d} | 4.2 ± 1.0^{b} | 5.6 ± 0.2^{ab} | 6.2 ± 1.0^{a} | 7.8 ± 0.5^{a} |
| Total n6 | 12.6 ± 0.1 | 13.9 ± 1.8 | 15.6 ± 0.5 | 15.5 ± 1.4 | 16.1 ± 0.9 |
| PUFA | | | | | |
| 18:3n3 ALA | 1.0 ± 0.0^{a} | 0.6 ± 0.1^{ab} | 0.7 ± 0.0^{ab} | 0.5 ± 0.0^{b} | 0.3 ± 0.0^{b} |
| 18:4n3 | 0.7 ± 0.0^{a} | 0.5 ± 0.0^{a} | 0.5 ± 0.0^{a} | 0.3 ± 0.0^{bc} | 0.1 ± 0.0^{c} |
| 20:3n3 | 0.2 ± 0.0^{ab} | 0.1 ± 0.0^{b} | 0.2 ± 0.0^{ab} | 0.1 ± 0.0^{b} | 0.1 ± 0.0^{b} |
| 20:4n3 | 0.9 ± 0.0^{a} | 0.6 ± 0.0^{b} | 0.6 ± 0.0^{b} | 0.5 ± 0.0^{a} | 0.3 ± 0.0^{c} |
| 20:5n3 EPA | 3.9 ± 0.1^{a} | 2.2 ± 0.3^{b} | 1.9 ± 0.1^{b} | 1.3 ± 0.2^{c} | 0.6 ± 0.0^{d} |
| 22:5n3 DPA | 6.8 ± 0.1^{a} | 4.6 ± 0.7^{b} | 4.2 ± 0.1^{b} | 3.0 ± 0.5^{bc} | 1.8 ± 0.1^{cd} |
| 22:6n3 DHA | 13.0 ± 0.3^{b} | 16.7 ± 2.7^{ab} | 18.9 ± 0.5^{a} | 19.0 ± 2.1^{a} | 20.5 ± 1.4^{a} |
| Total n3 | 26.5 ± 0.3 | 26.9 ± 3.6 | 27.0 ± 0.7 | 24.7 ± 3.7 | 26.1 ± 1.7 |
| PUFA | | | | | |
| Total PUFA | 39.1 ± 0.4 | 39.2 ± 5.6 | 42.6 ± 1.2 | 40.2 ± 5.2 | 39.8 ± 2.7 |
| Total n6 | 3.8 ± 0.1^{c} | 6.8 ± 1.2^{b} | 8.3 ± 0.4^{ab} | 8.7 ± 1.3^{ab} | 10.2 ± 0.6^{a} |
| LCPUFA | | | | | |
| Total n3 | 24.8 ± 0.3 | 24.2 ± 3.5 | 25.8 ± 0.6 | 23.9 ± 3.7 | 23.3 ± 1.7 |
| LCPUFA | | | | | |
| n3:n6 PUFA | 2.1 ± 0.0^{a} | 1.8 ± 0.0^{b} | 1.7 ± 0.0^{b} | 1.5 ± 0.1^{bc} | 1.4 ± 0.0^{c} |
| ratio¶ | | | | | |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
n6 PUFA, omega 6 polyunsaturated fatty acids (18:2, 18:3, 20:2, 20:3, 20:4, 22:4, 22:5);
n6 LCPUFA, omega 6 long chain polyunsaturated fatty acids (20:2, 20:3, 20:4, 22:4, 22:5), n3 PUFA, omega 3 polyunsaturated fatty acids (18:3, 18:4, 20:3, 20:4, 20:5, 22:5, 22:6);
n3 LCPUFA, omega 3 long chain polyunsaturated fatty acids (20:3, 20:4, 20:5, 22:5, 22:6);
EPA, eicosapentaenoic acid;
DHA, docosahexaenoic acid, and n3:n6 ratio calculated for total n3 PUFA: total n6 PUFA.
Mean values across the row not sharing a common superscript were significantly different as determined by Tukey's HSD test, P < 0.05.
ND, not detectable (<0.1% of total fatty acids). §, In many cases ±0.0 (S.E) values are rounding error.
¶The ratio for each replicate was first computed and then an average and SEM were computed for the diet treatment.
‡Significance probability associated with F-statistics.

TABLE 14

| Fatty Acid | | | |
|---|---|---|---|
| (% TFA) | Diet | Time | Diet × Time interaction |
| 14:00 | 0.01 | <0.01 | 0.12 |
| 15:00 | 0.06 | <0.01 | 0.47 |
| 16:00 | <0.01 | <0.01 | 0.03 |
| 17:00 | <0.01 | <0.01 | 0.21 |
| 18:00 | 0.99 | <0.01 | 0.65 |
| 20:00 | 0.41 | 0.08 | 0.20 |
| 22:00 | | | |
| 24:00:00 | 0.99 | <0.01 | 0.65 |
| Total SFA | <0.01 | <0.01 | 0.07 |
| 16:1n9 | 0.13 | 0.72 | 0.96 |
| 16:1n7 | <0.01 | <0.01 | 0.09 |
| 18:1n9 | 0.01 | <0.01 | 0.05 |
| 18:1n7 | <0.01 | <0.01 | 0.15 |
| 20:1n9 | <0.01 | <0.01 | 0.08 |
| 20:1n7 | <0.01 | <0.01 | <0.01 |
| 24:1n9 | 0.03 | <0.01 | <0.01 |
| Total MUFA | <0.01 | <0.01 | 0.13 |
| 18:2n6 | <0.01 | <0.01 | 0.18 |
| 18:3n6 | 0.02 | <0.01 | 0.03 |
| 20:2n6 | <0.01 | <0.01 | <0.01 |
| 20:3n6 | <0.01 | <0.01 | 0.13 |
| 20:4n6 ARA | 0.6 | <0.01 | 0.07 |
| 22:4n6 | 0.04 | <0.01 | 0.22 |
| 22:5n6 | <0.01 | <0.01 | <0.01 |
| Total n6 PUFA | 0.43 | <0.01 | <0.01 |
| 18:3n3 ALA | <0.01 | <0.01 | <0.01 |
| 18:4n3 | 0.03 | <0.01 | 0.10 |
| 20:3n3 | 0.02 | <0.01 | 0.02 |
| 20:4n3 | <0.01 | <0.01 | 0.03 |
| 20:5n3 EPA | <0.01 | <0.01 | <0.01 |
| 22:5n3 DPA | <0.01 | <0.01 | <0.01 |
| 22:6n3 DHA | <0.01 | <0.01 | <0.01 |
| Total n3 PUFA | 0.6 | <0.01 | 0.15 |
| Total PUFA | 0.46 | <0.01 | 0.14 |
| Total n6 LCPUFA | <0.01 | 0 | <0.01 |
| Total n3 LCPUFA | 0.67 | 0 | 0.06 |
| n3:n6 PUFA | <0.01 | 0.07 | <0.01 |
| ratio¶ | | | |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
n6 PUFA, omega 6 polyunsaturated fatty acids (18:2, 18:3, 20:2, 20:3, 20:4, 22:4, 22:5);
n6 LCPUFA, omega 6 long chain polyunsaturated fatty acids (20:2, 20:3, 20:4, 22:4, 22:5), n3 PUFA, omega 3 polyunsaturated fatty acids (18:3, 18:4, 20:3, 20:4, 20:5, 22:5, 22:6);
n3 LCPUFA, omega 3 long chain polyunsaturated fatty acids (20:3, 20:4, 20:5, 22:5, 22:6);
EPA, eicosapentaenoic acid;
DHA, docosahexaenoic acid, and n3:n6 ratio calculated for total n3 PUFA: total n6 PUFA.
Mean values across the row not sharing a common superscript were significantly different as determined by Tukey's HSD test, P < 0.05.
ND, not detectable (<0.1% of total fatty acids).
§In many cases ±0.0 (S.E) values are rounding error.
¶The ratio for each replicate was first computed and then an average and SEM were computed for the diet treatment.
‡Significance probability associated with F-statistics.

With respect to MUFAs in the fillet, total MUFA content and all fractions, except for 16:1n9, had significant time effects and generally showed a higher content at the middle (42 days; Table 12) of the experiment compared to the end of the experiment (84 days; Table 13). The concentrations of 16:1n7, 18:1n7, 20:1n9, 20:1n7, and total MUFAs were significantly affected by dietary treatments and time. Fish fed the Sc0 diet displayed the highest amount of MUFA, which was directly related to the MUFA content in the experimental diets. Irrespective of the diet, oleic acid (18:1n9) was the most abundant monounsaturated fatty acid (MUFA) in the fillet.

Most of the individual polyunsaturated fatty acids (PUFAs) varied greatly among five dietary treatments and time. Regarding n6 fatty acids, all n6 fractions including total n6 PUFA content had significant time effects and were higher at the end of the experiment (84 days; Table 13) than at the middle (42 days; Table 12). The total n6 PUFA content was not affected by the diet (P=0.43) but showed a significant time effect and interaction between diet and time (P<0.01) (Table 14). From 42 days to 84 days, total n6 PUFA content increased by 12.6% in fish fed the Sc0 diet, and by 16.1% in fish fed the SC100 diet. The Sc0 fed fish contained the highest amounts of 18:2n6, 18:3n6, and 20:3n6. In contrast, fish fed the Sc0 diet had significantly decreased amounts of 22:5n6 compared to fish fed the Sc25, Sc50, Sc75, and Sc100 diet. At the end of the experiment, concentrations of 20:4n6 in the fillet did not differ among five dietary treatments (P=0.6).

With respect to the n3 fatty acids, most of the n3 PUFA including 22:6n3 DHA and 20:5n3 EPA were significantly influenced by the dietary treatment or time or both. The n3 PUFA content was generally higher at the end of the experiment (84 days; Table 13) than at the middle (42 days; Table 12). For example, from 42 days to 84 days, the 22:6n3 DHA content increased by 13.0% in fish fed the Sc0 diet, and by 20.5% in fish fed the SC100 diet. Tilapia fed the Sc100 diet had the highest contents of 22:6n3 DHA in the fillet lipids at the end of the experiment, and reflected the higher 22:6n3 DHA supplied by this diet. Furthermore, increasing the levels of Sc (Sc50, Sc75 and Sc100), which corresponded to reduced levels of fish oil, resulted in significant increases in the fillet 22:6n3 DHA compared to the control diet (Sc0) at the end of the feeding experiment. Tilapia fed the Sc0 diet had significantly increased amounts of 18:3n3 compared to the Sc75 and the Sc100 diet. They also exhibited significantly increased amounts of 20:5n3 EPA and 22:5n3 DPA compared to the four Sc inclusion diets due to a higher concentration of 18:3n3 in the Sc0 diet. However, the amounts of total n3 PUFA, total PUFA, and total n3 LC PUFA were not significantly different (P>0.01) in any of the diets.

The n3:n6 PUFA ratio in the fillet was the highest in fish fed the Sc0 diet and progressively declined in accordance with the dietary n3:n6 ratios. Interestingly, the weight gain of tilapia linearly increased as the dietary n3:n6 ratio decreased (y=−5.1491x+35.14; r=0.961; p<0.01).

Amounts of 22:6n3 DHA deposited in the fish fillet (mg/100 g fillet) significantly increased in fish fed the Sc100 diet compared to the Sc0 diet (Table 15). With increasing Sc inclusion levels in the diet, the deposition of DHA in the fillet increased from 143.5 mg/100 g for the inclusion level of 0 g Sc/kg diet (Sc0 diet) to 261.8 mg/100 g for the inclusion level of 161 g Sc/kg diet (Sc100 diet). The relationship between Sc inclusion level in the diet and deposition of DHA (mg/100 g) in the fillets of tilapia was positively correlated (y=7.1423x+155.8; r=0.9459; P<0.01).

TABLE 15

| | Fillet | | | | | |
|---|---|---|---|---|---|---|
| | Control | | | | | F value |
| Composition | (ScO) | Sc25 | Sc50 | Sc75 | Sc100 | (P value) |
| Lipid | 2.2 ± 0.20 | 2.2 ± 0.74 | 2.3 ± 0.26 | 2.3 ± 0.18 | 2.2 ± 0.06 | 0.03 (0.99) |
| (g/100 g) | | | | | | |
| 18:2n6 LA | 96.7 ± 13.9 | 70.7 ± 14.1 | 77.5 ± 11.2 | 76.2 ± 11.2 | 55.1 ± 7.2 | 1.6 (0.24) |
| (mg/100 g) | | | | | | |
| 20:4n6 ARA | 3.8 ± 0.6 | 3.3 ± 0.4 | 3.1 ± 0.2 | 2.9 ± 0.3 | 2.7 ± 0.1 | 1.2 (0.36) |
| (mg/100 g) | | | | | | |
| 18:3n3 ALA | 13.6 ± 2.4 | 6.4 ± 1.4 | 6.9 ± 1.2 | 6.4 ± 0.9 | 3.2 ± 0.4 | 6.8 (0.006) |
| (mg/100 g) | | | | | | |
| 20:5n3 EPA | 52.0 ± 7.9^{a} | 22.1 ± 5.0^{b} | 20.5 ± 3.4^{b} | 16.1 ± 2.9^{b} | 5.9 ± 0.5^{c} | 13.5 (<0.01) |
| (mg/100 g) | | | | | | |
| 22:6n3 DHA | 143.5 ± 12.2^{c} | 205.3 ± 23.0^{b} | 200.4 ± 22.3^{b} | 258.0 ± 34.3^{a} | 261.8 ± 19.3^{a} | 4.2 (0.02) |
| (mg/100 g) | | | | | | |

LA, linoleic Acid; ARA, arachidonic acid; ALA, alpha linolenic acid; EPA, eicosapentaenoic acid; DHA, docosahexaenoic acid.
Mean values across the row not sharing a common superscript were significantly different as determined by Tukey's HSD test, P < 0.05.

This evaluation of the marine species, Schizochytrium sp. (Sc) with a high DHA content (302 g/kg of total fatty acids), in Nile tilapia showed significantly improved weight gain, feed conversion ratio and protein efficiency ratio when fish oil was fully replaced by Sc (Sc100 diet) compared to control feed containing fish oil (Sc-0) and no significant change in survival rate among all diets. Tilapia fed the Sc100 had the highest contents of 22:6n3 DHA in the fillet lipids and reflected the higher 22:6n3 DHA supplied by this diet. These results also have bearing on the n3:n6 fatty acid ratio in a person's total diet, which should be 1:1 or higher for optimum health. In this study, complete substitution of fish oil with Sc led to a n3:n6 ratio greater than 1 (1.4) in tilapia fillets, indicating that full replacement of fish oil with Sc in the diet maintained a favorable ratio for the human consumer. A typical Western diet is deficient in n3 PUFA, with n3:n6 ratios from 1:15 to 1:16.7 (Simopoulos (2008) Exp. Biol. Med. 233:674-88); and eating Nile tilapia with an n3:n6 ratio higher than 1:1 can help bring a person's total diet to the desired 1:1 ratio (see section 1.2.2). This would be a clear improvement over eating currently marketed, intensively farmed Nile tilapia which contain the opposite of what is good for human health: a much higher content of n6 than n3 fatty acids (Foran, et al. (2005) J. Nutrition. 135:2639-43; Weaver, et al. (2008) J. Am. Diet. Assoc. 108:1178-85; Young (2009) Internat. J. Food Sci. Nutrition 60(S5):203-11).

Further, these results indicate that eating flesh from tilapia raised on Sc100 diets would easily meet nearly one-quarter of the dietary recommendation for human consumption of n3 LC PUFAs. The American Dietetic Association and Dietitians of Canada recommend a daily consumption of 500 mg n3 LC PUFAs (EPA+DHA), which is the equivalent of two fish servings/week of approximately 100 g cooked (130 g raw) fatty fish (Lucas, et al. (2009) Public Health Nutrition 13:63-70; Gebauer, et al. (2006) Am. J. Clin. Nutr. 83:1526s-1353s). At the end of the study (84 days), tilapia fed Sc100 (16% dried algae) had a total of 117 mg n3 LC PUFAs (EPA+DHA)/100 g raw fillet, which would provide about 23.4% of the daily recommended level for these fatty acids if a person ate one 130 gram tilapia fillet per week. Overall, these results indicate that Sc is a high-quality fish oil substitute or supplement of long-chain PUFA in tilapia feed.

### Example 3: Digestibility of Marine Microalgae for Replacing Fishmeal and Fish Oil in Freshwater Tilapia Feeds

Whole cells of Nannochloropsis sp. are a rich source of EPA (2.9-47.4%) as well as other nutrients such as protein (38.1-58.52%), amino acids (methionine 1.1-2%, lysine 3.4-5.8%), lipid (3.79-39.4%), ash (7.9%), and a good source of minerals (Sukenik, et al. (1993) Aquaculture 117:313-26; Kagan, et al. (2013) Lipids Health Dis. 12:102). Thus, Nannochloropsis sp. shows potential to replace a portion or all of the fishmeal and fish oil in tilapia feed.

Accordingly, digestibility studies were carried out in tilapia with Nannochloropsis sp. and Isochrysis sp. Dried Nannochloropsis sp. and Isochrysis sp. were obtained from Reed Mariculture, Inc. (Pasadona, Calif.). Table 16 reports the proximate composition, gross energy, and amino acid profiles of the Nannochloropsis sp. and Isochrysis sp. and Table 17 reports the fatty acid profiles of the Nannochloropsis sp. and Isochrysis sp.

TABLE 16

Ingredients

| | |
|---|---|
| Nannochloropsis sp. | Isochrysis sp. |

Proximate composition (%, as is)

| | | |
|---|---|---|
| Dry matter | 96.97 | 92.53 |
| Crude protein | 58.52 | 44.7 |
| Lipid | 3.79 | 22.09 |
| Ash | 7.92 | 9.19 |
| Crude fiber | 1.96 | 0.58 |
| Energy, kJ/g | 15.70 | 18.40 |

Indispensible amino acids
(% in the weight of ingredient as is)

| | | |
|---|---|---|
| Arginine | 3.22 | 2.14 |
| Lysine | 3.42 | 2.36 |
| Isoleucine | 1.7 | 1.82 |
| Leucine | 4.94 | 4.04 |
| Histidine | 1.08 | 0.94 |
| Methionine | 1.1 | 1.07 |
| Phenylalanine | 2.94 | 2.38 |
| Threonine | 2.88 | 2.12 |
| Tryptophan | 0.42 | 0.28 |
| Valine | 2.52 | 2.34 |

Dispensible amino acids
(% in the weight of ingredient as is)

| | | |
|---|---|---|
| Alanine | 4.69 | 2.73 |
| Tyrosine | 2.25 | 1.56 |
| Cystine | 0.76 | 0.5 |
| Glycine | 3.21 | 2.62 |
| Aspartic acid | 5.96 | 4.6 |
| Serine | 2.78 | 1.96 |
| Glutamic acid | 8.58 | 6.19 |
| Proline | 4.57 | 2.68 |
| Hydroxyproline | 0.12 | 0.45 |
| Total | 57.19 | 43.32 |

TABLE 17

Lipid source

| Fatty acids (% of TFA) | Nannochloropsis sp. | Isochrysis sp. |
|---|---|---|
| 14:00 | 1.81 | 15.32 |
| 15:00 | 0.18 | 0.3 |
| 16:00 | 23.91 | 11.4 |
| 17:00 | 0.07 | 0.02 |
| 18:00 | 0.47 | 0.37 |
| 20:00 | ND | ND |
| 22:00 | ND | 0.04 |
| 24:00:00 | 0.18 | ND |
| Total SFA | 26.62 | 27.45 |
| 16:1n9 | 0.52 | 0.63 |
| 16:1n7 | 9.78 | 6.84 |
| 18:1n9 | 3.18 | 10.49 |
| 18:1n7 | 0.91 | 0.93 |
| 20:1n9 | ND | ND |
| 20:1n7 | ND | ND |
| 20:1n11 | ND | 1.09 |
| 22:1n9 | 0.1 | ND |
| 24:1n9 | 0.18 | ND |
| Total MUFA | 14.67 | 19.98 |
| 18:2n6 | 19.23 | 8.57 |
| 18:3n6 | 0.42 | 1.98 |
| 20:2n6 | ND | ND |
| 20:3n6 | ND | ND |
| 20:4n6 ARA | 1.69 | ND |
| 22:4n6 | ND | ND |
| 22:5n6 | ND | 1.28 |
| Total n6 PUFA | 21.34 | 11.83 |
| 18:3n3 ALA | 23.17 | 7.11 |
| 18:4n3 | ND | 20.48 |
| 20:3n3 | ND | 0.97 |
| 20:4n3 | ND | 0.13 |
| 20:5n3 EPA | 13.82 | 1.03 |
| 22:5n3 | ND | ND |
| 22:6n3 DHA | ND | 9.88 |
| Total n3 PUFA | 36.99 | 39.6 |
| Total PUFA | 58.33 | 51.43 |
| Total n6 LCPUFA | 1.69 | 1.28 |
| Total n3 LCPUFA | 13.82 | 12.01 |
| n3:n6 PUFA ratio | 1.73 | 3.31 |
| n3:n6 LCPUFA ratio | 8.18 | 9.38 |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
EPA, eicosapentaenoic acid;
DHA, docosahexaenoic acid.

A high-quality reference diet (Table 18) was prepared and combined with whole cells of Nannochloropsis sp. and Isochrysis sp. (pure algae) at a 7:3 ratio (as is basis) to produce the diets following a conventional apparent digestibility protocol (Cho, et al. (1982) Comp. Biochem. Physiol. Part B: Biochem. Mol. Biol. 73:25-41; Bureau & Hua (2006) Aquaculture 252:103-105). Chromic oxide was included as an inert marker for determination of apparent digestibility coefficients (ADC) for fatty acids and other nutrients (protein, lipid, energy). Micro ingredients were first mixed and then slowly added to the macroingredients to ensure a homogenous mixture. The ingredients were thoroughly mixed and steam pelleted using a California Pellet Mill, and pellets were dried in a forced-air oven (22° C., 24 hour), sieved and stored at −20° C.

TABLE 18

| Ingredients | Amount (g/kg) |
|---|---|
| Fish meal | 300 |
| Soybean meal | 170 |
| Corn gluten meal | 130 |
| Fish oil | 100 |
| Wheat flour | 280 |
| Vitamin/mineral¹ | 10 |
| Chromic oxide (marker) | 10 |
| Total | 1000 |

¹Vitamin/mineral premix (mg/kg dry diet unless otherwise stated): vitamin A (as acetate), 7500 IU/kg dry diet; vitamin D3 (as cholecalcipherol), 6000 IU/kg dry diet; vitamin E (as DL-a-tocopherylacetate), 150 IU/kg dry diet; vitamin K (as menadione Na-bisulphate), 3; vitamin B12 (as cyanocobalamin), 0.06; ascorbic acid (as ascorbyl polyphosphate), 150; D-biotin, 42; choline (as chloride), 3000; folic acid, 3; niacin (as nicotinic acid), 30; pantothenic acid, 60; pyridoxine, 15; riboflavin, 18; thiamin, 3; NaCl, 6.15; ferrous sulphate, 0.13; copper sulphate, 0.06; manganese sulphate, 0.18; potassium iodide, 0.02; zinc sulphate, 0.3; carrier (wheat middling or starch).

Table 19 reports the proximate analysis, and gross energy, and amino acid profiles of the reference diet (Ref) and the test diets composed of 70% reference diet and 30% Nannochloropsis sp. (Nanno) or 30% Isochrysis sp. (Iso). Table 20 reports the fatty acid profiles of the three diets.

TABLE 19

| Diet | | |
|---|---|---|
| Ref | Nanno | Iso |

Proximate composition (%, as is)

| | | | |
|---|---|---|---|
| Dry matter | 92.47 | 90.19 | 85.38 |
| Crude protein | 44.69 | 40.08 | 38.64 |
| Lipid | 10.46 | 10.50 | 12.73 |
| Ash | 6.99 | 6.77 | 7.14 |
| Crude fiber | 1.20 | 1.91 | 1.35 |
| Energy, kJ/g | 16.50 | 16.16 | 15.76 |

Indispensible amino acids (% in the weight of ingredient
as is)

| | | | |
|---|---|---|---|
| Arginine | 2.15 | 1.80 | 1.74 |
| Lysine | 2.14 | 1.88 | 1.90 |
| Isoleucine | 1.57 | 1.49 | 1.40 |
| Leucine | 4.43 | 4.30 | 3.93 |
| Histidine | 0.89 | 0.91 | 0.86 |
| Methionine | 0.72 | 0.67 | 0.71 |
| Phenylalanine | 2.25 | 2.05 | 2.06 |
| Threonine | 1.79 | 1.46 | 1.61 |
| Tryptophan | 0.25 | 0.20 | 0.24 |
| Valine | 1.95 | 1.55 | 1.72 |

Dispensible amino acids fractions
(% in the weight of ingredient as is)

| | | | |
|---|---|---|---|
| Alanine | 2.97 | 2.63 | 2.61 |
| Tyrosine | 1.66 | 1.48 | 1.48 |
| Cystine | 0.49 | 0.51 | 0.40 |
| Glycine | 2.21 | 1.94 | 1.95 |
| Aspartic acid | 4.05 | 3.59 | 3.33 |
| Serine | 2.21 | 1.96 | 2.00 |
| Glutamic acid | 9.01 | 8.72 | 7.73 |
| Proline | 3.43 | 2.90 | 2.47 |
| Hydroxyproline | 0.18 | 0.37 | 0.33 |
| Total | 44.30 | 40.36 | 38.42 |

TABLE 20

| Fatty acids | Diet | | |
|---|---|---|---|
| (% of TFA) | Ref | Nanno | Iso |
| 14:00 | 7.06 | 8.52 | 11.72 |
| 15:00 | 0.51 | 0.6 | 0.43 |
| 16:00 | 20.68 | 19.18 | 18.1 |
| 17:00 | 0.31 | 0.53 | 0.29 |
| 18:00 | 2.27 | 3.19 | 1.94 |
| 20:00 | ND | 0.2 | ND |
| 22:00 | ND | 0.15 | ND |
| 24:00:00 | ND | 0.05 | ND |
| Total SFA | 30.83 | 32.42 | 32.48 |
| 16:1n9 | 2.28 | 1.67 | 1.71 |
| 16:1n7 | 12.01 | 12.35 | 11.26 |
| 18:1n9 | 6.07 | 7.42 | 8.6 |
| 18:1n7 | 2.36 | 2.88 | 2.26 |
| 20:1n9 | 0.27 | 0.52 | 0.2 |
| 20:1n7 | ND | 0.17 | ND |
| 20:1n11 | ND | ND | 0.59 |
| 22:1n9 | ND | ND | ND |
| 24:1n9 | ND | 0.29 | ND |
| Total MUFA | 22.99 | 23.63 | 24.62 |
| 18:2n6 | 11.8 | 9.66 | 9.54 |
| 18:3n6 | 0.22 | 0.22 | 0.5 |
| 20:2n6 | ND | 0.07 | ND |
| 20:3n6 | ND | 0.19 | ND |
| 20:4n6 ARA | 1.27 | 1.12 | 0.66 |
| 22:4n6 | ND | 0.07 | ND |
| 22:5n6 | ND | 0.39 | 0.6 |
| Total n6 PUFA | 13.29 | 11.72 | 11.3 |
| 18:3n3 ALA | 7.05 | 1.68 | 3.52 |
| 18:4n3 | 1.53 | 2 | 8.41 |
| 20:3n3 | ND | 0.07 | ND |
| 20:4n3 | 0.56 | 1 | 0.42 |
| 20:5n3 EPA | 12.38 | 11.73 | 6.52 |
| 22:5n3 | 1.52 | 2.08 | 1.18 |
| 22:6n3 DHA | 7.34 | 9.83 | 9.8 |
| Total n3 PUFA | 30.38 | 28.39 | 29.85 |
| Total PUFA | 43.67 | 40.11 | 41.15 |
| Total n6 LCPUFA | 1.27 | 1.84 | 1.26 |
| Total n3 LCPUFA | 21.8 | 24.71 | 17.92 |
| n3:n6 PUFA ratio | 2.29 | 2.42 | 2.64 |
| n3:n6 LCPUFA | 17.17 | 13.43 | 14.22 |
| ratio | | | |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
EPA, eicosapentaenoic acid;
DHA, docosahexaenoic acid.
ND, not detectable (<10 g/kg of total fatty acids).

Experimental design, fish rearing, feeding, chemical analysis and calculations were carried out as described in Example 1. Significant differences between the two test diets (Table 21) were not detected for the ADC of dry matter (81.64 and 87.32), lipid (96.83 and 95.22), ash (89.37 and 89.54), crude fiber (90.34 and 92.04) and gross energy (91.34 and 91.11). There were however differences for the ADC of crude protein.

TABLE 21

| Diet | | |
|---|---|---|
| Ref | Nanno | Iso |

Proximate composition (%, as is)

| | | | |
|---|---|---|---|
| Dry matter | 90.01 ± 4.0 | 81.64 ± 0.4 | 87.32 ± 3.99 |
| Crude protein | 93.08 ± 2.02^{a} | 83.41 ± 1.99^{b} | 88.25 ± 2.76^{ab} |
| Lipid | 97.56 ± 1.08 | 96.83 ± 1.98 | 95.22 ± 1.91 |
| Ash | 85.72 ± 4.5 | 89.37 ± 4.36 | 89.54 ± 4.30 |
| Crude fiber | 90.46 ± 3.66 | 90.34 ± 3.49 | 92.04 ± 3.11 |
| Energy, kj g⁻¹ | 91.79 ± 3.56 | 91.34 ± 3.64 | 91.11 ± 4.47 |
| Total Phosphorus | 80.46 ± 4.06^{a} | 93.38 ± 2.42^{b} | 93.43 ± 2.18^{b} |

Indispensible amino acids (% in the weight of ingredient as is)

| | | | |
|---|---|---|---|
| Arginine | 95.66 ± 1.39 | 92.22 ± 2.71 | 93.26 ± 2.61 |
| Lysine | 95.26 ± 1.62 | 92.39 ± 1.93 | 94.58 ± 2.14 |
| Isoleucine | 85.00 ± 4.89 | 86.28 ± 7.98 | 87.91 ± 7.10 |
| Leucine | 94.68 ± 1.73 | 92.67 ± 2.71 | 93.38 ± 2.53 |
| Histidine | 95.25 ± 1.54 | 93.28 ± 2.09 | 94.21 ± 2.21 |
| Methionine | 94.46 ± 1.81 | 93.75 ± 2.39 | 94.28 ± 2.56 |
| Phenylalanine | 94.95 ± 1.77 | 93.28 ± 1.36 | 92.89 ± 2.59 |
| Threonine | 93.84 ± 2.08 | 91.79 ± 3.60 | 92.79 ± 2.76 |
| Tryptophan | 95.45 ± 1.81 | 91.26 ± 4.43 | 93.89 ± 2.41 |
| Valine | 94.22 ± 1.94 | 92.19 ± 3.83 | 92.60 ± 2.97 |

Dispensible amino acids fractions
(% in the weight of ingredient as is)

| | | | |
|---|---|---|---|
| Alanine | 95.51 ± 1.46 | 92.63 ± 2.24 | 94.77 ± 1.92 |
| Tyrosine | 92.34 ± 2.37 | 90.49 ± 2.33 | 91.76 ± 2.30 |
| Cystine | 95.29 ± 1.72 | 92.42 ± 2.96 | 92.10 ± 3.64 |
| Glycine | 94.63 ± 1.79 | 91.25 ± 2.8 | 94.25 ± 2.25 |
| Aspartic acid | 97.07 ± 0.98 | 95.27 ± 1.51 | 96.63 ± 1.32 |
| Serine | 94.95 ± 1.73 | 91.75 ± 2.44 | 94.20 ± 2.37 |
| Glutamic acid | 95.81 ± 1.50 | 93.81 ± 1.89 | 94.57 ± 2.1 |
| Proline | 95.93 ± 1.28 | 94.00 ± 1.72 | 93.98 ± 2.28 |
| Hydroxyproline | 88.98 ± 3.53^{b} | 97.14 ± 0.77^{a} | 96.10 ± 1.42^{ab} |

Mean values across the row not sharing a common superscript were significantly different as determined by Tukey's HSD test, P < 0.05.
ND, not detectable (<0.1% of total fatty acids).

ADCs of certain fatty acid fractions among the test diets were significantly different compared to the reference diet (Table 22). EPA and DHA had high ADCs for each of the diets. The highest ADC of total MUFA was obtained for the Isochrysis sp. diet.

TABLE 22

| Fatty acids | Diet | | | |
|---|---|---|---|---|
| (% of TFA) | Ref | Nanno | Iso | P value |
| 14:00 | 86.09 ± 3.57^{b} | 96.23 ± 0.70^{a} | 94.23 ± 0.65^{ab} | <0.01 |
| 15:00 | 80.69 ± 4.45^{b} | 93.04 ± 4.88^{a} | 90.39 ± 0.75^{ab} | 0.05 |
| 16:00 | 89.99 ± 3.52 | 90.14 ± 3.91 | 91.62 ± 4.0 | 0.95 |
| 17:00 | 84.72 ± 3.85^{b} | 94.59 ± 1.24^{a} | 94.39 ± 0.62^{a} | 0.05 |
| 18:00 | 83.57 ± 3.37^{b} | 93.83 ± 1.18^{a} | 90.67 ± 2.05^{a} | 0.05 |
| 20:00 | ND | ND | ND | |
| 22:00 | ND | ND | ND | |
| 24:00 | ND | 0.05 | ND | |
| SFA | 84.82 ± 2.22 | 89.39 ± 2.21 | 85.84 ± 3.36 | 0.84 |
| 16:1n9 | 99.17 ± 0.83 | 97.20 ± 1.06 | 96.52 ± 1.10 | 0.20 |
| 16:1n7 | 93.42 ± 2.81 | 92.86 ± 2.86 | 93.93 ± 3.1 | 0.72 |
| 18:1n9 | 88.40 ± 4.28 | 92.16 ± 2.49 | 93.71 ± 3.87 | 0.62 |
| 18:1n7 | 89.00 ± 4.51 | 92.65 ± 2.32 | 92.15 ± 3.42 | 0.78 |
| 20:1n9 | 92.30 ± 3.25 | ND | ND | |
| 20:1n7 | ND | ND | ND | |
| 20:1n11 | ND | ND | ND | |
| 22:1n9 | ND | ND | ND | |
| 24:1n9 | ND | 0.29 | ND | |
| MUFA | 91.94 ± 3.7 | 93.22 ± 2.85 | 93.67 ± 2.72 | 0.70 |
| 18:2n6 | 93.83 ± 3.18 | 90.96 ± 3.72 | 91.16 ± 3.31 | 0.80 |
| 18:3n6 | 98.98 ± 1.02 | 97.57 ± 1.46 | 96.14 ± 1.31 | 0.30 |
| 20:2n6 | ND | ND | ND | |
| 20:3n6 | ND | ND | ND | |
| 20:4n6 ARA | 93.79 ± 2.58 | 92.20 ± 5.30 | 91.35 ± 4.2 | |
| 22:4n6 | ND | ND | ND | |
| 22:5n6 | ND | ND | ND | |
| n6 PUFA | 94.03 ± 3.05 | 91.18 ± 4.21 | 93.19 ± 2.95 | 0.92 |
| 18:3n3 ALA | 98.07 ± 0.75^{a} | 84.39 ± 1.1^{b} | 93.80 ± 2.04^{ab} | 0.02 |
| 18:4n3 | 94.85 ± 2.14 | 93.06 ± 2.05 | 98.96 ± 0.32 | 0.12 |
| 20:3n3 | ND | ND | ND | |
| 20:4n3 | 95.93 ± 1.48 | 98.79 ± 0.1 | 100.0 ± 3.13 | 0.10 |
| 20:5n3 EPA | 96.96 ± 1.67 | 94.25 ± 3.42 | 93.29 ± 2.02 | 0.82 |
| 22:5n3 | 94.95 ± 2.06 | 96.65 ± 2.22 | 93.60 ± 4.17 | 0.79 |
| 22:6n3 DHA | 94.31 ± 2.12 | 96.15 ± 1.43 | 95.93 ± 1.94 | 0.78 |
| n3 PUFA | 96.81 ± 1.6 | 94.87 ± 2.18 | 94.67 ± 2.11 | 0.89 |
| PUFA | 95.43 ± 2.06 | 91.37 ± 2.92 | 92.71 ± 2.31 | 0.66 |
| n6 LC PUFA | 94.84 ± 2.50 | 91.59 ± 4.40 | 93.22 ± 3.59 | 0.86 |
| n3 LCPUFA | 96.35 ± 1.8 | 96.00 ± 2.28 | 94.73 ± 2.31 | 0.92 |

Mean values across the row not sharing a common superscript were significantly different as determined by Tukey's HSD test, P < 0.05.
ND, not detectable (<0.1% of total fatty acids).

Test ingredient apparent digestibility coefficients (ADCₜₑₛₜingredient)* of several nutrients were significantly different between the two microalgae ingredients (Table 23).

TABLE 23

| Ingredients | | |
|---|---|---|
| Nanno | Iso | P value |

Proximate composition (%, as is)

| | | | |
|---|---|---|---|
| Dry matter | 72.45 ± 3.87^{a} | 86.42 ± 1.13^{b} | 0.01 |
| Crude protein | 73.97 ± 0.37^{a} | 84.01 ± 5.14^{b} | 0.05 |
| Lipid | 92.19 ± 0.05 | 89.32 ± 3.94 | 0.15 |
| Ash | 83.26 ± 11.43 | 84.14 ± 11.88 | 0.80 |
| Crude fiber | 94.34 ± 6.34 | 98.12 ± 3.50 | 0.48 |
| Energy, kj g⁻¹ | 90.24 ± 4.46 | 89.71 ± 6.61 | 0.94 |
| Total Phosphorus | 125.43 ± 2.99 | 126.69 ± 4.73 | 0.82 |

Indispensible amino acids (% in the weight of ingredient as is)

| | | | |
|---|---|---|---|
| Arginine | 89.94 ± 3.15 | 89.35 ± 3.22 | 0.24 |
| Lysine | 89.51 ± 2.25^{b} | 97.5 ± 2.79^{a} | 0.04 |
| Isoleucine | 93.60 ± 8.01 | 92.33 ± 3.21 | 0.69 |
| Leucine | 93.78 ± 3.94 | 94.73 ± 4.25 | 0.88 |
| Histidine | 93.92 ± 1.49 | 94.20 ± 1.06 | 0.92 |
| Methionine | 93.11 ± 3.72 | 96.50 ± 3.40 | 0.52 |
| Phenylalanine | 92.02 ± 1.32 | 91.55 ± 2.30 | 0.86 |
| Threonine | 92.05 ± 0.48 | 94.24 ± 1.05 | 0.65 |
| Tryptophan | 90.85 ± 1.49^{b} | 95.45 ± 1.99^{a} | 0.04 |
| Valine | 86.44 ± 3.88^{b} | 94.53 ± 2.47^{a} | 0.05 |

Dispensible amino acids fractions
(% in the weight of ingredient as is)

| | | | |
|---|---|---|---|
| Alanine | 95.11 ± 2.75 | 99.26 ± 5.80 | 0.62 |
| Tyrosine | 90.15 ± 2.58 | 90.39 ± 2.52 | 0.48 |
| Cystine | 90.92 ± 4.37 | 92.48 ± 3.85 | 0.79 |
| Glycine | 90.92 ± 3.50 | 93.49 ± 3.48 | 0.23 |
| Aspartic acid | 95.15 ± 1.87 | 99.41 ± 2.52 | 0.28 |
| Serine | 94.23 ± 3.96 | 98.89 ± 5.21 | 0.50 |
| Glutamic acid | 96.74 ± 2.51 | 103.51 ± 7.91 | 0.48 |
| Proline | 98.23 ± 2.26^{a} | 87.02 ± 0.49^{b} | 0.05 |
| Hydroxyproline | 118.82 ± 0.87^{a} | 96.87 ± 1.44^{b} | 0.01 |

*Means of ADC of nutrients in reference and test diets for tilapia. Mean values across the row not sharing a common superscript were significantly different as determined by Tukey's HSD test, P < 0.05.
ND, not detectable (<1% of total fatty acids).

Similarly, certain test ingredient apparent digestibility coefficients (ADCₜₑₛₜingredient)* of fatty acids in Nannochloropsis (Nanno) and Isochrysis (Iso) for tilapia were also significantly different (Table 24).

TABLE 24

| Fatty acids | Ingredients | | |
|---|---|---|---|
| (% of TFA) | Nanno | Iso | P value |
| 14:00 | 160.62 ± 18.15 | 91.92 ± 2.60 | 0.01 |
| 15:00 | 93.72 ± 1.44 | 76.56 ± 4.96 | 0.05 |
| 16:00 | 90.45 ± 4.72 | 90.47 ± 6.10 | |
| 17:00 | 92.27 ± 2.85 | 135.47 ± 6.90 | <0.01 |
| 18:00 | 209 ± 24.24 | 184.95 ± 19.34 | 0.46 |
| 20:00 | ND | ND | |
| 22:00 | ND | ND | |
| 24:00:00 | ND | 0.05 | |
| SFA | 90.26 ± 3.70 | 87.34 ± 4.84 | 0.61 |
| 16:1n9 | 89.22 ± 1.12 | 84.61 ± 4.06 | 0.38 |
| 16:1n7 | 91.28 ± 2.83 | 89.75 ± 1.13 | 0.22 |
| 18:1n9 | 128.45 ± 8.54^{a} | 99.64 ± 1.53^{b} | 0.02 |
| 18:1n7 | 144.80 ± 13.04^{a} | 107.88 ± 4.09^{b} | 0.02 |
| 20:1n9 | ND | ND | |
| 20:1n7 | ND | ND | |
| 20:1n11 | ND | ND | |
| 22:1n9 | ND | ND | |
| 24:1n9 | ND | ND | |
| MUFA | 96.16 ± 2.11 | 95.41 ± 3.09 | 0.84 |
| 18:2n6 | 86.85 ± 6.58 | 90.73 ± 3.77 | 0.29 |
| 18:3n6 | 94.59 ± 3.74 | 93.94 ± 1.65 | 0.76 |
| 20:2n6 | ND | ND | |
| 20:3n6 | ND | ND | |
| 20:4n6 ARA | 88.06 ± 2.26 | ND | |
| 22:4n6 | ND | ND | |
| 22:5n6 | ND | ND | |
| Total n6 PUFA | 87.04 ± 6.76 | 89.95 ± 2.96 | 0.68 |
| 18:3n3 ALA | 74.68 ± 2.27 | 93.26 ± 1.56 | <0.01 |
| 18:4n3 | ND | 99.67 ± 0.08 | |
| 20:3n3 | ND | ND | |
| 20:4n3 | ND | 133.03 ± 32.75 | |
| 20:5n3 EPA | 88.58 ± 4.68^{a} | 60.40 ± 3.26^{b} | <0.01 |
| 22:5n3 | ND | ND | |
| 22:6n3 DHA | ND | 91.45 ± 3.0 | |
| Total n3 PUFA | 91.12 ± 3.81 | 88.70 ± 3.07 | 0.63 |
| Total PUFA | 90.48 ± 4.58 | 90.39 ± 2.84 | 0.83 |
| Total n6 LC | 94.00 ± 1.2 | 87.47 ± 7.70 | 0.55 |
| PUFA | | | |
| Total n3 | 88.62 ± 1.94 | 87.75 ± 5.68 | 0.91 |
| LCPUFA | | | |

This analysis showed that Nannochloropsis sp. and Isochrysis sp. cells both are highly digestible and nutrient-dense feedstuffs, broadly similar to fishmeal and fish oil. The apparent digestibility coefficient (ADC) in Nannochloropsis sp. crude protein was 73.9% (Table 23). Essential amino acids in Nannochloropsis sp. were highly digestible overall (>85%). Lysine and methionine digestibility were 89.5% and 93.1%, respectively. Saturated fatty acids (SFA), n-3 PUFA, and total PUFA were highly digestible (>90%). The phosphorus digestibility coefficient was very high (>100%). Tilapia showed high palatability for the Nannochloropsis sp. and Isochrysis sp. diets, feeding as aggressively on them as on the fishmeal-based reference diet. These data indicate that the dried whole cells of Nannochloropsis sp. and Isochrysis sp. are sustainable alternatives for the formulation of low pollution and nutritious feeds for tilapia.

### Example 4: Digestibility of Marine Microalgae for Replacing Fishmeal and Fish Oil in Freshwater Rainbow Trout Feeds

Dietary Design.

A high-quality reference diet (Table 25) was prepared and combined with each test microalga species (pure algae) at a 7:3 ratio (as is basis) to produce two test diets (one for each microalga species) following a conventional apparent digestibility protocol (Cho, et al. (1982) Comp. Biochem. Physiol. Part B: Biochem. Mol. Biol. 73:25-41; Bureau & Hua (2006) Aquaculture 252:103-105). Dried Nannochloropsis sp. and Isochrysis sp. were obtained from Reed Mariculture, Inc. (Pasadona, Calif.). SIPERNAT 50 (Degussa AG, Frankfurt, Germany) was included as an inert marker for determination of apparent digestibility coefficients (ADC) for fatty acids and other nutrients (protein, lipid, energy). For the digestibility measurement of the diet, 1% SIPERNAT 50 was added to the diet as an indigestible marker. Micro ingredients were first mixed and then slowly added to the macroingredients to ensure a homogenous mixture. The ingredients were thoroughly mixed and steam pelleted using a California Pellet Mill, and pellets were dried in a forced-air oven (22° C., 24 hours), sieved and stored at −20° C.

TABLE 25

| Ingredients | Amount (g/kg) |
|---|---|
| Fish meal | 300 |
| Corn gluten meal | 170 |
| Wheat meal | 169 |
| Soybean meal | 129 |
| Fish oil | 112 |
| Wheat gluten | 100 |
| Vitamin/mineral¹ | 10 |
| SIPERNAT 50² | 10 |
| Total | 1000 |

¹Corey Feed Mills Ltd., Fredericton, NB.
²SIPERNAT 50 ™ (Degussa AG, Frankfurt, Germany).

Fish, Feeding and Feces Collection.

Prior to the digestibility trial, rainbow trout (triploid, all female) with an average of 150 grams were randomly allocated in twelve 175 L rectangular tanks (12 fish/tank, 3 tanks/diet, total 108 fish for 9 tanks) in a fresh water recirculating system. Tanks were filled with 12 fish per tank. Environmental parameters were maintained within limits recommended for rainbow trout by the National Research Council (NRC 2011).

Prior to the beginning of the experiment, fish were acclimated five days to the feed. Fish were hand-fed until apparent satiation twice daily (9:00 and 16:00). The duration of the digestibility experiment was for 4 weeks; and feces were collected via a modified Guelph system twice a day, before each meal, and were stored at −20° C. Afterwards, samples were thawed in a refrigerator at 4° C., centrifuged to remove excess water and freeze-dried for seven days prior to analysis to determine apparent digestibility coefficients (ADC) for the nutrients and energy of test and reference diets as described herein. The overall digestibility data for macronutrients data revealed that Isochrysis sp showed significantly better digestibility than Nannochloropsis sp. in trout. However, as with tilapia, the improved digestibility of dried whole cells of Nannochloropsis sp. and Isochrysis sp., as nutrient dense feedstuffs, was broadly similar to fishmeal and fish oil. Therefore, these microalgae can be used as sustainable substitutes for the fishmeal and fish oil in rainbow trout feed.

The proximate chemical composition, gross energy, and amino acids of the microalgal test ingredients are provided in Table 26 and the fatty acid (% total fatty acids) content of whole cell dried Nannochloropsis sp. and Isochrysis sp. used in the experimental diets is provided in Table 27. Proximate analysis, gross energy, and amino acids of the reference and test diets are provided in Table 28 and fatty acid profiles of the reference and test diets are provided in Table 29.

TABLE 26

Ingredients*

| | |
|---|---|
| Nannochloropsis sp. | Isochrysis sp. |

Proximate composition (%, as is)

| | | |
|---|---|---|
| Dry matter | 96.9 | 92.5 |
| Crude protein | 58.5 | 44.7 |
| Lipid | 3.7 | 22.1 |
| Ash | 7.9 | 9.2 |
| Crude fiber | 1.9 | 0.6 |
| Energy, kJ/g | 15.7 | 18.4 |

Indispensible amino acids
(% in the weight of ingredient as is)

| | | |
|---|---|---|
| Arginine | 3.2 | 2.1 |
| Lysine | 3.4 | 2.4 |
| Isoleucine | 1.7 | 1.8 |
| Leucine | 4.9 | 4.0 |
| Histidine | 1.1 | 0.9 |
| Methionine | 1.1 | 1.1 |
| Phenylalanine | 2.9 | 2.4 |
| Threonine | 2.9 | 2.1 |
| Tryptophan | 0.4 | 0.3 |
| Valine | 2.5 | 2.3 |

Dispensible amino acids
(% in the weight of ingredient as is)

| | | |
|---|---|---|
| Alanine | 4.7 | 2.7 |
| Tyrosine | 2.3 | 1.6 |
| Cystine | 0.8 | 0.5 |
| Glycine | 3.2 | 2.6 |
| Aspartic acid | 5.9 | 4.6 |
| Serine | 2.8 | 1.9 |
| Glutamic acid | 8.6 | 6.2 |
| Proline | 4.6 | 2.7 |
| Hydroxyproline | 0.1 | 0.5 |
| Total | 57.2 | 43.32 |

*Reed Mariculture, Inc., Pasadona, CA.

TABLE 27

Lipid Source

| Fatty acids (% of TFA) | Nannochloropsis sp. | Isochrysis sp. |
|---|---|---|
| 14:00 | 1.8 | 15.3 |
| 15:00 | 0.2 | 0.3 |
| 16:00 | 23.9 | 11.4 |
| 17:00 | 0.1 | ND |
| 18:00 | 0.5 | 0.4 |
| 20:00 | ND | ND |
| 22:00 | ND | ND |
| 24:00:00 | 0.2 | ND |
| Total SFA | 26.7 | 27.4 |
| 16:1n7 | 9.8 | 6.8 |
| 16:1n9 | 0.5 | 0.6 |
| 18:1n9 | 3.2 | 10.5 |
| 18:1n7 | 0.9 | 0.9 |
| 20:1n9 | ND | ND |
| 20:1n7 | ND | ND |
| 20:1n11 | ND | 1.1 |
| 22:1n9 | 0.1 | ND |
| 24:1n9 | 0.2 | ND |
| Total MUFA | 14.7 | 19.9 |
| 18:2n6 | 19.2 | 8.6 |
| 18:3n6 | 0.4 | 1.9 |
| 20:2n6 | ND | ND |
| 20:3n6 | ND | ND |
| 20:4n6 ARA | 1.7 | ND |
| 22:4n6 | ND | ND |
| 22:5n6 | ND | 1.3 |
| Total n6 PUFA | 21.3 | 11.8 |
| 18:3n3 ALA | 23.2 | 7.1 |
| 18:4n3 | ND | 20.5 |
| 20:3n3 | ND | 0.9 |
| 20:4n3 | ND | 0.1 |
| 20:5n3 EPA | 13.8 | 1.0 |
| 22:5n3 | ND | ND |
| 22:6n3 DHA | ND | 9.9 |
| Total n3 PUFA | 37.0 | 39.6 |
| Total PUFA | 58.3 | 51.4 |
| Total n6 LCPUFA | 1.7 | 1.3 |
| Total n3 LCPUFA | 13.8 | 12.0 |
| n3:n6 PUFA ratio | 1.7 | 3.3 |
| n3:n6 LCPUFA ratio | 8.2 | 9.4 |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
EPA, eicosapentaenoic acid;
DHA, docosahexaenoic acid.
ND, not detectable (<10 g/kg of total fatty acids).

TABLE 28

| Feed | | |
|---|---|---|
| | 70%-Ref + | 70%-Ref + |
| Ref | 30%-Nanno | 30%-Iso |

Proximate composition (%, as is)

| | | | |
|---|---|---|---|
| Dry matter | 94.7 | 94.4 | 94.2 |
| Crude protein | 52.8 | 52.8 | 48.7 |
| Lipid | 12.4 | 12.7 | 16.0 |
| Ash | 7.3 | 7.2 | 8.3 |
| Crude fiber | 1.9 | 1.4 | 1.6 |
| Energy, kJ/g | 15.1 | 15.0 | 15.7 |

Indispensible amino acids
(% in the weight of ingredient as is)

| | | | |
|---|---|---|---|
| Arginine | 2.6 | 2.7 | 2.3 |
| Lysine | 2.5 | 2.6 | 2.2 |
| Isoleucine | 1.7 | 1.8 | 1.6 |
| Leucine | 4.4 | 4.4 | 3.9 |
| Histidine | 1.0 | 1.0 | 0.9 |
| Methionine | 1.0 | 1.0 | 1.0 |
| Phenylalanine | 2.3 | 2.4 | 2.1 |
| Threonine | 1.5 | 1.9 | 0.7 |
| Tryptophan | 0.3 | 0.4 | 0.4 |
| Valine | 2.0 | 2.3 | 2.0 |

Dispensible amino acids fractions
(% in the weight of ingredient as is)

| | | | |
|---|---|---|---|
| Alanine | 2.4 | 2.7 | 2.3 |
| Tyrosine | 1.8 | 1.8 | 1.6 |
| Cystine | 0.7 | 0.7 | 0.6 |
| Glycine | 1.9 | 2.3 | 2.0 |
| Aspartic acid | 3.7 | 4.5 | 3.9 |
| Serine | 2.3 | 2.4 | 2.1 |
| Glutamic acid | 12.4 | 11.7 | 11.2 |
| Proline | 3.5 | 3.8 | 3.2 |
| Hydroxyproline | 0.1 | 0.2 | 0.1 |
| Total | 48.2 | 50.7 | 44.4 |

TABLE 29

| | Feed | | |
|---|---|---|---|
| Fatty acids | | 70%-Ref + 30%- | 70%-Ref + |
| (% of TFA) | Ref | Nanno | 30%-Iso |
| 14:00 | 5.3 | 4.5 | 7.5 |
| 15:00 | 0.3 | 0.5 | 0.3 |
| 16:00 | 12.0 | 13.4 | 11.5 |
| 17:00 | 0.1 | 0.1 | 0.1 |
| 18:00 | 1.1 | 1.0 | 0.9 |
| 20:00 | 0.2 | 0.2 | 0.2 |
| 22:00 | 0.1 | 0.0 | 0.1 |
| 24:00:00 | ND | 0.1 | ND |
| Total SFA | 19.1 | 19.7 | 20.6 |
| 16:1n7 | 4.9 | 5.6 | 5.4 |
| 16:1n9 | 0.1 | 1.6 | 0.8 |
| 18:1n9 | 8.3 | 7.2 | 8.8 |
| 18:1n7 | 1.6 | 1.5 | 1.5 |
| 20:1n9 | 13.4 | 11.0 | 10.4 |
| 20:1n7 | 0.5 | 0.4 | 0.4 |
| 20:1n11 | 1.3 | 1.0 | 1.5 |
| 22:1n9 | 1.8 | 1.5 | 1.4 |
| 24:1n9 | 0.6 | 0.6 | 0.5 |
| Total MUFA | 56.9 | 52.0 | 50.1 |
| 18:2n6 | 8.1 | 9.2 | 7.4 |
| 18:3n6 | 0.1 | 0.1 | 0.4 |
| 20:2n6 | 0.2 | 0.1 | 0.1 |
| 20:3n6 | ND | ND | ND |
| 20:4n6 ARA | 0.2 | 0.5 | 0.2 |
| 22:4n6 | ND | ND | ND |
| 22:5n6 | ND | ND | 0.3 |
| Total n6 PUFA | 8.5 | 9.9 | 8.4 |
| 18:3n3 ALA | 1.0 | 4.7 | 2.7 |
| 18:4n3 | 1.5 | 1.2 | 5.3 |
| 20:3n3 | ND | ND | 0.1 |
| 20:4n3 | 0.2 | 0.2 | 0.2 |
| 20:5n3 EPA | 5.1 | 6.4 | 4.2 |
| 22:5n3 | 0.6 | 0.5 | 0.5 |
| 22:6n3 DHA | 5.4 | 4.2 | 6.1 |
| Total n3 PUFA | 14.0 | 17.4 | 19.3 |
| Total PUFA | 23.8 | 28.3 | 29.0 |
| Total n6 LCPUFA | 0.3 | 0.6 | 0.6 |
| Total n3 LCPUFA | 11.5 | 11.5 | 11.4 |
| n3:n6 PUFA | 1.7 | 1.8 | 2.3 |
| ratio | | | |
| n3:n6 LCPUFA | 34.8 | 19.4 | 17.9 |
| ratio | | | |

SFA, saturated fatty acids (sum of all fatty acids without double bonds);
MUFA, monounsaturated fatty acids (sum of all fatty acids with a single bond);
PUFA, polyunsaturated fatty acids (sum of all fatty acids with ≥2 double bonds);
EPA, eicosapentaenoic acid;
DHA, docosahexaenoic acid.
ND, not detectable (<10 g/kg of total fatty acids).

Table 30 provides the apparent digestibility coefficients (ADC)* of nutrients, gross energy, and amino acids in the reference diet and two test diets for rainbow trout. Table 31 provides the ADC of fatty acids in the reference diet and two test diets for rainbow trout. Table provides the test ingredient apparent digestibility coefficients (ADCₜₑₛₜingredient)* of nutrients, gross energy, and amino acids in Nannochloropsis (Nanno) and Isochrysis (Iso) for rainbow trout. Table 33 provides the test ingredient apparent digestibility coefficients (ADCₜₑₛₜingredient) of fatty acids in Nannochloropsis (Nanno) and Isochrysis (Iso) for rainbow trout.

TABLE 30

| Feed | | | |
|---|---|---|---|
| | 70%-Ref + 30%- | 70%-Ref + | |
| Ref | Nanno | 30%-Iso | P value |

Proximate composition (%, as is)

| | | | | |
|---|---|---|---|---|
| Dry matter | 76.1 ± 1.0 | 70.3 ± 0.7^{b} | 76.6 ± 1.0^{a} | <0.01 |
| Crude protein | 92.9 ± 0.6^{a} | 85.0 ± 0.3^{b} | 91.2 ± 0.3^{a} | <0.01 |
| Lipid | 87.3 ± 1.6^{a} | 80.2 ± 1.2^{ab} | 76.7 ± 0.8^{b} | <0.01 |
| Ash | 51.5 ± 1.2 | 55.2 ± 1.6 | 62.0 ± 2.0 | 0.26 |
| Energy | 81.0 ± 1.3^{a} | 75.2 ± 0.6^{b} | 78.0 ± 0.85^{a} | 0.01 |

Indispensible amino acids (% in the weight of ingredient as is)

| | | | | |
|---|---|---|---|---|
| Arginine | 94.5 ± 0.3^{a} | 86.9 ± 0.2^{b} | 94.9 ± 0.2^{a} | <0.01 |
| Lysine | 94.4 ± 0.3^{a} | 85.6 ± 0.1^{b} | 94.9 ± 0.2^{a} | <0.01 |
| Isoleucine | 91.8 ± 0.4^{a} | 85.2 ± 0.1^{b} | 91.9 ± 0.3^{a} | <0.01 |
| Leucine | 91.8 ± 0.4^{a} | 84.8 ± 0.2^{b} | 92.6 ± 0.2^{a} | <0.01 |
| Histidine | 92.3 ± 0.4^{a} | 86.2 ± 0.2^{b} | 92.6 ± 0.3^{a} | <0.01 |
| Methionine | 95.2 ± 0.4^{a} | 87.2 ± 0.2^{b} | 95.0 ± 0.1^{a} | <0.01 |
| Phenylalanine | 91.9 ± 0.4^{a} | 81.8 ± 0.2^{b} | 92.7 ± 0.2^{a} | <0.01 |
| Threonine | 92.4 ± 0.3^{a} | 80.7 ± 1.2^{b} | 92.5 ± 0.2^{a} | <0.01 |
| Tryptophan | 95.3 ± 0.3^{a} | 68.5 ± 1.1^{b} | 92.7 ± 0.3^{a} | <0.01 |
| Valine | 92.7 ± 0.4^{a} | 81.0 ± 0.2^{b} | 93.1 ± 0.25^{a} | <0.01 |

Dispensible amino acids fractions
(% in the weight of ingredient as is)

| | | | | |
|---|---|---|---|---|
| Alanine | 92.5 ± 0.4^{a} | 82.9 ± 0.3^{b} | 93.5 ± 0.2^{a} | <0.01 |
| Tyrosine | 93.6 ± 0.2^{a} | 85.3 ± 0.2^{b} | 93.5 ± 0.1^{a} | <0.01 |
| Cystine | 90.2 ± 0.1^{a} | 84.4 ± 0.4^{b} | 87.8 ± 1.5^{ab} | 0.01 |
| Glycine | 91.4 ± 0.6^{a} | 80.3 ± 0.5^{b} | 92.2 ± 0.3^{a} | <0.01 |
| Aspartic acid | 91.7 ± 0.4^{a} | 82.6 ± 1.6^{b} | 92.9 ± 0.3^{a} | <0.01 |
| Serine | 91.7 ± 0.4^{a} | 85.8 ± 1.2^{b} | 92.9 ± 0.3^{a} | <0.01 |
| Glutamic acid | 93.9 ± 0.4^{a} | 91.6 ± 0.6^{b} | 94.9 ± 0.2^{a} | 0.01 |
| Proline | 93.1 ± 0.4^{a} | 89.9 ± 0.1^{b} | 94.6 ± 0.2^{a} | <0.01 |
| Hydroxyproline | 86.8 ± 0.9^{a} | 80.5 ± 0.8^{b} | 80.6 ± 1.8^{ab} | 0.03 |

Mean values across the row not sharing a common superscript were significantly different as determined by Tukey's HSD test, P < 0.05.

TABLE 31

| | Feed | | | |
|---|---|---|---|---|
| Fatty acids | | 70%-Ref + | 70%-Ref + | |
| (% of TFA) | Ref | 30%-Nanno | 30%-Iso | P value |
| 14:00 | 76.7 ± 1.3 | 76.8 ± 1.6 | 72.8 ± 1.0 | 0.26 |
| 15:00 | 75.8 ± 0.7 | 73.1 ± 1.1 | 72.9 ± 1.4 | 0.30 |
| 16:00 | 71.1 ± 0.9^{a} | 63.3 ± 0.9^{b} | 64.3 ± 1.6^{b} | 0.01 |
| 17:00 | 53.6 ± 1.9 | 41.5 ± 0.9 | 45.3 ± 10.2 | 0.41 |
| 18:00 | ND* | ND | ND | |
| 20:00 | ND | ND | ND | |
| 22:00 | ND | ND | ND | |
| 24:00 | ND | ND | ND | |
| SFA | 71.7 ± 0.8^{a} | 65.8 ± 0.7^{b} | 66.9 ± 1.6^{b} | 0.04 |
| 16:1n7 | 88.2 ± 1.3^{a} | 76.1 ± 0.8^{b} | 87.2 ± 0.3^{a} | <0.01 |
| 18:1n9 | 83.2 ± 0.9 | 80.2 ± 0.7 | 82.7 ± 0.6 | 0.12 |
| 18:1n7 | 82.1 ± 1.0^{a} | 77.9 ± 0.8^{b} | 81.5 ± 0.7^{a} | <0.01 |
| 20:1n9 | 74.9 ± 1.5 | 74.0 ± 1.0 | 74.8 ± 0.5 | 0.84 |
| 20:1n7 | ND | ND | ND | |
| 20:1n11 | ND | ND | ND | |
| 22:1n9 | ND | ND | ND | |
| 24:1n9 | ND | ND | ND | |
| MUFA | 72.3 ± 1.2 | 69.6 ± 0.6 | 73.3 ± 0.8 | 0.18 |
| 18:2n6 | 85.4 ± 0.7^{a} | 67.7 ± 0.6^{b} | 88.5 ± 0.5^{a} | <0.01 |
| 18:3n6 | ND | ND | ND | |
| 20:2n6 | ND | ND | ND | |
| 20:3n6 | ND | ND | ND | |
| 20:4n6 ARA | 100 ± 0.0^{a} | 82.5 ± 0.30^{b} | 100.0 ± 0.0^{a} | <0.01 |
| 22:4n6 | ND | ND | ND | |
| 22:5n6 | ND | ND | ND | |
| n6 PUFA | 92.1 ± 0.4^{a} | 85.8 ± 0.2^{b} | 93.8 ± 0.3^{a} | <0.01 |
| 18:3n3 ALA | 93.7 ± 0.9^{b} | 98.1 ± 1.1^{a} | 90.6 ± 0.4^{ab} | <0.01 |
| 18:4n3 | 95.8 ± 0.6^{a} | 92.7 ± 0.1^{b} | 95.2 ± 0.2^{a} | <0.01 |
| 20:3n3 | ND | ND | ND | |
| 20:4n3 | ND | ND | ND | |
| 20:5n3 EPA | 96.9 ± 1.1^{a} | 81.1 ± 0.4^{b} | 94.5 ± 0.2^{a} | <0.01 |
| 22:5n3 | 88.4 ± 0.6^{a} | 85.4 ± 0.4^{b} | 88.4 ± 0.5^{a} | <0.01 |
| 22:6n3 DHA | 92.4 ± 0.5^{a} | 88.3 ± 0.2^{b} | 91.8 ± 0.4^{a} | <0.01 |
| n3 PUFA | 94.1 ± 0.5^{a} | 78.1 ± 0.4^{b} | 93.3 ± 0.3^{a} | <0.01 |
| PUFA | 90.7 ± 0.6^{a} | 76.3 ± 0.4^{b} | 91.7 ± 0.4^{a} | <0.01 |
| n6 LC PUFA | 92.8 ± 2.0^{a} | 78.5 ± 1.5^{b} | 100.0 ± 0.0^{a} | <0.01 |
| n3 LCPUFA | 95.3 ± 1.5^{a} | 84.5 ± 0.4^{b} | 93.3 ± 0.3^{a} | <0.01 |

Mean values across the row not sharing a common superscript were significantly different as determined by Tukey's HSD test, P < 0.05.
*ND = not found detectable amount in feces (<0.1% of total fatty acids).

TABLE 32

| Ingredients | | |
|---|---|---|
| Nanno | Iso | P value |

Proximate composition (%, as is)

| | | | |
|---|---|---|---|
| Dry matter | 56.7 ± 1.3^{a} | 77.1 ± 1.9^{b} | 0.01 |
| Crude protein | 69.3 ± 1.5^{a} | 86.5 ± 1.7^{b} | 0.01 |
| Lipid | 60.1 ± 0.6 | 62.8 ± 0.7 | 0.20 |
| Ash | 63.0 ± 4.3 | 71.1 ± 2.5 | 0.01 |
| Energy, kJ/g | 62.1 ± 1.4 | 72.6 ± 1.3 | 0.01 |

Indispensible amino acids
(% in the weight of ingredient as is)

| | | | |
|---|---|---|---|
| Arginine | 74.5 ± 0.2^{b} | 99.2 ± 4.4^{a} | 0.01 |
| Lysine | 72.6 ± 0.9^{b} | 101.4 ± 0.0^{a} | 0.01 |
| Isoleucine | 63.1 ± 1.0^{b} | 92.1 ± 0.9^{a} | 0.01 |
| Leucine | 71.8 ± 1.5^{b} | 94.5 ± 1.2^{a} | 0.01 |
| Histidine | 74.1 ± 0.8^{b} | 93.2 ± 1.1^{a} | 0.01 |
| Methionine | 69.8 ± 0.7^{b} | 94.9 ± 0.7^{a} | 0.01 |
| Phenylalanine | 64.8 ± 1.4^{b} | 94.4 ± 0.9^{a} | 0.01 |
| Threonine | 67.4 ± 4.8^{b} | 94.0 ± 0.6^{a} | 0.01 |
| Tryptophan | 11.8 ± 2.8^{b} | 84.4 ± 2.4^{a} | 0.01 |
| Valine | 58.9 ± 1.4^{b} | 98.5 ± 0.1^{a} | 0.01 |

Dispensible amino acids fractions
(% in the weight of ingredient as is)

| | | | |
|---|---|---|---|
| Alanine | 71.5 ± 0.7^{b} | 95.5 ± 0.9^{a} | 0.01 |
| Tyrosine | 71.9 ± 0.3^{b} | 93.4 ± 0.9^{a} | 0.01 |
| Cystine | 76.7 ± 0.9 | 84.4 ± 3.8 | 0.16 |
| Glycine | 63.9 ± 1.6^{b} | 93.7 ± 0.9^{a} | 0.01 |
| Aspartic acid | 68.7 ± 4.9^{b} | 92.9 ± 0.4^{a} | 0.01 |
| Serine | 75.3 ± 3.6^{b} | 90.8 ± 1.1^{a} | 0.01 |
| Glutamic acid | 84.4 ± 2.0^{b} | 98.9 ± 1.7^{a} | 0.01 |
| Proline | 84.7 ± 0.5^{b} | 98.6 ± 1.6^{a} | 0.01 |
| Hydroxyproline | 56.8 ± 1.5^{b} | 77.7 ± 2.5^{a} | 0.01 |

Mean values across the row not sharing a common superscript were significantly different as determined by Tukey's HSD test, P < 0.05.

TABLE 33

| Fatty acids | Ingredients | | |
|---|---|---|---|
| (% of TFA) | Nanno | Iso | P value |
| 14:00 | 77.4 ± 20.5 | 69.6 ± 0.8 | 0.72 |
| 15:00 | 73.2 ± 1.4 | 75.2 ± 3.1 | 0.62 |
| 16:00 | 54.2 ± 1.4 | 47.7 ± 3.7 | 0.22 |
| 17:00 | ND* | ND | |
| 18:00 | ND | ND | |
| 20:00 | ND | ND | |
| 22:00 | ND | ND | |
| 24:00:00 | ND | ND | 0.41 |
| SFA | 55.9 ± 1.2 | 58.9 ± 2.6 | 0.01 |
| 16:1n7 | 62.0 ± 0.7^{b} | 85.3 ± 1.1^{a} | 0.01 |
| 18:1n9 | 61.9 ± 3.4^{b} | 81.8 ± 0.6^{a} | 0.01 |
| 18:1n7 | 62.9 ± 2.0^{b} | 78.9 ± 1.5^{a} | |
| 20:1n9 | ND | ND | |
| 20:1n7 | ND | ND | |
| 20:1n11 | ND | ND | |
| 22:1n9 | ND | ND | |
| 24:1n9 | ND | ND | |
| MUFA | 44.7 ± 5.0^{b} | 72.2 ± 6.3^{a} | <0.01 |
| 18:2n6 | 51.4 ± 1.2^{b} | 94.8 ± 1.8^{a} | <0.01 |
| 18:3n6 | ND | ND | |
| 20:2n6 | ND | ND | |
| 20:3n6 | ND | ND | |
| 20:4n6 ARA | 88.06 ± 2.26 | ND | |
| 22:4n6 | ND | ND | |
| 22:5n6 | ND | ND | |
| Total n6 PUFA | 76.2 ± 0.7^{b} | 98.4 ± 1.1^{a} | <0.01 |
| 18:3n3 ALA | 98.3 ± 0.0^{a} | 90.3 ± 0.4^{b} | <0.01 |
| 18:4n3 | ND | 95.1 ± 0.2 | |
| 20:3n3 | ND | ND | |
| 20:4n3 | ND | ND | |
| 20:5n3 EPA | 69.4 ± 0.8^{b} | 87.7 ± 2.2^{a} | <0.01 |
| 22:5n3 | ND | ND | |
| 22:6n3 DHA | ND | 91.0 ± 1.4 | |
| Total n3 PUFA | 63.9 ± 0.7^{b} | 92.6 ± 0.4^{a} | <0.01 |
| Total PUFA | 61.8 ± 0.7^{b} | 91.7 ± 0.8^{a} | <0.01 |
| Total n6 LC PUFA | 72.0 ± 1.2^{b} | 103.9 ± 1.3^{a} | <0.01 |
| Total n3 LCPUFA | 63.2 ± 3.9^{b} | 94.4 ± 1.3^{a} | <0.01 |

Mean values across the row not sharing a common superscript were significantly different as determined by Tukey's HSD test, P < 0.05.
*ND = not found detectable amount in feces (<0.1% of total fatty acids)

The overall digestibility data for macronutrients, amino acids, lipid, and fatty acids revealed that Isochrysis sp. was significantly better (more digestible) than Nannochloropsis sp. in trout (Tables 30-33). However, as with tilapia, the improved digestibility of dried whole cells of Nannochloropsis sp. and Isochrysis sp., as nutrient dense feedstuffs, is broadly similar to fishmeal and fish oil, and thus both species can be used as sustainable substitutes for fishmeal and fish oil in rainbow trout feed.

### Example 5: Fish Oil-Free and Fishmeal-Free Aquafeeds for Tilapia

Based upon the diets disclosed herein, N. oculata is combined with dried Schizochytrium sp. (SCI) whole cells to produce a fish oil-free and fishmeal-free aquafeed. Dried SCI whole cells can be used at four supplementation levels (yielding three experimental N. oculata diets combined with SCI and one basal diet containing no SCI; Table 34). When formulating the diets, incremental n-3/n-6 and DHA/EPA ratios are maintained, with the expectation being >1. All four diets are formulated to be iso-nitrogenous (38% crude protein), iso-energetic (16 kJ/g) and iso-lipidic (14% lipid) (example for Nile tilapia). Diets are prepared as described herein. It is expected that combining N. oculata and SCI will promote a balance of ω₃/ω₆ and DHA/EPA ratios effective for tilapia growth and for human health benefits.

TABLE 34

| | Diet (g/100 g diet) | | | | |
|---|---|---|---|---|---|
| | Control | | | | |
| | (Nanno- | Nanno- | Nanno- | Nanno- | Nanno- |
| Ingredient | SC0) | SC25 | Sc50 | Sc75 | Sc100 |
| Fish meal | 20 | 15 | 10 | 5 | 0 |
| N. oculata | 0 | 10 | 13 | 18 | 24 |
| Corn gluten meal | 20 | 20 | 20 | 20 | 20 |
| Soybean meal | 20 | 20 | 20 | 20 | 20 |
| Wheat flour | 26.25 | 20.25 | 21.8 | 22.3 | 21.25 |
| CaH₂PO₄ | 0.75 | 0.75 | 0.75 | 0.75 | 0.75 |
| Vitamin mix¹ | 1 | 1 | 1 | 1 | 1 |
| Mineral mix² | 1 | 1 | 1 | 1 | 1 |
| Scizochytrium sp. | 0 | 10 | 10 | 10 | 10 |
| Fish oil | 9 | 0 | 0 | 0 | 0 |
| Choline chloride | 2 | 2 | 2 | 2 | 2 |

¹Vitamin premix (mg/kg dry diet unless otherwise stated): vitamin A (as acetate), 7500 IU/kg dry diet; vitamin D3 (as cholecalcipherol), 6000 IU/kg dry diet; vitamin E (as DL-a-tocopherylacetate), 150 IU/kg dry diet; vitamin K (as menadione Na-bisulphate), 3; vitamin B12 (as cyanocobalamin), 0.06; ascorbic acid (as ascorbyl polyphosphate), 150; D-biotin, 42; choline (as chloride), 3000; folic acid, 3; niacin (as nicotinic acid), 30; pantothenic acid, 60; pyridoxine, 15; riboflavin, 18; thiamin, 3.
²Mineral premix (mg/kg dry diet unless otherwise stated): ferrous sulphate, 0.13; NaCl, 6.15; copper sulphate, 0.06; manganese sulphate, 0.18; potassium iodide, 0.02; zinc sulphate, 0.3; carrier (wheat middling or starch).

### Example 6: Fish Oil-Free and Fishmeal-Free Aquafeeds for Rainbow Trout

Data from the digestibility experiments with whole cells of Nannochloropsis sp. (N), Isochrysis sp. (I), and Schzochytrium sp. (S) indicate that each serves as a highly digestible and nutrient-dense feedstuff, broadly similar to fishmeal and fish oil. Building on this finding, combinations of N, I and S were used as quality fishmeal and fish oil substitutes in, e.g., tilapia and trout feed. A nutritional feeding trial with diets containing dried whole cells of these microalgae was designed to substitute complete fishmeal and fish oil for maximum growth, and to measure the extent to which inclusion of dried whole-cells of these microalgae improve n3 LC PUFAs deposition in trout fillets with respect to health benefits of human consumption.

Dietary Design.

Four diets were formulated as isonitrogenous and iso-energetic practical diets (Table 35). The experimental treatments included a reference diet with fish oil (Ref); 100% fish oil replacement with Nannochloropsis sp. (N) and Isochrysis sp. (I) with 13% inclusion level of Canola oil; 100% fish oil replacement with N and Schizochytrium sp. (S) with 12% inclusion level of canola oil; 100% fish oil replacement with N, I and S with the 11% inclusion level of canola oil.

TABLE 35

| | Diet | | | |
|---|---|---|---|---|
| Ingredients | Ref | NI | NS | NIS |
| Fish meal | 7.5 | 0 | 0 | 0 |
| Fish oil | 13.5 | 0 | 0 | 0 |
| Nannochloropsis (N) | 0 | 7 | 7 | 7 |
| Isochrysis (I) | 0 | 2.4 | 0 | 2.4 |
| Schizochytrium (S) | 0 | 0 | 2.5 | 3.2 |
| Canola oil | 0 | 13 | 12 | 11 |
| Poultry byproduct meal | 20 | 20 | 20 | 20 |
| Blood meal | 7 | 7 | 7 | 7 |
| Corn gluten meal | 20 | 20 | 20 | 20 |
| Soy protein Concentrate | 20 | 20 | 20 | 20 |
| Wheat gluten | 5 | 5 | 5 | 5 |
| CaHPO4 | 1 | 1 | 1 | 1 |
| Vitamin-mineral premix | 0.6 | 0.6 | 0.6 | 0.6 |
| Lysine | 1 | 1 | 1 | 1 |
| Methionine | 0.2 | 0.2 | 0.2 | 0.2 |
| Choline chloride | 0.5 | 0.5 | 0.5 | 0.5 |
| Wheat flour | 3.5 | 2.1 | 3.0 | 0.9 |
| Ascorbic acid | 0.2 | 0.2 | 0.2 | 0.2 |
| Astaxanthine | 0.05 | 0.05 | 0.05 | 0.05 |
| Total | 100 | 100 | 100 | 100 |

Diets were formulated to meet nutritional requirements of rainbow trout (National Research Council (NRC), 2011). Dried Nannochloropsis sp. and Isochrysis sp. were obtained from Reed Mariculture, Inc. (Pasadona, Calif.). Dried Schizochytrium sp. was obtained from ALGAMAC (Aquafauna Bio-marine, Inc., CA). Micro ingredients were first mixed and then slowly added to the macroingredients to ensure a homogenous mixture. The ingredients were thoroughly mixed and steam-pelleted using a California Pellet Mill (San Francisco, Calif.). The initial size of the pellet was 4.0 mm; which was increased to 6.0 mm as the fish grow larger throughout the trial. Pellets were dried in a forced-air oven (22° C., 24 hours), sieved and stored at −20° C.

Fish Husbandry and Feeding.

Rainbow trout (all female, triploid, with average body weight of 30-50 g) are stocked into 170-L tanks in a recirculating culture system at 15 fish per tank. Three tanks of fish are randomly assigned to each dietary treatment. The experimental diets are fed to apparent satiation twice daily (at 8:00 am and 3:00 pm), 6 days a week, for 12 weeks. Apparent satiation is defined as all the feed the fish would consume in a 20-minute period. During the experiment, the recirculating system is maintained at optimum levels for rainbow trout culture: 15° C. for water temperature, and other environmental parameters are maintained within limits recommended for rainbow trout by the National Research Council (NRC 2011). After 12 weeks of feeding, fish are fasted for 24 hours before collection of tissue samples for compositional analyses.

Biological Sampling Procedures, Fillet Preparations and Growth Measurements.

The fish are bulk-weighed at the beginning of the experiment, and then every 3 weeks until the end of the experiment (84 days). Feeding of the fish is stopped 24 hours prior to each bulk weight-sampling event. Three samples are taken from each fish per tank at day 42 (middle) and 84 (final) for the fillet fatty acid compositions. During mid-sampling, the fish are immediately filleted from a standardized dorso-anterior landmark, each fillet is weighed, the liver is packaged in sterile polythene bags (WHIRL-PAK; Naso, Fort Atkinson, Wis.) and stored frozen (−20° C.), then freeze dried. The weight of each freeze dried fillet is taken to track how much water/moisture is reduced thereby allowing the expression of fatty acid data via a wet weight basis.

During final sampling the entire fish biomass of every tank is weighed. Three fish per tank are sacrificed for whole body proximate. Three fish per tank are filleted from a standardized dorso-anterior land-mark, weighed, packaged in sterile polythene bags (WHIRL-PAK; Naso, Fort Atkinson, Wis.) and stored frozen (−20° C.) and freeze dried. Again, the weight of each freeze dried fillet is taken to track how much water/moisture is reduced thereby allowing the expression of fatty acid data via a wet weight basis. From these fish, liver and viscera are harvested and weighed. Fillet and liver samples are stored frozen (−20° C.) and freeze dried. The freeze dried samples are also individually weighed to know the moisture/water content thereby allowing expression of the data in wet weight basis. Whole-body proximate analysis and fatty acids composition are expressed as wet weight basis.

The dietary effects on growth are determined by evaluating final weight, weight gain percentage, feed conversion ratio (FCR), specific growth rate (SGR), protein efficiency ratio (PER), survival rate (%), hepatosomatic index (HIS), thermal growth efficiency (TGC), and condition factor (K). The indices that are calculated include: Weight gain (g)=final weight−initial weight; weight gain (%)=(final weight−initial weight/initial weight)×100%; FCR, feed conversion ratio=feed intake/weight gain; SGR, specific growth rate (%/day) (ln final wet weight (g)−ln initial wet weight (g))/Time (days); PER, protein efficiency ratio=weight gain (g)/protein fed (g); and survival rate (%)=(Final number of fish/Initial number of fish)×100. The hepatosomatic index (HIS)=(Liver weight (g)/Fish weight (g))×100, thermal growth efficiency (TGC)=100×(final body weight^{1/3}−initial body weight^{1/3})/(temperature×days, and condition factor (K)=(10⁵×final weight)/(fork length)³ are also calculated.

A palatability experiment was conducted to determine whether rainbow trout accept the fishmeal-free and fish oil-free microalgae based diets (NI, NS, and NIS) compared to their acceptance of a fishmeal and fish oil based control diet (Table 27). To achieve this goal, all female triploid rainbow trout with an average body weight of 20 g, were stocked into 10-L tanks in a recirculating culture system at 4 fish per tank. Three tanks of fish are randomly assigned to each dietary treatment. The experimental diets are fed to apparent satiation twice daily (at 8:00 am and 3:00 pm), 6 days a week, for 10 days. With the exception of the NI diet, fish fed the other two microalgae diets (NS and NIS) showed no reduction or compromising of their feed intake when compared to fish fed the control diet (Table 36). It is interesting to note that fish fed the NIS diet exhibited enhancement of all growth indices and feed utilization when compared with the control diet, however, the difference was statistically insignificant. A long-term growth experiment is expected to lead this growth difference to reach a significant level. The short-term palatability study revealed that the combination of three marine microalgae (NIS) can be fully replaced marine derived fishmeal and fish oil from trout feed. A long term (84 days) nutritional feeding trial is conducted with these diets containing dried whole cells of these microalgae designed to completely substitute fishmeal and fish oil for maximum growth, and to measure the extent to which inclusion and combinations of these microalgae improved n3 LC PUFAs deposition in trout fillets with respect to health benefits of human consumption. It is expected that the fishmeal-free and fish oil-free and microalgae-based aquafeed provides a sustainable alternative for the formulation of low pollution and nutritious feeds for rainbow trout.

Palatability.

As an initial analysis, a palatability experiment was conducted to determine whether rainbow trout accepted the fishmeal-free and fish oil-free microalgae based diets (NI, NS, and NIS) when compared to fishmeal and fish oil-based control diet (Table 35). In this analysis, all female triploid trout, having an average body weight of g, were stocked into 10-L tanks in a recirculating culture system at four fish per tank. Three tanks of fish were randomly assigned to each dietary treatment. The experimental diets were fed to apparent satiation twice daily (at 8:00 am and 3:00 pm), 6 days a week, for 10 days. With the exception of the NI diet, fish fed the other two microalgae diets (NS and NIS) did not show reduction of or compromising of their feed intake when compared with the control diet (Table 36). It was of interest to note that fish fed the NIS diet exhibited enhancement of all growth indices and feed utilizations when compared with the control diet, however, the difference was statistically insignificant. It is expected that in a long-term growth experiment (84 days) this growth difference will reach a significant level. The short-term palatability study revealed that the combination of three marine microalgae (NIS) can fully replace marine-derived fishmeal and fish oil in trout feed. Thus, the fishmeal-free and fish oil-free and microalgae-based aquafeed provides a sustainable alternative for the formulation of low pollution and nutritious feeds for rainbow trout.

TABLE 36

| | Diet¹ | | | | F value |
|---|---|---|---|---|---|
| | Control | NI | NS | NIS | (P value) |
| Initial | 26.41 ± 2.7 | 26.36 ± 1.2 | 26.15 ± 2.4 | 28.20 ± 1.3 | 0.72 |
| weight | | | | | (0.56) |
| (g) | | | | | |
| Final | 29.76 ± 2.0 | 28.50 ± 1.9 | 29.70 ± 2.2 | 32.74 ± 1.4 | 2.79 |
| weight | | | | | (0.11) |
| (g) | | | | | |
| Weight | 1292.4 ± 426.0^{a} | 806.1 ± 213.9^{b} | 1370.9 ± 247.2^{a} | 1612.8 ± 135.2^{a} | 5.55 |
| gain | | | | | (0.02) |
| (%)² | | | | | |
| FCR³ | 1.33 ± 0.32 | 1.54 ± 0.30 | 1.13 ± 0.01 | 0.99 ± 0.06 | 3.62 |
| | | | | | (0.07) |
| SGR⁴ | 1.20 ± 0.38^{ab} | 0.78 ± 0.2^{b} | 1.27 ± 0.22^{ab} | 1.49 ± 0.12^{a} | 5.57 |
| | | | | | (0.02 |
| TGC⁵ | 0.10 ± 0.0^{ab} | 0.06 ± 0.2^{b} | 0.10 ± 0.0^{ab} | 0.13 ± 0.0^{a} | 6.76 |
| | | | | | (0.01) |
| Feed | 4.32 ± 0.1^{a} | 3.20 ± 0.7^{b} | 3.96 ± 0.2^{a} | 4.50 ± 0.6^{a} | 4.77 |
| intake | | | | | (0.04) |
| (g/fish) | | | | | |
| Survival | 100.0 ± 0.0 | 100.0 ± 0.0 | 100.0 ± 0.0 | 100.0 ± 0.0 | |
| rate | | | | | |
| (%)⁶ | | | | | |

Values are means of ±SE of three replicate groups (n = 3)
¹Mean values not sharing a superscript letter in the same row differ significantly (P < 0.05).
²Weight gain (%) = (final wet weight − initial wet weight/initial wet weight) × 100%.
³FCR, feed conversion ratio = feed intake/weight gain
⁴Specific growth rate SGR (%/day) = 100 × (ln final wet weight (g) − ln initial wet weight (g))/Time (days);
⁵TGC, thermal unit growth coefficient = 100 × (final body weight^{1/3} − initial body weight^{1/3})/(temperature × days)
⁶Survival rate (%) = (Final number of fish/Initial number of fish) × 100.
NI = Nannochloropsis sp. + Isochrysis sp.;
NS = Nannochloropsis sp. + Schizochytrium sp;
NIS = Nannochloropsis sp. + Isochrysis sp + Schizochytrium sp.

### Example 7: Microalgal Cells and Co-Products for Fishmeal-Free and Fish Oil-Free Aquafeeds

Data presented herein indicate that whole cells of Nannochloropsis sp. in tilapia are a highly digestible and nutrient-dense feedstuff, broadly similar to fishmeal and fish oil. The apparent digestibility coefficient (ADC) in crude protein was 73.9%. Essential amino acids in Nannochloropsis sp. were highly digestible overall (>85%). Lysine and methionine digestibility were 89.5% and 93.1%, respectively. Saturated fatty acids (SFA), n-3 PUFA, and total PUFA were highly digestible (>90%). The phosphorus digestibility coefficient was very high (>100%). Tilapia showed high palatability for the Nannochloropsis sp. diet, feeding as aggressively on it as on the fishmeal-based reference diet. These data indicate that the dried whole cells of Nannochloropsis sp. are sustainable alternatives for the formulation of low pollution and nutritious feeds for tilapia.

Nannochloropsis sp. co-product, such as N. oculata cells left over after non-toxic GRAS solvent extraction of oils for a human nutraceutical (Kagan, et al. (2014) Internat. J. Toxicol. 33:459-74), is commercially available in large amounts. This co-product contains high levels of crude protein (35-45%), amino acids (methionine 0.72%, lysine 2.10%), crude lipid (2-10.3%), ash (26.1-33.5%), gross energy (17.9%), EPA (24.2%), and is a good source of minerals. Thus, this co-product shows potential to replace a portion or all of the fishmeal and fish oil in tilapia feed. Accordingly, the level of nutrients and anti-nutrients in whole cells and co-products of N. oculata are determined as is the nutrient digestibility of N. oculata co-product for tilapia. Based on the resulting determination of the digestible nutrient content of N. oculata co-product, feeds are formulated and a nutritional feeding experiment is conducted to assess the ideal level of replacement of fishmeal by the N. oculata co-product. In addition, the combining N. oculata co-product can be combined with Schizochytrium sp. to maintain fish flesh ω₃/ω₆ and DHA/EPA ratios that are beneficial for human health.

Minerals and Metals/Heavy Metals Analysis.

A LACHAT QUICKCHEM AE automated flow injection auto analyzer is used for colorimetric analysis of minerals in microalgal cells and co-products. Trace elements, minerals, metals and heavy metals (e.g., molybdenum, chromium, mercury, cobalt, cadmium, copper, boron, barium, aluminium, lead, and arsenic etc.) content in microalgal cells and co-products is analyzed by Leeman Prodigy Inductively Coupled Plasma Atomic Emission Spectrophotometer (ICP-AES).

Macronutrients, Amino Acids and Fatty Acids Analysis.

Whole cells and co-products of N. oculata are lyophilized and analyzed for dry matter, ash, crude protein, total lipid, crude fiber, gross energy, and fatty acid and amino acid profiles. Dry matter is obtained by drying samples to constant weight in a forced air oven at 150° C. overnight, and expressed as a percentage of wet weight (AOAC, 930.15). Ash content is obtained via a muffle furnace at 500° C. overnight and expressed in dry weight (AOAC, 942.05), and crude fiber (AOAC, 1978.10). Gross energy analysis is performed by bomb calorimetry (Fisher Scientific calorimeter) and calculated as percentage of dry matter. Crude protein (AOAC, 990.03) is evaluated using a Carlo Erba 1500 NA Series 2 elemental analyzer, and nitrogen (N) conversion factor of N×6.25, expressed as dry weight. Algal whole cells and co-product are also analyzed for essential and non-essential amino acids (high-performance liquid chromatography, HPLC analysis, via AOAC methods 994.12, 985.28, 988.15, and 994.12) and fatty acids (fatty acids methyl esters, FAME analysis, via AOAC method 963.22).

Whole cells and co-products of N. oculata are analyzed for several types of anti-nutrients. The microalgal cell wall's non-starch polysaccharides, such as hemicellulose and pectin, is determined in accordance with conventional methods (Talbott & Ray (1992) Plant Physiol. 98:357-368). An agglutination assay for lectins is carried out according to a previously described method (Hori, et al. (1986) Botanica Marina 29:323-328; Chiles & Bird (1989) Comp. Biochem. Physiol. 94B:107-111). For trypsin inhibitor activity, the protease inhibitor assay is carried out using a known method (Hamerstrand, et al. (1981) Cereal Chem. 58:42-5). Phytic acid (myo-inositol 1,2,3,5/6-hexakis dihydrogen phosphate) is also determined by a known method (Graf & Dintzis (1982) J. Agric. Food Chem. 30:1094-7).

Feed Formulation and Preparation for Digestibility Analysis.

A high-quality reference diet is prepared and combined with N. oculata co-product at a 7:3 ratio (as is standard) to produce a test diet following a conventional apparent digestibility protocol (Cho, et al. (1982) Comp. Biochem. Physiol. B 73:25-41). SIPERNAT 50 (acid-insoluble ash; Evonik Degussa Corporation, Parsippany, N.J.) is included in the basal diet at 1% as a digestion indicator. The diets are produced by weighing and mixing oil and dry ingredients in a food mixer (Hobart Corporation, Tory, Ohio) for 15 minutes; blending water (330 ml/kg diet) into the mixture to attain a consistency appropriate for pelleting; and running each diet through a meat grinder (Panasonic) to create 4 mm-diameter pellets. After pelleting, the diets are dried to a moisture content of 80-100 g/kg under a hood at room temperature for 12 hours and then stored in plastic containers at −20° C.

Experimental Design and Methods for Digestibility Study with N. oculata Co-Product.

The experiment has a completely randomized design of two diets×four replicates (tanks). Eight static-water 114-L cylindro-conical tanks fitted with feces settling columns are used. Juvenile Nile tilapia fish are used for assessing digestibility. The Nile tilapia (O. niloticus) is obtained from Americulture Inc. (Animas, N. Mex.). Prior to the start of the experiment, fish are randomly assigned to a tank (17 tilapia/tank, mean wt. of 20.0 g/fish) and maintained under a photoperiod cycle at 10 hours light and 14 hours dark. Fish are acclimated to experimental conditions for seven days and fed the reference diet. After randomly assigning the two diets to eight tanks, fish are acclimated to experimental diets for seven days before initiation of feces collection. Fish are hand-feed two times daily between 0930 and 1700 h and uneaten feed is collected after each feeding to prevent mixing with fecal samples. Appropriate restricted pair feeding is employed to supply the same quantity of dietary nutrients (feed) to the groups. Water quality is monitored daily to maintain favorable conditions for tilapia, with water replaced as needed, and water temperature kept within 27.0-28.0° C.

Fish fecal samples are collected twice daily, once before the morning feeding and once before the afternoon feeding, for 60 days, from an unstirred fecal collection column affixed to the bottom of each tank. Uneaten feed residues and feces are flushed out of the fecal collection column after each feeding. To collect feces, the bottom of the tank is sealed from the collector column by closing a valve, the column is gently removed and settled feces and surrounding water are withdrawn from the fecal collector using electronic pipetting and placed in 50 ml FALCON tubes. Samples are allowed to settle in the tube before removing supernatant water with the pipette, and the tubes are frozen at −20° C. Fecal samples by tank are pooled for the duration of the experiment. At the end of the experiment, the samples are lyophilized, finely ground, and stored at −20° C. for proximate, amino acid and fatty acid analysis.

Three types of samples (microalgal co-product, diets and feces) are analyzed for dry matter, ash, crude protein, total lipid, crude fiber, gross energy, and fatty acid and amino acid profiles. Acid-insoluble ash (AIA) is analyzed in feed and feces according to known methods (Naumann & Bassler (1976) VDLUFA-Methodenbuch, Diechemische Untersuchung von Futtermitteln, vol. 3. Neumann Neudamm, Melsungen; Keulen & Young (1977) J. Anim. Sci. 44:282-287). Apparent digestibility coefficients (ADC) are calculated for macronutrients, amino acids, fatty acids and energy of the test and the reference diets as described herein.

One-way analysis of variance (ANOVA) of apparent digestibility coefficients is conducted for macronutrients, fatty acids and amino acids in the reference and test diets, as well as for test ingredients. Data are expressed as the mean with pooled SEM of three replicates. All statistical analyses are carried out using the IBM Statistical Package for the Social Sciences (SPSS) program for Windows (v. 21.0, Armonk, N.Y., USA).

Diet Formulation for Tilapia Nutritional Feeding Trial.

Co-product of N. oculata is incorporated into tilapia experimental diets for a nutritional feeding trial. Table 37 provides an illustrative formulation of experimental diets, based on composition values for N. oculata co-product inclusion via serial replacement of fishmeal. The five iso-nitrogenous (38% crude protein), iso-energetic (16 kJ/g) and iso-lipidic (14% lipid) experimental diets are prepared, wherein fishmeal (Nanno0) is designated as the control, and in experimental feeds, 25% fishmeal (Nanno25), 50% fishmeal (Nanno50), 75% fishmeal (Nanno75), and 100% fishmeal (Nanno100) is substituted with N. oculata co-product.

TABLE 37

| | Diet | | | | |
|---|---|---|---|---|---|
| Ingredient | Nanno0 | Nanno25 | Nanno50 | Nanno75 | Nanno100 |
| Fish meal | 20 | 15 | 10 | 5 | 0 |
| N. oculata co- | 0 | 17 | 27 | 38 | 45 |
| product | | | | | |
| Corn gluten | 20 | 20 | 20 | 20 | 20 |
| meal | | | | | |
| Soybean meal | 20 | 15 | 15 | 15 | 15 |
| Wheat flour | 26.25 | 19.25 | 14.25 | 8.25 | 5.99 |
| CaH₂PO₄ | 0.75 | 0.75 | 0.75 | 0.75 | 0.75 |
| Mineral mix | 1 | 1 | 1 | 1 | 1 |
| Vitamin mix | 1 | 1 | 1 | 1 | 1 |
| Fish oil | 9 | 9 | 9 | 9 | 9 |
| L-lysine HCL | 0 | 0 | 0 | 0 | 0.26 |
| Choline | 2 | 2 | 2 | 2 | 2 |
| chloride | | | | | |

Feed preparation and analysis are performed as described herein. At each level of N. oculata co-product replacement, the growth, feed efficiency, and nutritional quality of fish flesh are compared to that of fish on the control diet.

Experimental Design and Methods to Evaluate Tilapia Growth on N. oculata Co Product Diets.

A completely randomized design of five diets×three replicates (tanks) is used for this analysis. Seven hundred fifty juvenile tilapia (mean initial weight 5 grams) are randomly assigned to groups of 50 fish per tank, bulk-weighed and placed into fifteen indoor, static-water 114-L cylindro-conical tanks. Each tank is filled with well water and provided aeration through an air stone diffuser via a low-pressure electrical blower. Each tank also has its water recirculated through a separate bubble bead-filter for biological filtration and solids removal. The stocking density (<0.251b/gal) and water quality parameters in the system are maintained in excellent conditions to ensure maximum growth of tilapia. All fish are maintained on the control diet for one week to adapt them to feeding and handling practices. Each experimental diet is subsequently administered at a rate ranging between 6% of body weight at the beginning of the trial to 4% the end (National Research Council, NRC 2011). Fish are hand-fed three times a day at 10:00, 13:00 and 16:00 for 12 weeks, and care is taken to ensure that feed waste is minimized. Fish are anesthetized (tricaine methane-sulfonate, “MS-222”; Argent Chemical Laboratories, Redmond, Wash.; concentration 2 mg/L), bulk-weighed and counted in each tank at 3-week intervals and the feeding rate is adjusted accordingly. For 24 hours prior to the weighing procedure food is withheld to avoid an increase in ammonia excretion due to handling.

Fish are weighed and sampled at the beginning of the experiment. Prior to commencing the feeding trial, 20 fish are euthanized from the stock, the fish are ground into a homogeneous slurry, freeze-dried, reground and stored at −20° C. for whole-body proximate and fatty acid composition analysis. At Week 6 of the experiment (midpoint), 10 fish are removed from each tank and euthanized for sampling. Of these, fillet subsamples are similarly collected from 5 fish using a standardized dorso-anterior landmark, packaged and stored for fatty acid analysis. From these same 5 fish, liver and viscera are also removed and each is weighed for hepato somatic index (HIS) and viscera somatic index (VSI) evaluation. Liver are stored frozen (−20° C.) for fatty acid analysis. The remaining 5 fish from each tank are freeze-dried, finely ground and stored at −20° C. until whole-body carcass analysis. At Week 12 of the experiment (terminus), fish are removed from each tank and euthanized for sampling. Of these, fillet subsamples are similarly collected from 5 fish using a standardized dorso-anterior landmark, packaged and stored for fatty acid analysis. As before, liver and viscera are removed, weighed and evaluated. Liver are stored frozen (−20° C.) for fatty acid analysis. The remaining 5 fish from each tank are frozen, finely ground and stored at −20° C. until whole-body carcass analysis.

The effects of the different N. oculata co-product replacement levels on growth and survival are determined by quantifying final weight, weight gain percentage, feed conversion ratio (FCR), specific growth rate (SGR), protein efficiency ratio (PER) and survival rate. These indices are calculated as follows: Weight gain=(final weight−initial weight/initial weight)×100; FCR, feed conversion ratio=feed intake/weight grain; protein efficiency ratio; SGR (%/day)=100×(ln final wet weight (g)−ln initial wet weight (g))/Time (days), PER=weight gain (g)/protein fed (g); and Survival rate (%)=(final number of fish/initial number of fish)×100. Nutrient (P and N) retention (g/kg fish)=100×{(final biomass×final nutrient concentration of the fish)−(initial biomass×initial nutrient concentration of the fish)}/feed consumed×nutrient concentration of the diet. Proximate, amino acids, and fatty acids of the samples are analyzed as described herein.

One-way analysis of variance (ANOVA) of growth performance and feed utilization parameters, nutrient retention, whole body proximate composition, fillet and liver fatty acids composition are conducted and, when significant differences are found, the treatment means are compared using Tukey's test of multiple comparisons with 95% level of significance. Statistical analyses are conducted using the IBM Statistical Package for the Social Sciences (SPSS) program for Windows (v. 21.0, Armonk, N.Y., USA).

Experiment Evaluating Diets that Combine N. oculata Co-Product with Schizochytrium sp.

Experimental diets are based on N. oculata co-product and free of fish oil, with four supplementation levels of dried Schizochytrium sp. (Sc) whole cells (yielding three experimental N. oculata co-product diets combined with Sc and one basal diet containing no Sc). When formulating the diets, the goal is to maintain incremental n-3:n-6 and DHA:EPA ratios, expected to be >1:1. All four diets are formulated to be iso-nitrogenous (38% crude protein), iso-energetic (16 kj/g) and iso-lipidic (14% lipid). Diets are prepared as described herein. The nutritional feeding trial is conducted for 6 months to cover the full growth phase of tilapia until marketable size. The experiment has a completely randomized design: tanks randomly assigned to one of the four dietary treatments, with three replicate tanks per treatment. Six hundred juvenile tilapia (mean initial weight 5 grams) are randomly assigned to groups of 50 fish per tank, bulk-weighed and placed into twelve, 100 gal fish tanks of recirculating aquaculture modules (RAS modules). The stocking density (<0.251b/gal, 80 gal of rearing water/tank) and water quality parameters in the RAS modules are maintained in excellent conditions to ensure maximum growth of tilapia. The recirculating system removes suspended solids and maintains ammonia-nitrogen and nitrite levels with a BIOCLARIFIER bubble bead filter. Water quality is monitored daily to maintain favorable conditions for tilapia and water temperature kept within 27.0-28.0° C.

Fish are weighed and sampled at the beginning of the experiment. Prior to commencing the feeding trial, 20 fish are euthanized, ground into a homogeneous slurry, freeze-dried, reground and stored at −20° C. for whole-body proximate and fatty acid composition analysis. At month 3 of the experiment (midpoint), 10 fish are removed from each tank and euthanized for sampling. Of these, fillet subsamples are similarly collected from 5 fish using a standardized dorso-anterior landmark, packaged and stored for fatty acid analysis. From these same 5 fish, liver and viscera are removed, weighed and evaluated. Liver are stored frozen (−20° C.) for fatty acid analysis. The remaining 5 fish from each tank are freeze dried, finely ground and stored at −20° C. until whole-body carcass analysis. At month 6 of the experiment (terminus), 10 fish are removed from each tank and euthanized for sampling. Of these, fillet subsamples are similarly collected from 5 fish using a standardized dorso-anterior landmark, packaged and stored for fatty acid analysis. From these same 5 fish, liver and viscera are removed, weighed and analyzed. Liver are stored frozen (−20° C.) for fatty acid analysis. The remaining 5 fish from each tank are freeze-dried, finely ground and stored at −20° C. until whole-body carcass analysis.

Nutrient digestibility, retention and waste outputs (N and P) of four combined co-product/Sc diets fed to tilapia are compared to quantify their pollution potential. Effects of the four diets on dry matter, ash, crude protein, total lipid, and phosphorus digestibility are measured by incorporating an indigestible marker, SIPERNAT (acid-insoluble ash) in the same feed used for the feeding experiment. After 6 months of the final sampling, out of the remaining experimental fish, 17 fish/tank are transferred into twelve static-water 114-L cylindro-conical tanks fitted with feces settling columns. Transferred fish are fed the same combined diet that they previously received, with each diet fed to three replicate tanks (n=3) in a completely randomized design for another 4 weeks. Feces are collected to measure digestibility of the diet as described herein.

The apparent digestibility coefficients (ADCs) of nutrients in the combined co-product/Sc diets are calculated as described herein. Nutrients (P and N) retention, solid and dissolved nutrients (P and N) waste output are calculated as follows: nutrient retention (g/kg fish)=100×{(final biomass×final nutrient concentration of the fish)−(initial biomass×initial nutrient concentration of the fish)}/feed consumed×nutrient concentration of the diet. Total P loading are estimated based on solid and dissolved P loading (solid P load+dissolved P load). Solid and dissolved nutrients (P and N) load are calculated using the following formula: Solid nutrient load (g/kg fish)={1-apparent nutrient digestibility coefficient×nutrient intake (g/kg fish)}; Dissolved nutrient load (g/kg fish)=[apparent nutrient digestibility coefficient×{nutrient intake (g/kg fish)−retained nutrient (g/kg fish)}]. Analytical procedures for feed, feces, and acid insoluble ash and statistics are the same as described herein.

This analysis demonstrates the practical feasibility and financial viability of incorporating highly digestible, marine microalgal co-product in tilapia diets. The results provide the first comprehensive dataset for informing the inclusion of N. oculata whole cells or N. oculata co-product plus Sc into tilapia diets that are more environmentally sustainable, cost-effective, and maintain desirable fatty acid profiles in tilapia flesh. Specifically, the results quantify levels of nutrients and anti-nutrients in the whole cells and co-product of N. oculata and quantify the nutrient digestibility of N. oculata co-product incorporated into a complete feed. It is expected that N. oculata co-product will show high potential as a substitute for fishmeal in formulated feeds. The results also demonstrate growth performance, survival, feed conversion ratio, feed efficiency, protein efficiency ratio and maintenance of flesh quality when tilapia are fed diets incorporating the N. oculata co-product. It is expected that combining N. oculata co-product and Sc will promote a balance of ω₃/ω₆ and DHA/EPA ratios that are effective for tilapia growth and for human health benefits.

What is claimed is:

1. A method for preparing a fish oil-free and fishmeal-free aquaculture feed composition comprising
(a) providing a source of fatty acids, wherein the fatty acid source consists of one or a combination of marine microalgae having an omega-3 long-chain polyunsaturated fatty acid content of at least 30% of the total fatty acids;
(b) providing at least one source of essential amino acids; and
(c) contacting (a) and (b) to prepare an aquaculture feed composition, wherein the ratio of omega-3 polyunsaturated fatty acids:omega-6 polyunsaturated fatty acids of the aquaculture feed composition is in the range of 1:1 to 2:1.

2. The method of claim 1, wherein the marine microalgae are selected from the group of Schizochytrium sp., Nannochloropsis sp., Isochrysis sp., Nanofrustulum sp., Tetraselmis sp., Crypthecodinium sp., Phaeodactylum sp., Chaetoceros sp., Thalassiosira sp., Pavlova sp., Skeletonema sp., Haematococcus sp., Chlamydomonas sp., Thraustochytrium sp., Pinguiococcus sp., and Dunaliella sp.

3. The method of claim 1, wherein the at least one source of essential amino acids is a marine microalgae or a marine microalgae in combination with corn meal, soybean meal, or a combination thereof.

4. The method of claim 3, wherein the marine microalgae consists of one or a combination of Nannochloropsis sp., Schizochytrium sp., Isochrysis sp., Nanofrustulum sp., Tetraselmis sp. Crypthecodinium sp., Phaeodactylum sp., Chaetoceros sp., Thalassiosira sp., Pavlova sp., Skeletonema sp., Haematococcus sp., Chlamydomonas sp., Thraustochytrium sp., Pinguiococcus sp., and Dunaliella sp.

5. The method of claim 1, wherein the marine microalgae have an omega-3 long-chain polyunsaturated fatty acid content in the range of 30 to 50% of the total fatty acids.

6. The method of claim 1, wherein the ratio of omega-3 polyunsaturated fatty acids:omega-6 polyunsaturated fatty acids of the aquaculture feed composition is in the range of 1.8:1 to 1:1.

7. A fish oil-free and fishmeal-free aquaculture feed composition prepared by the method of claim 1.

8. A method for producing an aquaculture product with improved growth rates, feed conversion, protein efficiency ratio, or survival rates comprising feeding a freshwater tilapia or a salmonid species a fish oil-free aquaculture feed composition comprising
(a) a source of fatty acids, wherein the fatty acid source consists of one or a combination of marine microalgae having an omega-3 long-chain polyunsaturated fatty acid content of at least 30% of the total fatty acids; and
(b) at least one source of essential amino acids thereby producing an aquaculture product with improved growth rates, feed conversion, protein efficiency ratio, or survival rates.

9. The method of claim 8, wherein the freshwater tilapia comprises Oreochromis niloticus, Oreochromis niloticus×Oreochromis aureus, Oreochromis aureus, or Oreochromis mossambicus.

10. The method of claim 8, wherein the salmonid species comprises Salmo salar, Pacific salmon, Oncorhynchus mykiss, Salmo gairdneri, alvelinus alpinus, Salvelinus namaycush or Salvelinus fontinalis.

11. The method of claim 8, wherein the marine microalgae are selected from the group of Schizochytrium sp., Nannochloropsis sp., Isochrysis sp., Nanofrustulum sp., Tetraselmis sp., Crypthecodinium sp., Phaeodactylum sp., Chaetoceros sp., Thalassiosira sp., Pavlova sp., Skeletonema sp., Haematococcus sp., Chlamydomonas sp., Thraustochytrium sp., Pinguiococcus sp., and Dunaliella sp.

12. The method of claim 8, wherein the at least one source of essential amino acids is selected from the group of corn meal, soybean meal, dried marine microalgae, marine microalgae co-product and a combination thereof.

13. The method of claim 12, wherein the marine microalgae consists of one or a combination of Nannochloropsis sp., Schizochytrium sp., Isochrysis sp., Nanofrustulum sp., Tetraselmis sp. Crypthecodinium sp., Phaeodactylum sp., Chaetoceros sp., Thalassiosira sp., Pavlova sp., Skeletonema sp., Haematococcus sp., Chlamydomonas sp., Thraustochytrium sp., Pinguiococcus sp., and Dunaliella sp.

14. The method of claim 8, wherein the fillet of the aquaculture product has a ratio of n-3 PUFA:n-6 PUFA in the range of 1.8:1 to 1:1.

15. An aquaculture product, or aquaculture meat product thereof, produced by the method of claim 8.
